(19) United States
(12) Patent Application Publication
(10) Pub. No.: US 2016/0063435 A1
(43) Pub. Date: Mar. 3, 2016

(54) SYSTEMS AND METHODS FOR FACILITATING SECURE ORDERING, PAYMENT AND DELIVERY OF GOODS OR SERVICES

(71) Applicants: Inam Shah, Toronto (CA); Samer Ziade, Toronto (CA); Abir Rais, Toronto (CA)

(72) Inventors: Inam Shah, Toronto (CA); Samer Ziade, Toronto (CA); Abir Rais, Toronto (CA)

(21) Appl. No.: 14/837,958

(22) Filed: Aug. 27, 2015

Related U.S. Application Data
(60) Provisional application No. 62/042,612, filed on Aug. 27, 2014.

(51) Int. Cl. G06Q 10/08; G06Q 20/42

(52) U.S. Cl. CPC G06Q 10/0833; G06Q 20/42

(57) ABSTRACT

Various embodiments are described that generally to a system and method for facilitating the secure order, payment and delivery of goods and/or services between various parties. The method may include receiving an order for goods or services at a management server; creating a waypoint for each address in the order; generating an identifier for each waypoint; transmitting the identifiers to a party associated with the waypoints; locating a courier to deliver the order; receiving identifier responses from the courier device at the waypoints, and matching the identifiers with the corresponding identifier responses to verify at least one of task completion and payment at the waypoints.

### CROSS-REFERENCE TO RELATED APPLICATION

This application claims the benefit of U.S. Provisional Patent Application No. 62/042,612, filed Aug. 27, 2014; the entire contents of Patent Application No. 62/042,612 are hereby incorporated by reference.

### FIELD

The various example embodiments described herein relate generally to systems and methods of facilitating secure ordering, delivery and payment of goods or services or completion of tasks between various parties.

### BACKGROUND

Ordering goods online typically involves a buyer placing an order directly with a merchant of the goods or services, where the merchant then arranges for the goods or services to be delivered to the buyer or the buyer makes a purchase through the delivery system. Some goods that are ordered online may be required for a specific time or type of handling and may require a time sensitive delivery. For example, medicinal products may be required at specific times in the day since it may be beneficial to consume such products within a specific period after they are prepared.

Ordering goods online generally provides the buyer or seller with little control or traceability into the delivery and payment process. If a delivery is delayed or if a buyer is unsatisfied when receiving a product that has a time sensitive delivery, it's often difficult to establish whether the delay was caused by the merchant or by the courier completing the delivery. Current systems for facilitating the order, payment and delivery of goods or services, however, do not provide a buyer or seller with more control or security over the process.

### SUMMARY

In a first broad aspect, in at least one example embodiment described herein, there is provided a method to facilitate the secure order, payment and delivery of at least one of goods and services using a communication network. The method comprises providing for the connection of a plurality of buyer devices, merchant devices and courier devices using the communication network; receiving an order request for the at least one of goods and services at a management server, the order request being sent from a first electronic device of a first party, the at least one of goods and services being prepared by a second party having a second electronic device and the order being fulfilled by a courier having a courier device; obtaining order authorization for the order request from the first electronic device of the first party; generating first and second corresponding identifiers for the order request and sending the first identifier to the second electronic device of the second party and the second identifier to the first electronic device of the first party; locating the courier who will fulfill the order; receiving a first identifier response from the courier device when the located courier picks up the order from the second party; verifying pick up of the order at the second party by matching the first identifier with the first identifier response; receiving a second identifier response from the courier device when the located courier delivers the order to the first party; verifying delivery of the order to the first party by matching the second identifier with the second identifier response; and completing payment transaction for the order upon delivery verification.

In some embodiments, the method comprises sending the order request to the second electronic device and upon receiving acceptance of the order request from the second electronic device, the first and second corresponding identifiers for the order request are generated and sent to the second and first electronic devices respectively.

In some embodiments, the order comprises order attribute data and at least two waypoints, and wherein each of the at least two waypoints corresponds to a pick-up location or a drop-off location and comprises one or more waypoint attributes.

In at least some embodiments, the order request comprises waypoints for multiple drop-offs and/or multiple pick-ups.

In at least some embodiments, the method further comprises determining a total distance and a delivery time for the at least two waypoints using a mapping module.

In some embodiments, the payment transaction comprises determining a total charge that is based on the order attribute data and a delivery charge.

In some embodiments, locating the courier to fulfill the order further comprises broadcasting a courier request to a plurality of courier devices corresponding to couriers, the courier request comprising the total distance, the delivery time and address information for waypoints associated with the order for review by the couriers.

In other embodiments, the method further comprises determining a distance and an estimated delivery time (EDT) between the at least two waypoints using a mapping component.

In at least some embodiments, the EDT is determined by the management server and transmitted from the management server to the first electronic device of the first party.

In some embodiments, the payment transaction comprises a total charge, wherein the total charge is based on the order attributes and a delivery charge.

In some embodiments, the payment transaction is transmitted to a payment processor associated with the first party.

In some embodiments, the method further comprises receiving a payment pre-authorization response from the payment processor corresponding to the order authorization before generating the first and second identifiers.

In some embodiments, a payment processor approval is transmitted after the first and second identifier responses are matched with the first and second identifiers, respectively.

In some embodiments, the order attribute data comprise item data for at least one item ordered from the second party, vehicle type data for a type of vehicle needed to deliver the order, and address data, contact name data and task information data for instructions to be followed by the courier at each of the waypoints of the order.

In some embodiments, the order attribute data comprises weight and volume data that is used to determine the vehicle type data.

In some embodiments, the order is a custom run and the task information data comprises instructing the courier to take a picture of any goods being picked up and/or dropped off.

In some embodiments, the task information data comprises at least one of pick-up data including a pick-up time, and drop-off data including a drop-off time.

In some embodiments, the first party is a buyer and the second party is a merchant.

In some embodiments, the first party is at least one first individual and the second party is at least one second individual.

In another broad aspect, in at least one example embodiment described herein there is provided a method to facilitate the creation of an order request for the secure ordering, payment and delivery of at least one of goods and services using a communication network. The method comprises receiving item data from a first electronic device of a first party for at least one of goods and services to be ordered from a second party; receiving first waypoint data for a first waypoint of the order request, the first waypoint data comprising first address data, first contact data and first task instruction data; receiving second waypoint data for a second waypoint of the order request, the second waypoint data comprising second address data, second contact data and second task instruction data; packaging the item data, first waypoint data and second waypoint data into an order request; sending the order request to a second electronic device of the second party; upon acceptance of the order request by the second party, sending a courier request to a plurality of courier devices to locate one courier that will deliver the order; and upon acceptance of the courier request, sending an identifier for each waypoint to a contact at each waypoint, wherein the identifiers are used to verify the completion of tasks by the courier at each of the waypoints.

In another broad aspect, in at least one example embodiment described herein there is provided a method for facilitating authorization and payment for an order request using a secure ordering, payment and delivery system having a management server, the order request having at least first and second waypoints. The method comprises receiving authorization for the order request at the management server from a first electronic device of a creator of the order request; obtaining pre-payment authorization of the order request from a payment processor for the order request; generating first and second corresponding identifiers for the authorized order request at the management server; sending the first identifier from the management server to a second electronic device associated with the first waypoint; sending the second identifier from the management server to a third electronic device associated with the second waypoint; verifying task completion at the first waypoint when a first identifier response matching the first identifier is received at the management server; verifying task completion at the second waypoint when a second identifier response matching the second identifier is received at the management server; and sending authorization from the management server to a payment processor to complete payment transaction for the order request when the verifications have been successfully performed for the first and second waypoints.

In another broad aspect, in at least one example embodiment described herein there is provided a method for facilitating the secure ordering, payment and delivery of at least one of goods and/or services for an authorized order having first and second waypoints in a secure ordering, payment and delivery system having a management server. The method comprises generating first and second corresponding identifiers for the authorized order request at the management server; sending the first identifier from the management server to a first electronic device associated with the first waypoint; sending the second identifier from the management server to a second electronic device associated with the second waypoint; sending a courier request from the management server of the ordering and delivery system to a courier device for facilitating the authorized order request at the two waypoints; receiving a courier request response from the courier device at the management server to signify an acceptance of the courier request; and receiving an identifier response at the management server from the courier device for verification at a given waypoint where the courier has completed tasks associated with the given waypoint.

In another broad aspect, in at least one example embodiment described herein, there is provided a management server to facilitate a secure ordering, payment and delivery system for at least one of goods and services using a communication network that links a plurality of buyer devices, a plurality of merchant devices and a plurality of courier devices. The management server comprises at least one data store for storing databases related to a plurality of buyers and merchants that are registered for using the ordering and delivery system; and one or more processors coupled to the at least one data store and configured to perform the at least one of the methods defined according to the teachings herein.

In another broad aspect, in at least one example embodiment described herein, there is provided a system for facilitating the secure order, payment and delivery of at least one of goods and services between at least two parties using a communication network. The system comprises a plurality of buyer devices coupled to the communication network and configured to generate order requests; a plurality of merchant devices coupled to the communication network and configured to receive an order request and provide an order request acceptance; a plurality of courier devices; and at least one server configured to perform at least one of the methods according to the teachings herein.

In another broad aspect, in at least one example embodiment described herein, there is provided an electronic courier device for use in facilitating the secure order, payment and delivery of at least one of goods and/or services in a secure ordering, payment and delivery system. The electronic courier device comprises a memory element for storing a plurality of instructions; and one or more processors coupled to the memory element and configured to execute the plurality of instructions which, when executed cause the one or more processors to receive a courier request to deliver an order from a management server of the ordering and delivery system, the order comprising at least two waypoints; send a courier request response to the management server to signify an acceptance of the courier request; and transmit an identifier response to the management server for verification at a given waypoint where the courier has completed tasks associated with the waypoint.

In another broad aspect, in at least one example embodiment described herein, there is provided a computer readable medium comprising a plurality of instructions that are executable on one or more processors of a device for adapting the device to implement a method to facilitate the secure order, payment and delivery of at least one of goods and services using a communication network, wherein the method is defined according to at least one of the methods according to the teachings herein.

In another broad aspect, at least one embodiment described herein provides a method of creating an online store at a server to facilitate the secure order, payment and delivery of at least one item by a secure ordering, payment and delivery system, the online store being for a non-registered merchant that is previously not associated with the secure ordering, payment and delivery system. The method comprises receiving business attribute data sent from a creator device at the server for creating a business waypoint for the online store; receiving item attribute data sent by the creator device at the server for at least one item associated with the online store; associating the at least one item with the business waypoint at the server; receiving drop-off waypoint data sent by the creator device at the server for the waypoint where the ordered item is to be delivered; receiving an order request sent by the creator device at the server for at least one item at the online store; determining a charge for the order request at the server based on the at least one ordered item, a route between the business and drop-off waypoints and a delivery charge; sending information on the order request and the charge to the creator device for approval; receiving approval of the order request at the server and broadcasting the order request to an electronic device associated with the non-registered merchant to prepare at least one item and/or at least one service specified in the order request; and broadcasting the order request to courier devices for delivering the at least one ordered item.

In at least some embodiments, the method comprises creating the business waypoint at the server using the business attribute data sent from the creator device, the business attribute data comprising at least one of a business name, a business address and a business contact.

In at least some embodiments, the method comprises creating the at least one item for the online store at the server using the item attribute data sent from the creator device, the item attribute data comprising at least one of an item name, an item description, an item price, an item image, an item weight and an item volume.

In at least some embodiments, the method comprises creating the drop-off waypoint at the server using the drop-off waypoint attribute data sent by the creator device, the drop-off waypoint attribute data comprising at least one of a drop-off waypoint name, a drop-off waypoint address, a drop-off waypoint image, and drop-off waypoint contact information.

In another broad aspect, at least one embodiment described herein provides a computer readable medium comprising a plurality of instructions that are executable on one or more processors of a server for adapting the processors to implement a method of creating an online store at a server to facilitate the secure order, payment and delivery of at least one item by a secure ordering, payment and delivery system, the online store being for a non-registered merchant that is not previously associated with the secure ordering, payment and delivery system, wherein the method is defined in the preceding paragraphs.

In another broad aspect, at least one embodiment described herein provides a server for implementing a method of creating an online store at a server to facilitate the secure order, payment and delivery of at least one item by a secure ordering, payment and delivery system, the online store being for a non-registered merchant that is not previously associated with the secure ordering, payment and delivery system, wherein the server is configured to perform the method as defined in the preceding paragraphs.

In another broad aspect, at least one embodiment described herein provides an electronic device for implementing a method of creating an online store at a server to facilitate the secure order, payment and delivery of at least one item by a secure ordering, payment and delivery system, the online store being for a non-registered merchant that is not previously associated with the secure ordering, payment and delivery system. The electronic device comprises: a memory element for storing a plurality of instructions; and one or more processors coupled to the memory element and configured to execute the plurality of instructions which, when executed cause the one or more processors to: send business attribute data to a server for creating a business waypoint for an online store by the server; send item attribute data to the server for at least one item associated with the online store; send drop-off waypoint data to the server for the waypoint where the ordered item is to be delivered; send an order request to the server for at least one item at the online store; receive information on the order request and a charge determined by the server to determine approval; and send approval of the order request to the server.

In at least some embodiments, the business attribute data comprises at least one of a business name, a business address and a business contact.

In at least some embodiments, the item attribute data comprises at least one of an item name, an item description, an item price, an item image, an item weight and an item volume.

In at least some embodiments, the drop-off waypoint attribute comprises at least one of a drop-off waypoint name, a drop-off waypoint address, a drop-off waypoint image, and drop-off waypoint contact information.

In another broad aspect, at least one embodiment described herein provides a server for implementing a method of creating an online store at a server to facilitate the secure order, payment and delivery of at least one item by a secure ordering, payment and delivery system, the online store being for a non-registered merchant that is previously not associated with the secure ordering, payment and delivery system, wherein the server is configured to perform the method as defined in the preceding paragraphs.

It should be noted that there may be other electronic devices, management servers, systems and/or computer readable medium that may be directed to other aspects of one or more of the methods described in accordance with the teachings herein.

### BRIEF DESCRIPTION OF THE DRAWINGS

For a better understanding of the various example embodiments described herein, and to show more clearly how these various embodiments may be carried into effect, reference will be made, by way of example, to the accompanying drawings which show at least one example embodiment. The drawings will now be briefly described.

FIG. 1A illustrates a schematic diagram of an ordering and delivery system according to an example embodiment.

FIG. 1B illustrates a schematic diagram of the secure ordering, payment and delivery system of FIG. 1A according to a first use case.

FIG. 1C illustrates another schematic diagram of the secure ordering, payment and delivery system of FIG. 1A according to the first use case.

FIG. 1D illustrates another schematic diagram of the secure ordering, payment and delivery system of FIG. 1A according to the first use case.

FIG. 1E illustrates a schematic diagram of the secure ordering, payment and delivery system of FIG. 1A according to a second use case.

FIG. 1F illustrates another schematic diagram of the secure ordering, and payment and delivery system of FIG. 1A according to the second use case.

FIG. 2 illustrates a simplified schematic diagram of an electronic device, according to an example embodiment, for use with a secure ordering, payment and delivery system described herein.

FIG. 3A illustrates an example embodiment of a method for generating an order.

FIG. 3B illustrates an example embodiment of a method for locating a courier and sending identifiers for each waypoint for an order.

FIG. 3C illustrates an example embodiment of a method for correlating a first identifier and a second identifier with a first identifier response and a second identifier response, respectively, to verify secure fulfillment of an order.

FIGS. 4A to 4G illustrate an example embodiment of a series of graphical user interfaces that a user may use to create an order request.

FIG. 4H illustrates an example of how visual confirmation may be used to verify waypoints and a route that are generated for order fulfillment for an example order.

FIG. 4I illustrates an example of an order status updated in real time using appropriate time stamps and a text description.

FIGS. 5-1 and 5-2 are flow diagrams of an example embodiment of a remote point of sale and delivery settlement method showing an example of the sequence of events that occur and the devices that are involved.

FIG. 6A is a flow diagram of an example embodiment of a use case in which an end user creates an order using an embodiment of the secure ordering, payment and delivery system described herein.

FIG. 6B is a flow diagram of an example embodiment of another use case in which a merchant creates an order using an embodiment of a secure ordering, payment and delivery system described herein.

FIG. 6C is a flow diagram of an example embodiment of another use case in which an order is made for a non-registered merchant using an embodiment of a secure ordering, payment and delivery system described herein.

FIGS. 7A to 7C illustrates an example embodiment of several courier graphical user interfaces that may be displayed on a courier device and used by a courier when accepting a courier request and making a delivery and/or pickup.

FIG. 8 illustrates examples of some electronic messages that may be sent during the operation of an ordering and delivery system in accordance with the teachings herein.

FIG. 9 illustrates an example embodiment of a control panel that may be used to monitor and control the activity of an embodiment of a secure ordering, payment and delivery system described herein.

FIG. 10 illustrates an example embodiment of a process for an alternative embodiment of a secure ordering, delivery system that uses a management server having payment processing functionality and also allows a courier to pay for an order on behalf of a customer.

Further aspects and features of the embodiments described herein will appear from the following description taken together with the accompanying drawings.

### DESCRIPTION OF VARIOUS EXAMPLE EMBODIMENTS

Various processes, apparatuses, devices or systems will be described below to provide an example of at least one embodiment for the claimed subject matter. No embodiment described below limits any claimed subject matter and any claimed subject matter may cover processes, apparatuses, devices or systems that differ from those described below. It is possible that the claimed subject matter are not limited to apparatuses, processes, devices or systems having all of the features of any one apparatus, process, device or system described below or to features common to multiple or all of the apparatuses, processes, devices or systems described below. It may be possible that an apparatus, process, device or system described below is not an embodiment of any claimed subject matter. Any subject matter disclosed in an apparatus, process, device or system described below that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that there may be cases where the example embodiments described herein may be practiced without these specific details. In other instances, well-known methods, procedures and components have not been described in detail so as not to obscure the example embodiments described herein. Also, the description is not to be considered as limiting the scope of the example embodiments described herein in any way, but rather as merely describing the implementation of various embodiments as described herein.

It should be noted that terms of degree such as “substantially”. “about” and “approximately” when used herein mean a reasonable amount of deviation of the modified term such that the end result is not significantly changed. These terms of degree should be construed as including a deviation of the modified term if this deviation would not negate the meaning of the term it modifies.

Furthermore, the recitation of any numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation up to a certain amount of the number to which reference is being made if the end result is not significantly changed.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The example embodiments of the systems and methods described herein may generally be implemented in hardware or software, or a combination of both, where possible. In some cases, the example embodiments described herein may be implemented, at least partially, using one or more computer programs, executing on one or more programmable computing devices each comprising at least one processor, a data storage system (including volatile and non-volatile memory and/or storage elements), at least one input device (e.g. a keyboard, mouse or touchscreen), and at least one output device (e.g. a display screen, a printer, a wireless radio and the like).

For example, and without limitation, the programmable computers or communication devices may include servers, personal computers, laptops, tablets, personal data assistants (PDA), cell phones, smart phones, and other mobile devices. Program code can be applied to input data to perform the unique functions described herein and to generate output information. The output information can then be supplied to one or more output devices for outputting to one or more users.

In some of the example embodiments described herein, at least some of the programs may be implemented in a high level procedural or object oriented programming and/or scripting language or both. Accordingly, the program code may be written in C, C++. Java, SQL or any other suitable programming language and may include modules or classes, as is known to those skilled in object oriented programming. Alternatively, or in addition thereto, some of these programs may be implemented in assembly language, machine language or firmware as needed. In either case, the language may be a compiled or an interpreted language.

At least some of these programs may be stored on a storage media (e.g. a computer readable medium such as, but not limited to, ROM, a magnetic disk, an optical disc and the like) or a device that is readable by a general or special purpose computing device. The program code, when read by the computing device, configures the computing device to operate in a new, specific and predefined manner in order to perform at least one of the methods described herein.

Furthermore, at least some of the programs associated with the systems and methods of the example embodiments described herein are capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g. downloads), media, digital and analog signals, and the like. The computer useable instructions may also be in various formats, including compiled and non-compiled code.

The communication network that is used in the embodiments described herein may be implemented with various network technologies, such as wired or wireless distribution systems, fiber optic networks, satellite or extra-terrestrial systems, or any combination or hybrid thereof, and can include public (e.g., Internet) or private networks suitable for wired or wireless data communication.

It should also be noted that the terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices can be directly connected to one another or connected to one another through one or more intermediate elements or devices via an electrical element or electrical signal depending on the particular context. Furthermore, the term “communicative coupling” indicates that an element or device can electrically or wirelessly send data to another element or device as well as receive data from another element or device.

The example embodiments described herein generally relate to systems and methods for facilitating secure ordering and payment for delivery of goods or services between various parties. For example, the embodiments described herein may incorporate technology that facilitates the secure ordering, payment and delivery of goods or services between a first party, e.g. a buyer, and a second party, e.g. a merchant. Alternatively, some of the embodiments described herein may include technology to facilitate the secure ordering and payment for delivery of goods or services between a first party, e.g. a buyer, and a plurality of other parties, e.g. a plurality of merchants. In some embodiments, technology may be provided so that secure ordering, payment and delivery of goods or services may be initiated by a buyer, and in other embodiments, technology may be provided to enable the secure ordering, payment and delivery of goods or services that may be initiated by a merchant.

At least one of the example embodiments described herein may provide technology that allows a user, such as a buyer, with more control over the secure ordering, payment and delivery of goods or services, such as in controlling the delivery schedule or verifying whether an order has been fulfilled. For example, in some cases a buyer may need to add specific instructions related to a delivery such as, but not limited to, processing payment for goods using a specified payment method specified by the creator or a management server that uses a courier credit card. Alternatively, or in addition thereto, a buyer may need to add specific instructions related to the goods such as, but not limited to, specifying a different delivery location and a confirmation of delivery by picture, by what time the order should be prepared for delivery and/or ensuring that the payment instructions are carried out properly, for example.

In addition, it may be possible to use at least one of the systems described herein for allowing a party, such as a buyer, to create a delivery run for a non-merchant such as, but not limited to, a friend, a family member or a co-worker, for example.

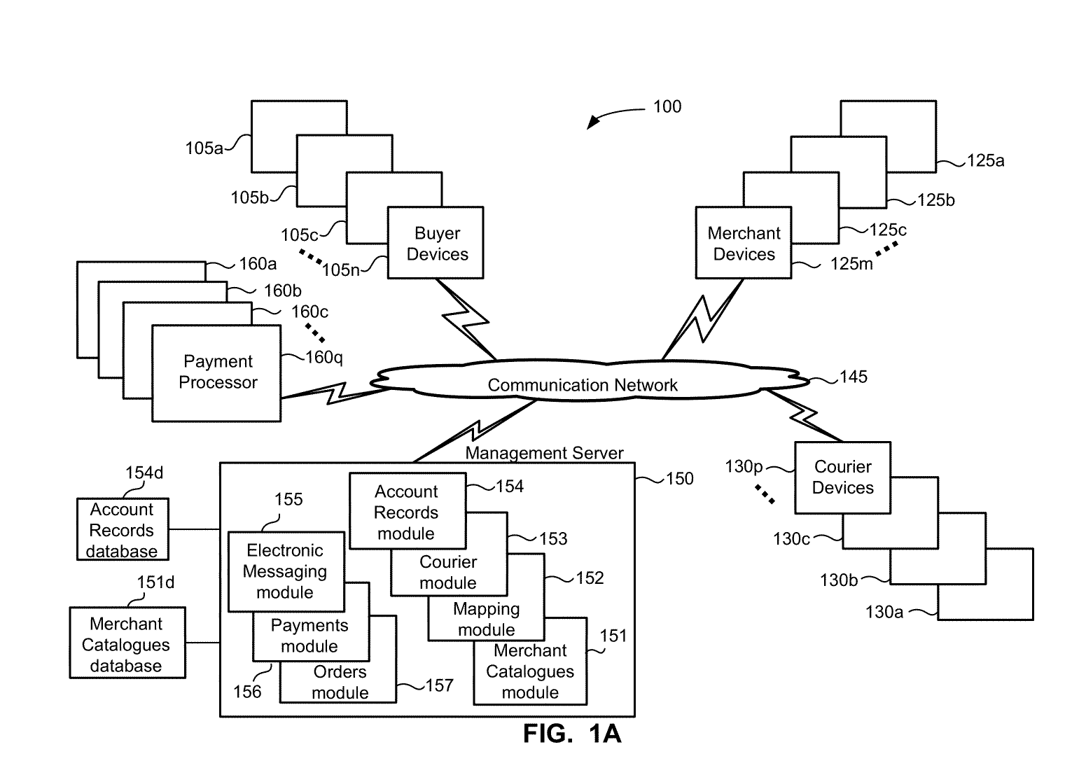

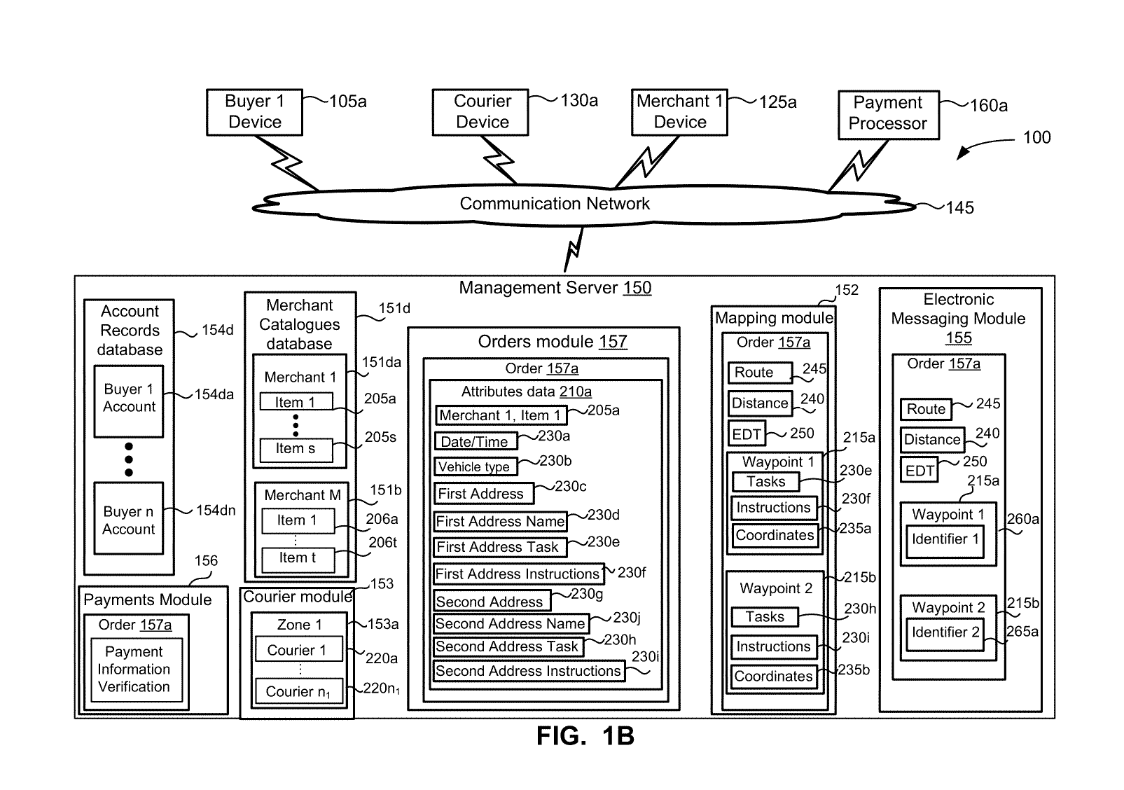

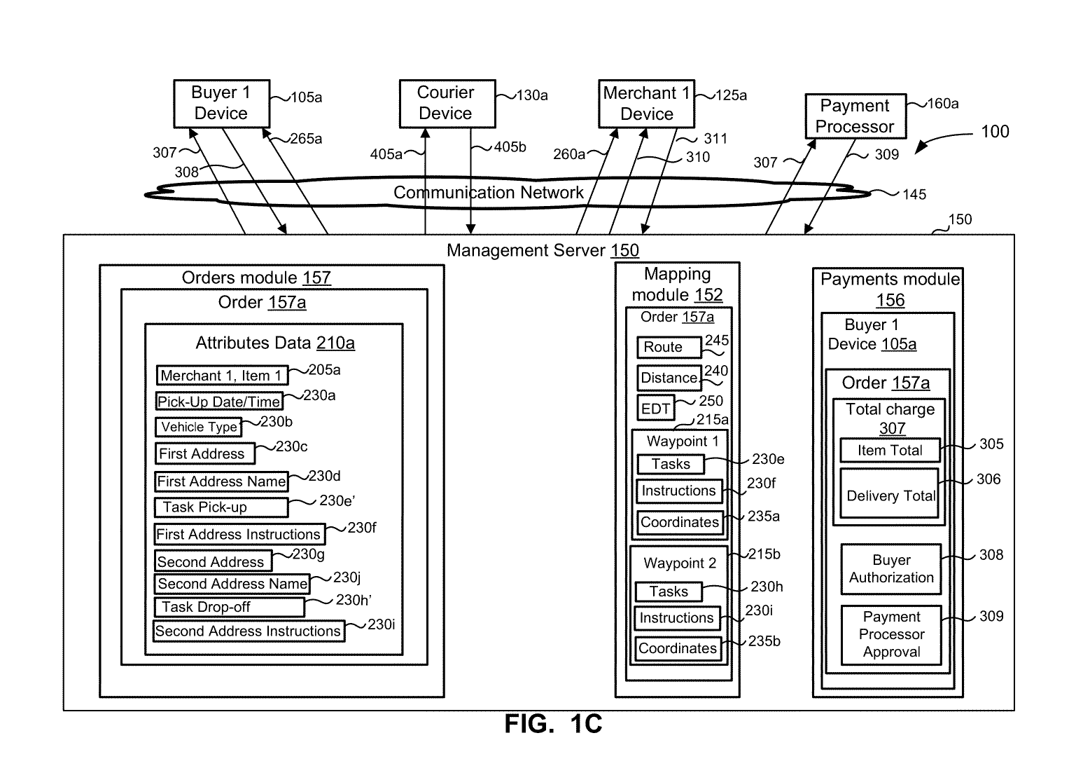

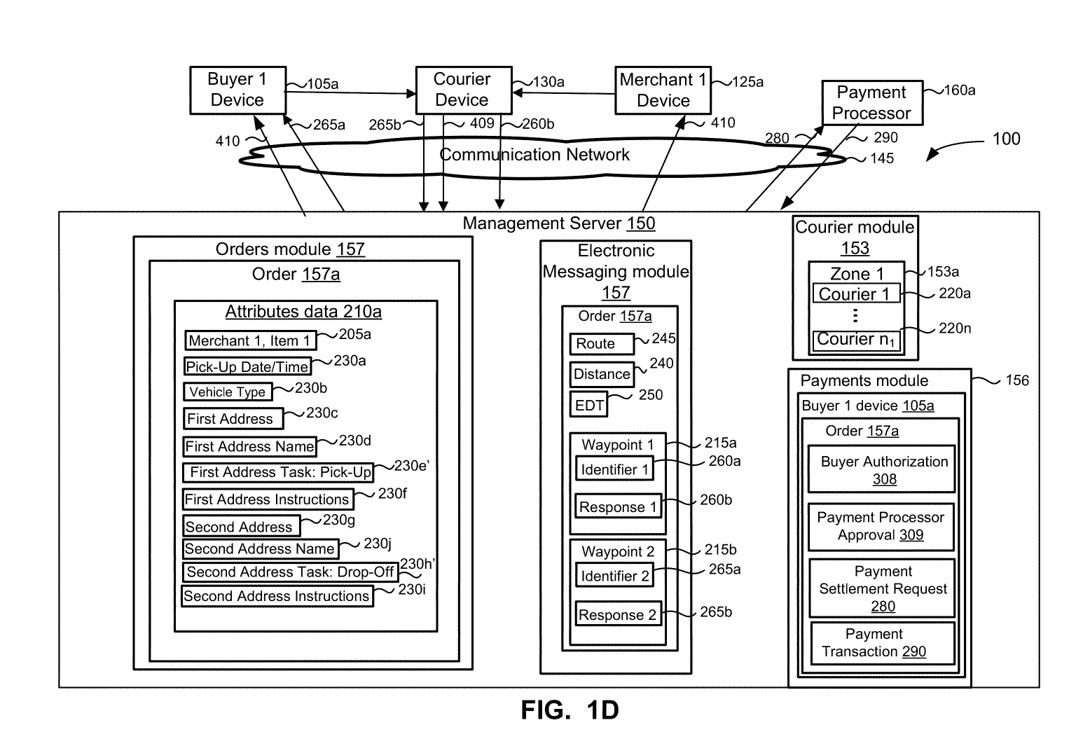

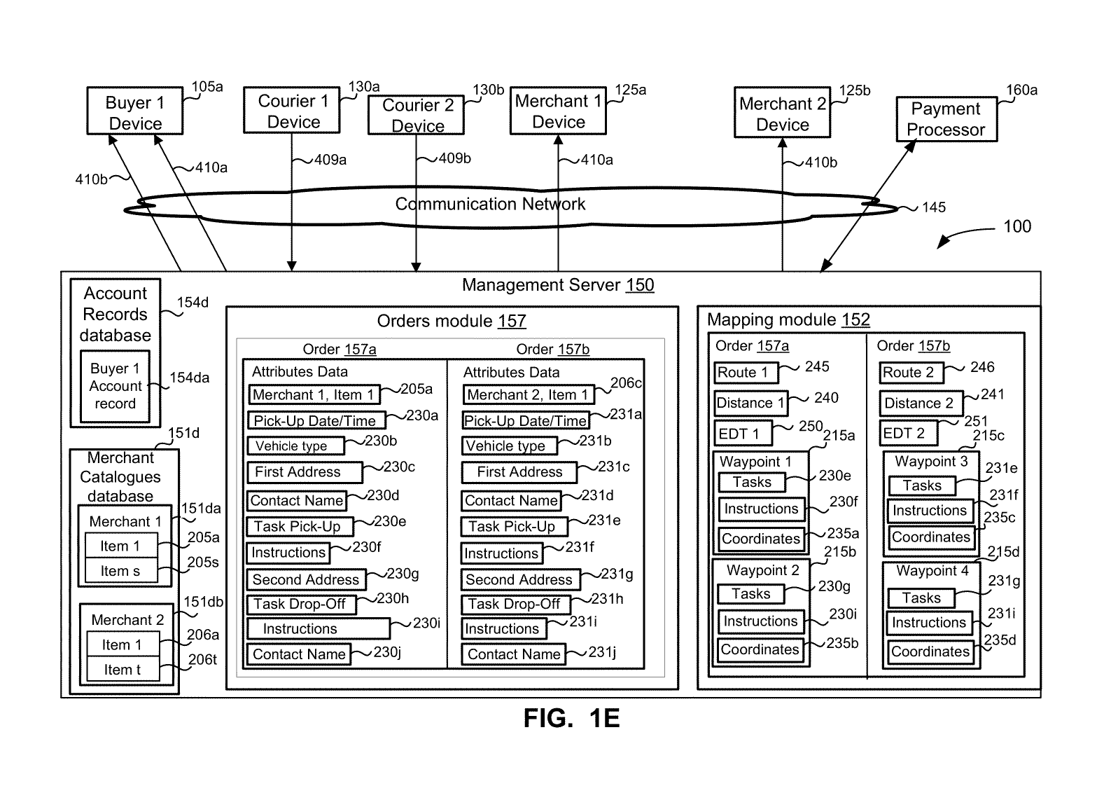

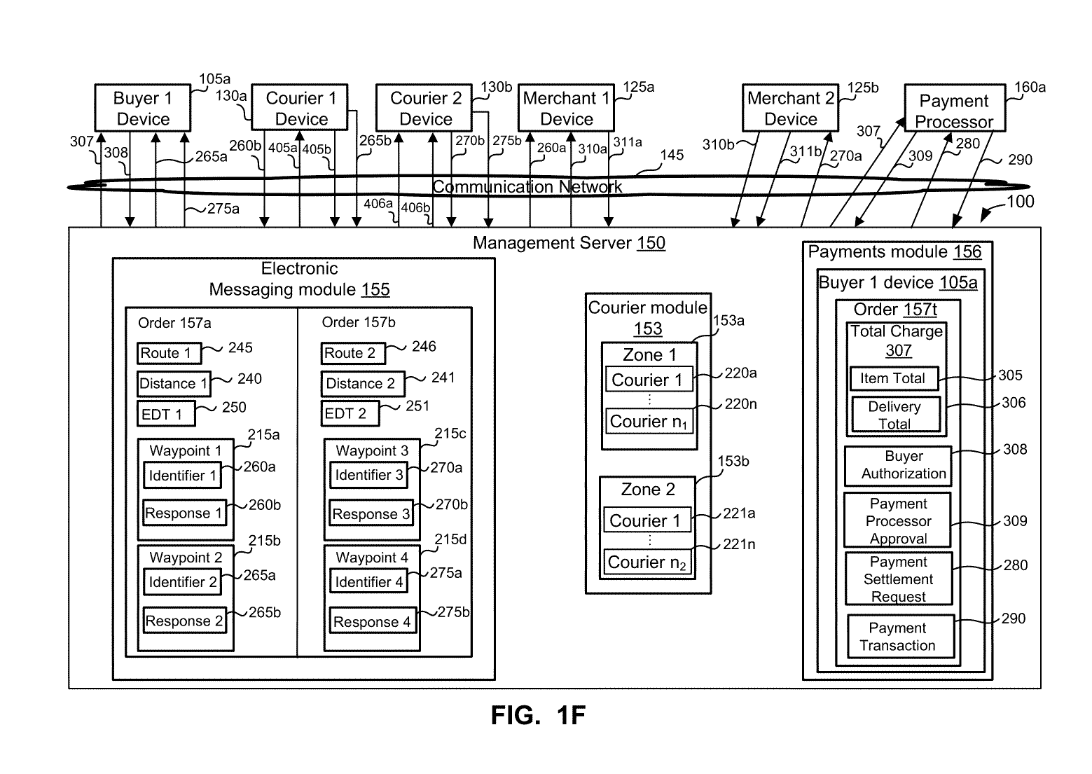

Reference is first made to FIG. 1, which illustrates an example embodiment of a secure ordering, payment and delivery system 100. The system 100 comprises a plurality of buyer devices 105a, 105b, 105c and 105n, a plurality of merchant devices 125a, 125b, 125c and 125m, and a plurality of courier devices 130a, 130b, 130c and 130p. These devices may be off the shelf or custom-made electronic devices that run software that allow the user of the devices to communicate with other entities of the system 100. Accordingly, these devices have communication abilities. The software may be written for any of several popular operating systems in use today. For example, the devices may be personal computers, laptops, tablets, personal data assistants (PDA), cell phones, smart phones, and the like, depending on who is using the device. For example, the courier devices 130a to 130n may be portable electronic devices whereas at least one of the buyer devices 105a-105n or the merchant devices 125a-125m may not be portable electronic devices but may be a desk-top computer.

The buyer device 105a represents a first buyer device, the buyer device 105b represents a second buyer device, the buyer device 105c represents a third buyer device and the buyer device 105n represents an n^{th} buyer device. Likewise, the merchant device 125a represents a first merchant device, the merchant device 125b represents a second merchant device, the merchant device 125c represents a third merchant device and the merchant device 125m represents an m^{th} merchant device. Similarly, the courier device 130a represents a first courier device, the courier device 130b represents a second courier device, the courier device 130c represents a third courier device, and the courier device 130p represents a p^{th} courier device. The variables n, m and p are integers and they do not have to be equal to one another. It should be noted that the courier devices 130a-130p are associated with couriers or delivery persons who accept jobs to pick up and deliver goods or facilitate the execution of certain services.

The system 100 may further comprise a plurality of payment processors 160a, 160b, 160c and 160q that process payments for orders that are made using the system 100. The payment processors 160a-160q may include, but are not limited to, a credit card processor such as Visa®, a debit card processor such as Interac®, or an online payment processor such as PayPal®, for example.

In other embodiments, it may be possible for the buyer to specify a cash payment which can be paid by the recipient of the delivered order at the time of delivery. However, merchants typically may receive payment at the time of order or at the time of pick-up depending on whether the payment is made via cash, electronic means or via a physical credit card, for example.

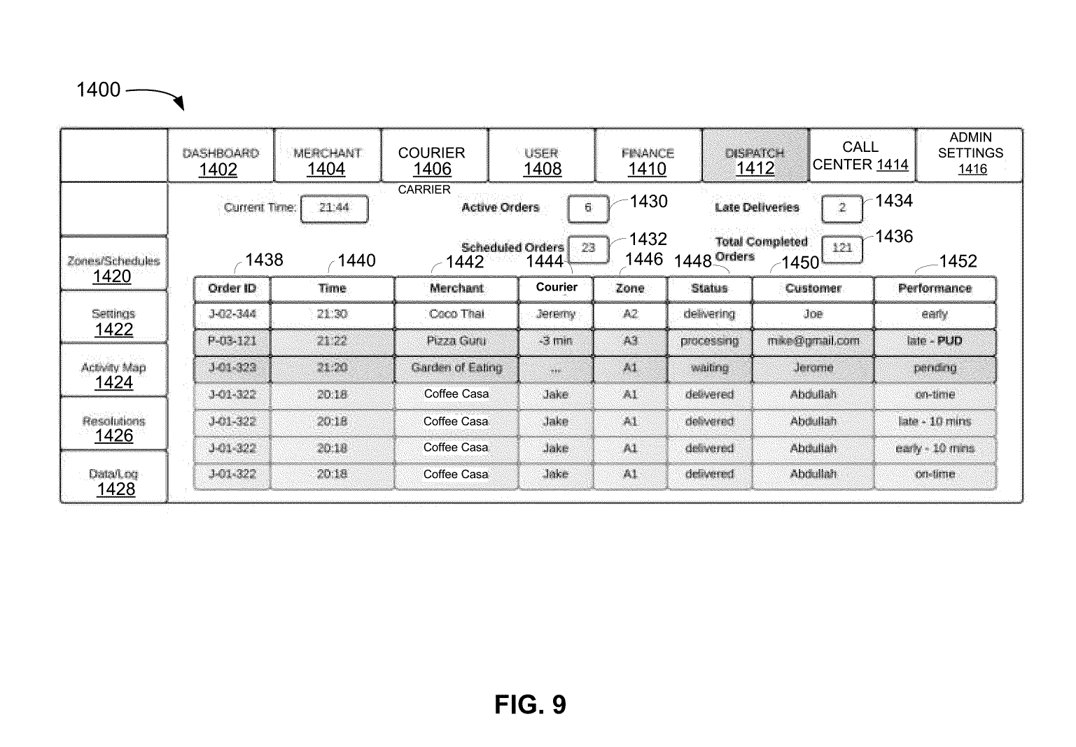

The system 100 further comprises a management server 150 that typically acts as the primary interface between the buyer devices 105a-105n, the merchant devices 125a-125m, and the courier devices 130a-130p, connecting to such devices via a communication network 145. The management server 150 may connect to the payment processors 160a-160q in different ways such as via communication network 145, for example. In an alternative embodiment (such as that shown in FIG. 9), the management server 150 may be modified to also provide payment processing and there would be no need for the payment processor 160a-160q.

The communication network 145 may be a wireless network or have various wired components such as a digital modem or other communication devices that connect to the Internet. In the case of a wireless network, the communication network 145 may contain one or more different communication channels that operate according to associated communication protocols such as, but not limited to, COMA, UTMS, GSM, GPRS, EDGE or LTE according to standards such as, but not limited to, IEEE 802.11a or 802.11g, for example.

The management server 150 may include at least one computer server equipped with one or more processors and memory storage components such as, but not limited to, a database or a file system, as well as an operating system and computer executable program code in the form of various software modules for implementing one or more of the various methods described herein. The components of the management server 150 may include a merchant catalogues module 151 for allowing users of the buyer devices 105a-105n to access items or services available for secure order, payment and delivery from one or more of the merchants 125a-125m, a mapping module 152 for determining distance and estimated delivery time for orders, a courier module 153 for locating couriers for a given delivery or for performing a specified task, an account records module 154 for creating and maintaining accounts for users of the system 100, such as buyers and storing buyer account information, an orders module 157 for generating and/or verifying orders, a payments module 156 for interfacing with at least one of the payment processors 160a-160q, and an electronic messaging module 155 for generating various electronic messages that are sent to the users of the system 100 to facilitate and/or provide real-time status updates for various steps of at least one of the secure order, payment and delivery processes as will be described in accordance with the teachings herein. The electronic messages may involve using various formats including, but not limited to, e-mail, short messaging service (SMS), instant messaging (IM) or any other suitable form of electronic messaging, for example such as electronic messages, push notifications, phone calls (automated), and the like.

The system 100 further comprises databases that store information that is used for the secure ordering, payment and delivery of goods and/or services or for the completion of certain tasks. The system 100 may further comprise a merchant catalogues database 151d and an accounts records database 154d. The merchant catalogues database 151d may be used to store the items available for secure order, payment and delivery from one or more of the merchants 125a-125m as well as other information about the merchants 125a-125m such as contact names, address information, and payment information (for facilitating transactions between one of the merchant devices 125a-125m and the management server 150). For a given merchant, the merchant catalogues database 151d may also include, but is not limited to, store information, store items, feedback from customers, and a contact list of customers. The merchant catalogues database 151d may also be used by the merchants to manage what products or services are being offered, as well as the pricing, potentially including discounts and promotions for these products or services, for example. The merchant catalogues database may also include information on non-registered merchants such as but not limited to, address, contact and payment information, for example. Non-registered merchants are merchants that may use the system 100 for deliveries or who may be sent deliveries by a user on a custom run (this is described in further detail below). The account records database 154d may be used to store buyer account information. The merchant catalogues database 151d and the accounts records database 154d may be stored in one data store or separate data stores that may be local or remote to the management server 150 depending on the particular implementation.

Referring now to FIG. 1B, illustrated therein is a schematic diagram of the secure ordering, payment and delivery system 100 according to a first use case. In this use case, the management server 150 is coupled to the communication network 145 for communicating with the first buyer device 105a, the first merchant device 125a, the payment processor 160a, and the first courier device 130a. In this example, a buyer creates an order using the buyer device 105a for goods from a merchant that corresponds to, or is using, the merchant device 125a, and the goods are delivered by a courier that corresponds to, or is using, the courier device 130a.

The account records database 154d stores a plurality of account records 154da-154dn. The account record 154da corresponds to the buyer using the first buyer device 105a, and the account record 154dn corresponds to the buyer who uses the nt buyer device 105n. The account record 154da may store, for example, buyer payment information such as, but not limited to, at least one of a credit card number, a debit card number, bank account information, a billing address, a shipping address, a purchase history, login information, and product preferences, for example.

The buyer device 105a may be configured to initiate the ordering process by receiving login information from the buyer associated with the account record 154da. The login information may comprise a user name and a password. The buyer device 105a sends this information to the management server 150. The management server 150 may then verify the login information to determine whether the user that is using the buyer device 105a is authorized to use the system 100 by determining if there is a corresponding buyer account 154ad in the account records database 154d. If not, the management server 150 may interact with the buyer device 105a to setup a new user account for this user and store the new user account in the account records database 154d.

When the login verification is successful, the management server 150 may then verify payment information associated with the account record 154da by, for example, requesting payment information from the user. In this case the user may enter the payment information into the device 105a which sends the payment information to the management server 150. Alternatively, the management server 150 may access stored payment information from the account record 154da. The payment information may comprise an account number, a credit card number, a debit card number and the like. The payment information may be transmitted to the payment processor 160a associated with the account record 154da, for security purposes or to ensure the payment information is still valid. (e.g. confirming card numbers, security codes, etc.). Alternatively, in some embodiments, it may not be necessary for a newly registered user to provide their payment information. In either embodiment, the payment information is generally used for pre-authorizing secure orders and completing financial transactions.

Once the buyer has been authorized to use the system 100, the buyer may use the buyer device 105a to browse merchant catalogues from the merchant catalogues database 151d to select items for secure purchase and delivery for a particular merchant. These items may be displayed as a webpage on the buyer device 105a. The merchant catalogues module 151 can generate these webpages to be responsive and adapt to different screen sizes of the buyer devices 105a-105n. In at least some embodiments, the store page may be shared with the merchant using the merchant device, and the merchant may edit their catalogue items at will to update their customer facing web store or webpage. In some embodiments, at least one of the buyer devices 105a-105n may have a native application that can be executed to generate pages that resemble webpages or website store pages.

The merchant catalogues database 151d comprises merchant catalogues from a plurality of merchants with associated merchant devices 125a-125m, wherein at least one item available for purchase from a given merchant is listed in the respective merchant catalogue. For example, the merchant catalogue 151da represents a merchant catalogue from a first merchant corresponding to the merchant device 125a, with a first item 205a to an s^{th} item 205s, and the merchant catalogue 151dm represents a merchant catalogue from an m^{th} merchant corresponding to the merchant device 125m, with a first item 206a to a t^{th} item 206t. The merchant catalogue module 151 uses the information in the merchant catalogues database 151d to generate documents that may be accessed by the buyer device 105a for viewing by the buyer. The documents may be in the form of webpages or pdf documents, for example, and may contain images, descriptions, options, weight and volume, feedback reviews, and pricing. All of the documents may be available digitally for browsing by the user so that they can create a shopping cart of the items that they desire. They may then proceed to a checkout page to purchase the desired items.

The merchant catalogues 151a-151m may be updated continuously by the merchants who use the merchant devices 125a-125m to provide real-time listings of items available for purchase. For example, the merchants may use an application stored on the merchant devices 125a-125m to upload new items or new information about existing items (i.e. price changes, availability, etc.) to the management server 150. Alternatively, the merchant catalogues module 151 may provide an interface, such as a webpage, that may be used by the merchants via merchant devices 125a-125m to upload this information.

In this example embodiment, a buyer uses the buyer device 105a to select the item 205a for purchase from the first merchant catalogue 151a which results in the creation of an order data object 157a, hereafter referred to as an order. In general, the orders module 157 facilitates the creation of an order from information received from the buyer device 105a in the form of an order request that was inputted by the buyer. The order request may then be processed by other components in the management server 150 to facilitate implementation of the order based on information that is included in the order 157a. For example, the order request can be transformed into an order object and have pricing information added to it which is then sent to the buyer device 105a for order authorization by the buyer. Once the order has been authorized, the order 157a is created. It should also be noted that the order object may be also known as a sprint object.

In this example embodiment, the order 157a may generally comprise order attribute data 210a, which may include, but not be limited to, at least one of, for example, at least one item selected from the first merchant catalogue 151a (and/or other merchant catalogues) for purchase (e.g. item 205a in this embodiment), order details entered by the buyer at the buyer device 105a including one or more of date and time for pick-up data 230a, vehicle type for delivery data 230b, first address data 230c (the actual address location for a first waypoint), first address name data 230d (i.e. a contact name) for the first address data 230c, first address task data 230e corresponding to at least one task to be performed at the first address (e.g., pick-up, drop-off, or return), first address instruction data 230f corresponding to the first address (e.g., instructions related to the goods or to the delivery), second address data 230g (the actual address location), second address task data 230h corresponding to at least one task to be completed at the second address (e.g., pick-up, drop-off, return, etc.), second address instruction data 230i corresponding to the second address task data 230f (e.g., instructions related to the goods or to the delivery), and second address name data 230j (e.g. contact name) for the second address. The first and second address name data 230d and 230j may each be the name of a person that the courier associated with the courier device 130a must interact with at the first and second addresses (also known as first and second waypoints) respectively. It should be noted that some orders may be generated using a subset of the order details listed above, depending on the particular nature of the order.

For example, each address or waypoint may have a corresponding “descriptions field” containing any specific information related to the waypoint such as the ORDER number that is to be delivered to that specific waypoint. For example, an order may be created to deliver PRODUCT A to waypoint 1 (the description of waypoint 1 would indicate that PRODUCT A is to be delivered there). The order may also include instructions to deliver PRODUCT B to waypoint 2 (which may be indicated as an instruction within the description as entered by the creator of the order).

Once the first and second address data 230c and 230g, the corresponding first and second task data 230e and 230h, and the corresponding task instruction data 230f and 230i (if any), are transmitted by the buyer device 105a to the management server 150, the orders module 157 generates the order 157a for authorization by the buyer.

The orders module 157 may also perform verification of generated orders. For example, the orders module 157 may perform one or more verification tasks such as, but not limited to, verifying that a task is associated with each address, verifying that at least one task is a drop-off, and the like, for example.

In some embodiments, at least one of the first and second address data 230c and 230g, respectively, may be automatically populated, for example, based on information about the buyer stored in the buyer account record 154da and/or information about the merchant whose items are being selected for purchase (this information may be in the merchant catalogues database 151d). In other embodiments, the first and second address data 230c and 230g, respectively, may be based on the current location (e.g. GPS coordinates) of the buyer device 105a and/or the merchant device 125a of the merchant from whom the buyer is requesting an order.

In other embodiments, the buyer device 105a may also transmit payment instruction data for at least one of the first and second address instruction data 230f and 230i. For example, the buyer device 105a may transmit payment instruction data for the first address instruction data 230f such as “make a payment of $25 at the pick-up address” and payment instruction data for the second address instruction data 230i to “collect $35 payment at drop-off address”.

The first and second address data 230c and 230g may be analyzed by the mapping module 152 to verify that the address data in the order is correct. The mapping module 152 may verify the first address data 230c and the second address data 230g, for example, by cross-referencing this address data against a postal office database to confirm that the addresses exist. Other cross-referencing or validation techniques to verify the address information may also be used.

The mapping module 152 then generates a first waypoint 215a corresponding to the first address data 230c, and a second waypoint 215b corresponding to the second address data 230g. The waypoints 215a and 215b comprise a plurality of waypoint attributes data which include, but are not limited to, at least one of first and second address task data 230e and 230h, first and second address instruction data 230f and 230i, and first and second coordinate data 235a and 235b that are generated from the first and second address data 230c and 230g, respectively. The mapping module 152 may use the first and second coordinate data 235a and 235b to calculate a distance 240 between the first waypoint 215a and the second waypoint 215b, to generate a route 245 between the first waypoint 215a and the second waypoint 215b, and to generate an Estimated Delivery Time (EDT) 250 for the route.

In some alternative embodiments, the EDT may be specified by the buyer using the buyer device 105a in terms of a minimum EDT that must be met or that the EDT must be at a certain time of day. In these cases, the mapping module 152 may use the specified EDT to determine the route as well as a start time for the courier to start to perform the task(s) associated with the order 157a.

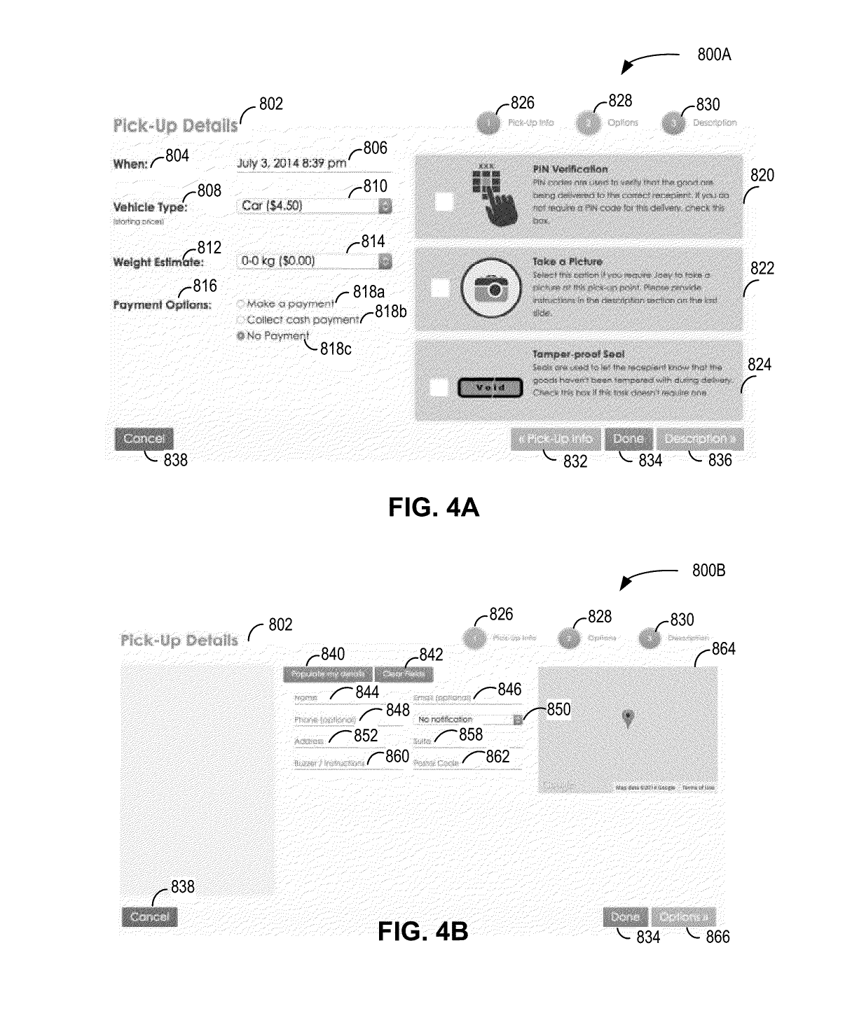

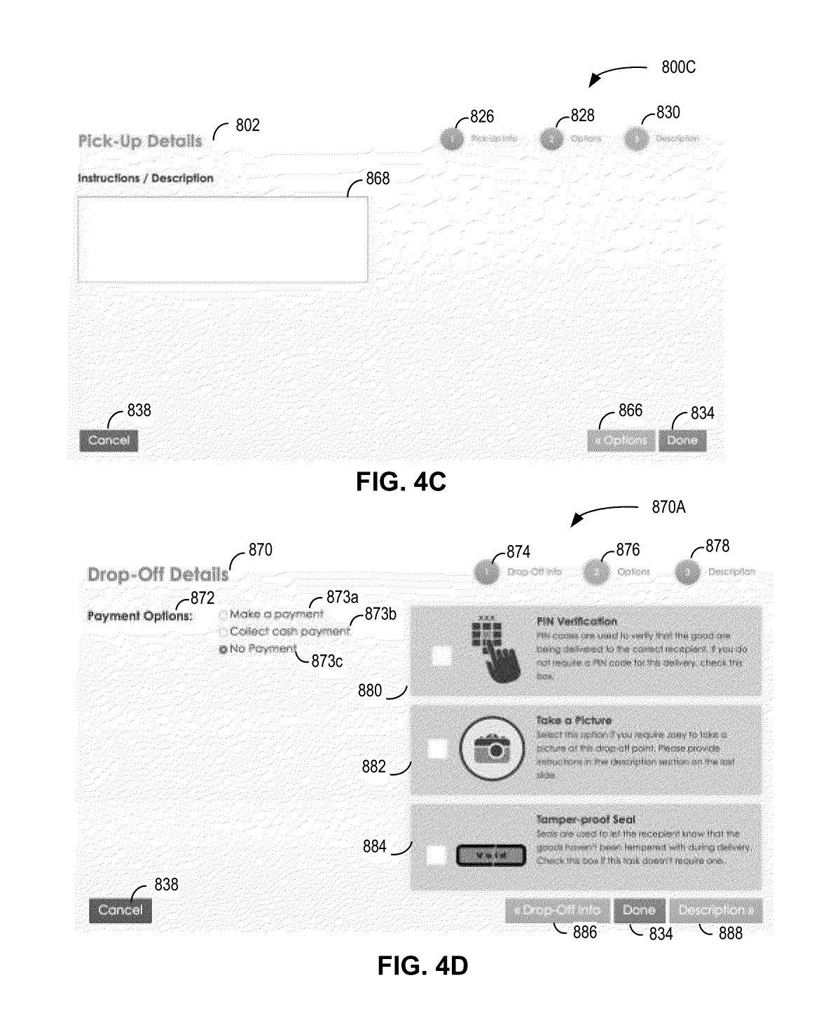

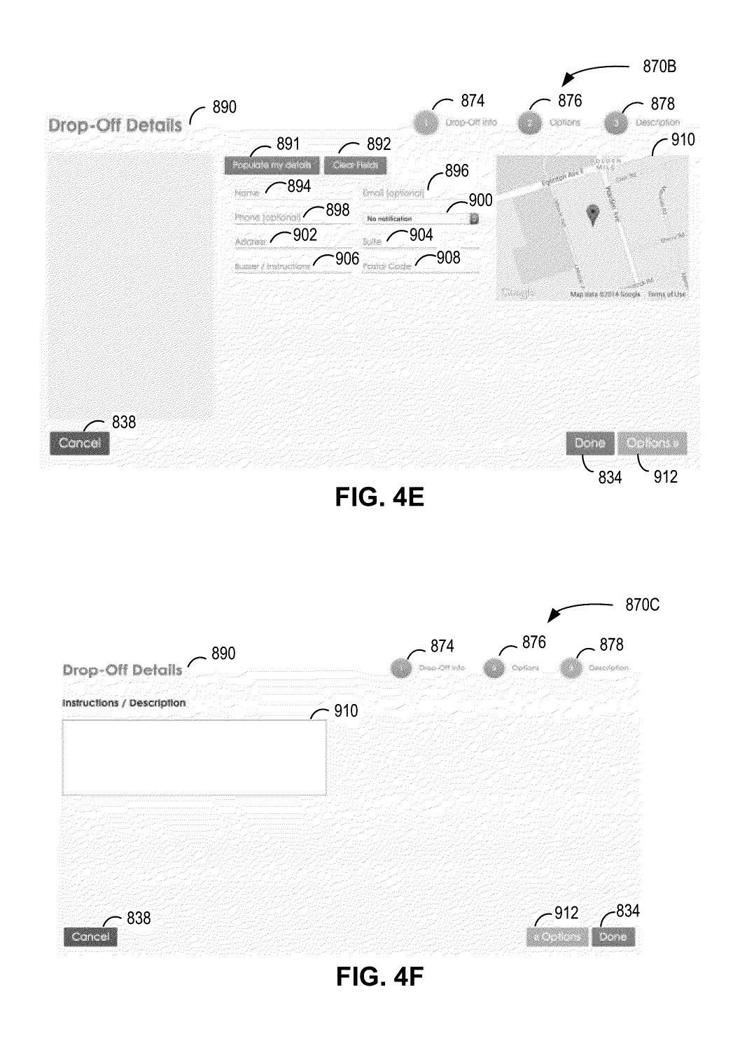

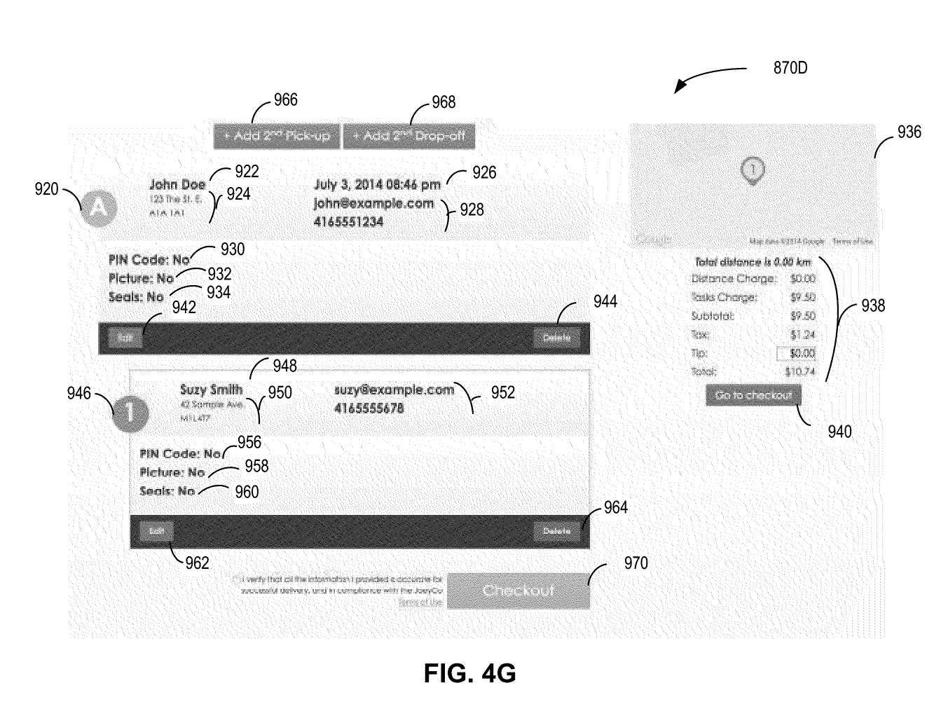

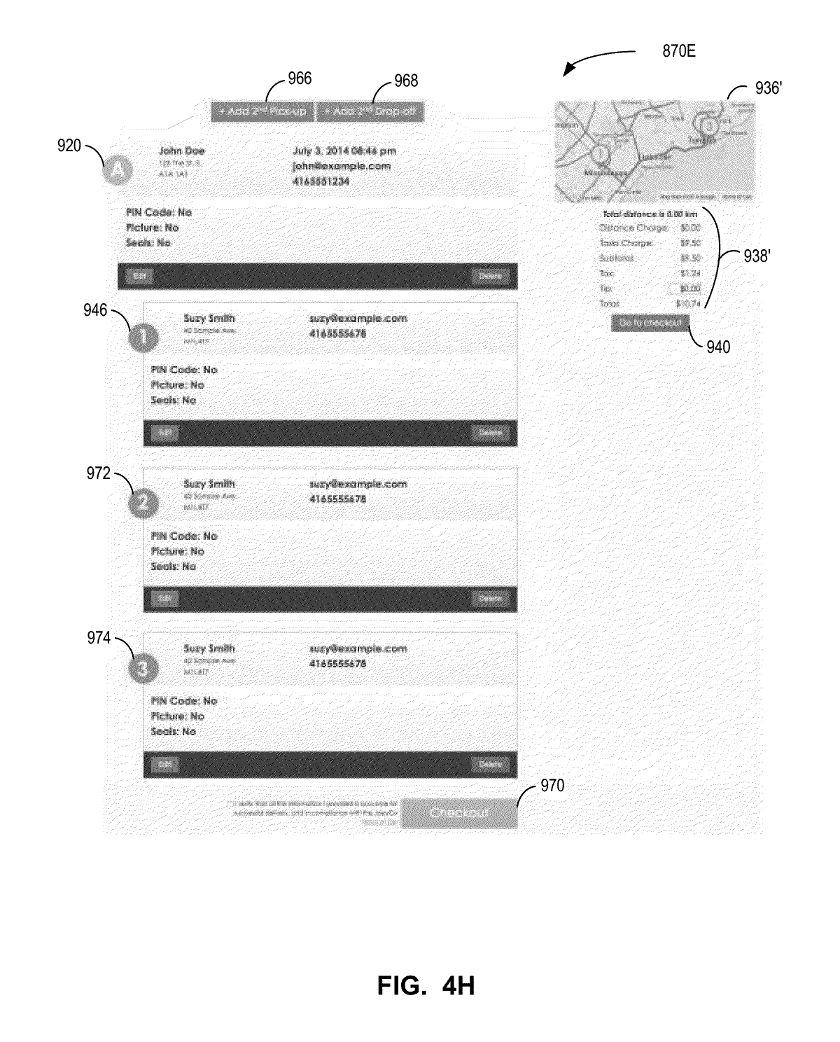

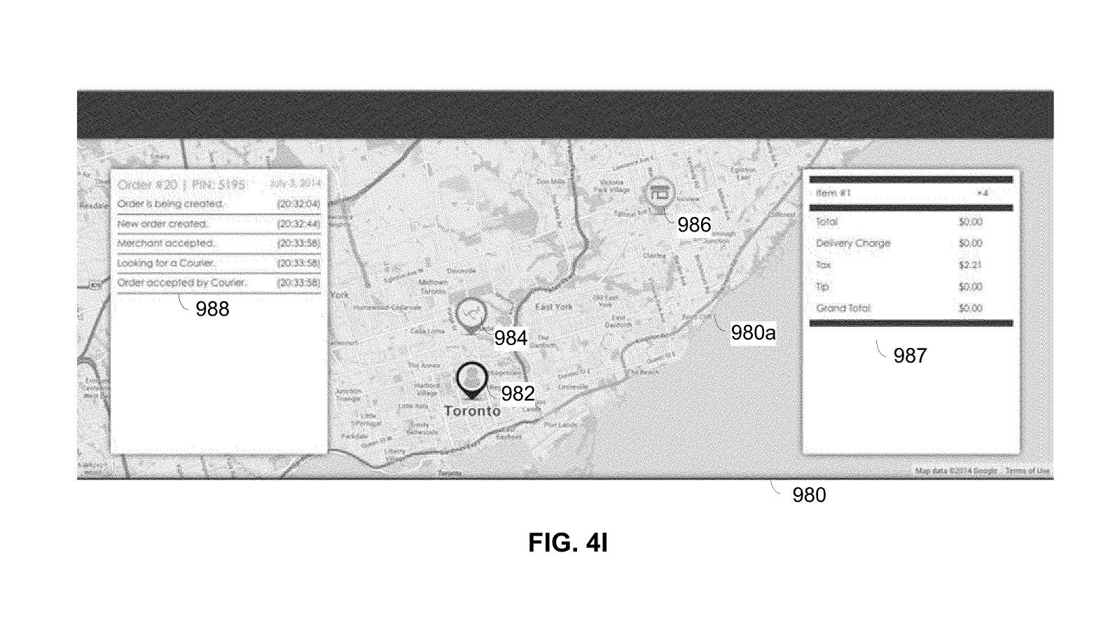

In at least some embodiments a visual map with the first and second waypoints 215a and 215b may be plotted by the mapping module 152 along with a highlighted route that may be displayed for visual confirmation of the address data and route (an example of a visual map is provided in FIG. 4I). Known mapping software may be used to implement the mapping module 152. However, in alternative embodiments, custom-made mapping software may be used. In at least some cases, the mapping module 152 may use latitude and longitude information for the address data and return travel times according to current traffic conditions, general geo-location of all waypoints, coordinates of the courier associated with the courier device 130a (assuming this is the courier selected for the task) and the EDT.

Reference is now made to both FIGS. 1B and 1C. FIG. 1C illustrates another schematic diagram of the ordering and delivery system 100 according to the first use case and showing the activity of the payments module 156. The distance 240, the route 245, and the EDT 250 generated by the mapping module 152 are used by the payments module 156 to generate total charge data 307 corresponding to the order 157a. The total charge data 307 comprises an item total 305 and a delivery total 306. The item total 305 is based on the cost of the items that are ordered, which in this example is item 205a from merchant 1. The delivery total 306 is based on the cost associated with the courier delivering the order from the merchant to the buyer. The delivery total 306 may be determined by a weighted calculation in which weights are applied to various parameters associated with the secure order, payment and delivery. For example, the delivery total may comprise a weighted average of at least two of the vehicle type 230b selected by the buyer device 105a, the distance 240, the route 245, and the EDT 250. The delivery total 306 may be determined in other ways in other embodiments.

The payments module 156 transmits the total charge data 307 to the buyer device 105a for buyer authorization of the order 157a. If the buyer agrees with the total charge, then the buyer uses the buyer device 105a to send buyer authorization 308. Upon receipt of the buyer authorization 308 from the buyer device 105a, the payments module 156 transmits the total charge data 307 to the payment processor 160a for payment processor approval 309. The payment processor approval 309 from the payment processor 160a means that the buyer account at the payment processor 160a that is associated with the buyer device 105a has adequate funds or credit available to pay for the total charge 307.

If the buyer device 105a transmits buyer authorization 308 for the total charge 307 and the payment processor 160a provides the payment processor approval 309, then the electronic messaging module 155 generates a purchase order request 310 and transmits the purchase order request 310 to the merchant device 125a. The purchase order request 310 may comprise at least one order attribute 210a such as, but not limited to, items selected by the buyer using the buyer device 105a for the order 157a, for example. The merchant corresponding to the merchant device 125a transmits a purchase order response 311 after reviewing the purchase order request 310, to either accept or decline the purchase order request 310.

Upon receiving the buyer authorization 308 from the buyer device 105a, the purchase order response 311 from the merchant device 125a that accepts the purchase order request 310, and the payment processor approval 309 from the payment processor 160a, the electronic messaging module 155 generates a first identifier 260a corresponding to the first waypoint 215a and a second identifier 265a corresponding to the second waypoint 215b. The first identifier 260a is transmitted to the merchant device 125a, and the second identifier 265a is transmitted to the buyer device 105a. At this point, the order 157a becomes a live order that requires a courier to carry out the order 157a. In other embodiments, other modules may generate the identifiers. For example, the orders module 157 may generate these identifiers in an alternative embodiment. A unique identifier is generated for each waypoint that is part of the order and sent to the device of the entity that the courier must deal with at that particular waypoint.

The courier module 153 locates which of the courier devices 130a-130p may be suitable for facilitating the order 157a. Once the courier devices are determined that are suitable to deliver the live order, the courier devices are sent a job notification. This may be sent in different ways, such as in a priority sequence based on the vicinity of these located courier devices to the first waypoint or first address. The courier device that is closest to the first address may be given the highest priority. In other embodiments, the located courier devices may be otherwise prioritized or categorized in another manner in terms of which courier would be preferred for carrying out the order.

Once the courier module 153 selects one of the courier devices 130a-130n to carry out the order, the courier module 153 transmits a courier request 405a to the selected courier device 130a-130n. The courier request 405a may include various data such as, but not limited to, task data 230e and 230h, task instruction data 230f and 230i, distance 240, route 245, and EDT 250, for example. The courier associated with the selected courier device 130a-130p then indicates whether they will accept or deny the courier request 405a by transmitting a courier response 405b using their courier device. The courier response 405b is then received by the courier module 153 which determines if the courier corresponding to the selected courier device has accepted the courier request 405a. If there is not an acceptance, then the courier module 153 selects another one of the courier devices 130a-130p and sends the courier request 405a to the selected courier device. This process may be repeated until one of the couriers accepts the courier request 405a.

Referring next to FIG. 1D, illustrated therein is another schematic diagram of the secure ordering, payment and delivery system 100 according to the first use case. Assuming that the courier device 130a has accepted the courier request 405a, the courier corresponding to the courier device 130a initiates the delivery process by arriving at the first waypoint 215a. The first waypoint 215a corresponds to the first address data 230c with the first address task data 230e comprising a pick-up in this example. In this example embodiment, the first address data 230c comprises the address of the merchant corresponding to the first merchant device 125a from which the buyer has selected an item for purchase. At the first waypoint 215a, the merchant corresponding to the first merchant device 125a enters a first identifier response 260b that corresponds to the first identifier 260a into the courier device 130a. The first identifier response 260b may be the first identifier 260a. In alternative embodiments, the first identifier response 260b may be generated based on the first identifier 260a by using an algorithm such as a cryptographic algorithm that uses the first identifier 260a as a key, for example. The first identifier response 260b may be entered by the contact at the merchant on the courier device 130a. Alternatively, near field communication, Bluetooth communication or some other short range communication technique may be used to send the first identifier response 260b to the courier device 130a. The first identifier response 260b is then sent to the management server 150 for further processing. In this example, the electronic messaging module 155 receives the first identifier response 260b for further processing. In alternative embodiments, other modules of the management server 150, such as the orders module 157, for example, may provide this function such as the orders module 157.

The electronic messaging module 155 receives the first identifier response 260b provided to courier device 130a by the merchant corresponding to the merchant device 125a, and determines whether the first identifier response 260b is correct. This may be done in several ways. For example, if the first identifier response 260b that is sent by the courier device 130a is supposed to be the first identifier 260a then the electronic messaging module 155 of the management server 150 will compare the first identifier 260a with the first identifier response 260b for a match. In other embodiments, a cryptographic algorithm may be applied using data unique to that creator and the first identifier 260a may be the unique data and the first identifier response 260b may be the output of the cryptographic algorithm when it operates on the unique data. It should be noted that the identifiers may be generated randomly, in a quasi-random manner or in a more definite/deliberate manner using a cryptographic algorithm.

If the first identifier 260a and the first identifier response 260b are matched, or otherwise correlated, by the electronic messaging module 155, the tasks 230e and instructions 230f associated with the first waypoint 215a are considered to be completed by the courier corresponding to the courier device 130a and verified by the management server 150. The electronic messaging module 155 may then send a status update to the buyer device 105a to inform that the task at the first waypoint has been completed.

The courier corresponding to the courier device 130a continues with the delivery process by arriving at the second waypoint 215b. The waypoint 215b corresponds to the address data 230g with the task data 230h comprising a drop-off task in this example. In this embodiment, the address data 230g comprises the address of the buyer corresponding to the buyer device 105a (alternatively, another drop off address may be specified by the buyer device 105a as will be discussed with respect to FIG. 4H). At the second waypoint 215b, the buyer corresponding to the buyer device 105a provides a second identifier response 265b corresponding to the second identifier 265a to the courier device 130a. The electronic messaging module 155 receives the second identifier response 265b provided to the courier device 130a by the buyer corresponding to the buyer device 105a, and compares the second identifier 265a with the expected identifier in a process that is similar to the comparison or correlation carried out at the first waypoint for the first identifier response 260b. If the second identifier 265a and the second identifier response 265b are matched, or otherwise correlated, by the electronic messaging module 155, the tasks 230h and instructions 230i associated with the second waypoint 215b are considered to be completed by the courier who is using the courier device 130a and the delivery is considered to be verified by the electronic messaging module 155. The waypoints are tagged complete once the correct identifier or PIN has been provided to the courier device 130a by the buyer or contact at the second waypoint after they are satisfied that the instructions for the second waypoint have been followed by the courier. Examples of tasks that may be marked as complete are the “pick-up task” or “drop-off task”. There may be other tasks associated with the waypoint which may not require an identifier.

If both first and second identifiers, 260a and 265a, are matched or otherwise correlated with the respective first and second identifier responses, 260b and 265b, by the electronic messaging module 155, or another suitable module at the management server 150, then the payments module 156 may transmit a payment settlement request 280 to the payment processor 160a to settle payment for the total charge 307. If the payment processor 160a can finalize the transaction, then the payment processor 160a sends a payment transaction 290. In some embodiments, there may not be any pre-authorizations for payment methods that involve cash or debit.

If either of the identifier responses 260b or 265b that is entered into the corresponding courier device (e.g. 130a in this embodiment) cannot be correlated by the electronic messaging module 155, then the management server 150 may initiate a return process. The return process may include, for example, the electronic messaging module 155, or another suitable module such as the orders module 157, determining the waypoint at which the incorrect identifier response was entered (or no identifier response was entered) and appending a return task to that waypoint. In this case, in some embodiments, the electronic messaging module 155 may request the mapping module 152 to perform a vicinity check and may request assistance from an administrator of the management server 150 or a dispatch officer. In addition, the order 157a may include further information such as an alternative delivery waypoint in case of an identifier mismatch or correlation failure. The alternative waypoint may only be engaged once a failed delivery is verified by the management server 150.

For a return, if the task at that waypoint indicates a pick-up, then the item that should have been picked up (item 205a in this example) may be removed from the order 157a by the orders module 157 and the order 157a may be regenerated in case there are items at other waypoints that still need to be picked up. In addition, the payments module 156 may update the total charge 307 to reflect the item removal. The electronic messaging module 155 may then transmit an electronic message to the buyer device 105a indicating that the task at the corresponding waypoint was not completed and/or there was a return of an item.

Still continuing with the case of a return, if the task at that waypoint indicates a drop-off then the item that should have been dropped off (i.e. item 205a in this example) may be removed from the order 157a by the orders module 157. In addition, the payments module 156 may update the total charge 307 by reducing it due to the removal of the item. The electronic messaging module 155 may then transmit an electronic message to the buyer device 105a and the corresponding merchant device 125a, indicating that the task at the corresponding waypoint was not completed. In some cases, an electronic message may also be transmitted to the courier device 130a with instructions to return to the previous waypoint.

In some cases, the user (e.g. the buyer in this example) may define alternative instructions in the task instruction data in the event of an error or a failure in delivery. The alternative instructions may comprise an alternative return task. For example, when food is the purchased item, the buyer may provide instructions for the courier to dispose of the food or to return the product to its pick-up location in the case of no delivery.

The electronic messaging module 155 may also transmit a status update 410 to the buyer device 105a and the merchant device 125a as the courier is travelling from one waypoint to another waypoint. The status update 410 may include the distance 240, the route 245, the EDT 250, and a current courier location indicator 409 (e.g. GPS coordinates) of the courier device 130a. The status update 410 may also indicate whether the identifiers 260a, 260b, 265a or 265b have been entered and verified. The status update 410 may be transmitted constantly to provide real-time traceability of the order 157a. In at least some embodiments, the merchant device 125a may also receive its updates for the electronic messaging module 155 once relevant status information is gathered or determined from the activity of the courier device 130a and the buyer device 105a.

In some embodiments, the management server 150 may settle payment with the payment processor 160a associated with the buyer device 105a for the total charge 307 before the first and second identifiers 260a and 265a are matched, or otherwise correlated, with the first and second identifier responses 260b and 265b, respectively. For example, it may be advantageous for the courier corresponding to the courier device 130a to pay the merchant corresponding to the merchant device 125a directly. In this scenario, the buyer device 105a transmits the buyer authorization 308 and the payment processor 160a provides the payment processor approval 309. The payments module 156 may then transmit the payment settlement request 280 to the payment processor 160a to settle payment for the total charge 307.

If the settlement request 280 is approved by the payment processor 160a, the payments module 156 transfers the amount for the final charge to a temporary account associated with the order 157a. Upon arriving at the first waypoint 215a, the courier corresponding to the courier device 130a presents the merchant corresponding to the merchant device 125a with payment for the item total 305 from the temporary account associated with the order 157a, which may be implemented with a credit card, debit card, electronic payment, or any other suitable payment method.

Reference is next made to FIGS. 1E and 1F, which respectively illustrate two schematic diagrams of the secure ordering, payment and delivery system 100 for a second use case example. In this example, the management server 150 is coupled to the communication network 145 for communicating with the first buyer device 105a, the first merchant device 125a, a second merchant device 125b, the payment processor 160a, the first courier device 130a and a second courier device 130b. In this embodiment, a buyer creates an order using the buyer device 105a for goods from merchants corresponding to the merchant devices 125a and 125b, and the goods are delivered by one or more couriers corresponding to the courier devices 130a and 130b.

In this example, the buyer uses the buyer device 105a to start the ordering process as was explained in the first use case example of FIGS. 1B to 1D by selecting at least one item from the merchant associated with the merchant device 125a and at least one item from the merchant associated with the merchant device 125b which may be done by viewing, and selecting the items from, the merchant catalogues 151a and 151b that correspond to the merchants associated with merchant devices 125a and 125b, respectively. In particular, the catalogue 151da represents a merchant 1 catalogue for a first merchant corresponding to the merchant device 125a, with the merchant 1 catalogue having a first item 205a to an s^{th} item 205s, and the catalogue 151db represents a merchant 2 catalogue for a second merchant corresponding to the merchant device 125b, with the merchant 2 catalogue having a first item 206a to a t^{th} item 206t. The merchant catalogues in the merchant catalogues database 151d may be updated continuously, for example by the merchant devices 125a-125m, to provide real-time listings of items available for purchase as was described earlier with respect to FIG. 1B.

In this example, the buyer uses the buyer device 105a to select an item 205a for purchase from the merchant catalogue 151da and item 206c from the merchant catalogue 151db to create an order 157b. The orders module 157 facilitates the secure fulfillment of orders created by the buyers by using other components in the management server 150. The order 157b comprises order attribute data 210b, which may include for example, but not be limited to, the items selected from the merchant catalogues 151da and 151db for purchase (e.g. items 205a and 206a in this example), order data entered by the user at the buyer device 105a including date and time for pick-up data 230a and 231a for items 205a and 206a, respectively, first and second vehicle type data 230b and 231b if two couriers will be used, first address data 230c and 231c, first contact name data 230d and 231d for the first addresses, first task data 230e and 231e corresponding to the first addresses respectively (e.g., pick-up, drop-off, return), first instruction data 230f and 231f corresponding to the first task data 230e and 231e (e.g., instructions related to the goods or to the delivery), second address data 230g and 231g, second task data 230h and 231 h associated with the second addresses respectively (e.g., pick-up, drop-off, return, etc.), second task instruction data 230i and 231i corresponding to the second task data 230f and 231f (e.g., instructions related to the goods or to the delivery), and contact name data 230j and 231j for the second addresses, respectively.

Once the first address data 230c and 231c, the second address data 230g and 231g, the corresponding first task data 230e and 230h as well as the corresponding second task data 231e and 231h, and the first task instruction data 230f and 230i as well as the second task instruction data 231f and 231i (if any) are provided by the buyer using the buyer device 105a for the order 157b, the orders module 157 verifies the data entered for the order 157b. The verification by the orders module 157 may include, but is not limited to, at least one of verifying that a task is associated with each address, or verifying that at least one task is a drop-off, for example.

In some embodiments, the address data 230c and 231c may be automatically populated, for example, based on the merchants whose items have been selected for purchase if the merchants are properly registered and information about them is stored in the merchant catalogues database 151d or another suitable data store. In other embodiments, the address data 230c and 231c may be based on the current location (e.g. GPS coordinates) of the merchant devices 125a and 125b.

In other embodiments, the buyer device 105a may transmit payment instructions in the instruction data 230f, 230i, 231f and 231i. For example, the buyer device 105a may transmit instruction data 230f to “make a payment at the pick-up address for $25” and instruction data 230i to “collect payment of $35 at drop-off address”.

The first address data 230c and 231c as well as the second address data 230g and 231g are transmitted to the mapping module 152 to verify the addresses for pick-up and delivery. The mapping module 152 verifies the address data 230c, 231c, 230g, and 231g for example by cross-referencing addresses against a postal office database to confirm that the addresses exist. Alternatively, other verification techniques may be used.

The mapping module 152 then generates a first waypoint 215a corresponding to pick-up address specified in first address data 230c, a second waypoint 215b corresponding to a drop-off address specified in second address data 230g, a third waypoint 215c corresponding to pick-up address specified in the first address data 231a, and a fourth waypoint 215d corresponding to drop-off address specified in the second address data 231g. The waypoints 215a, 215b, 215c, and 215d comprise at least one of a plurality of waypoint attribute data including, but not limited to, task data 230c, 231c, 230h and 231h, instruction data 230f, 230i, 231f and 231i, and coordinate data 235a, 235b, 235c and 235d generated from the pick-up and drop-off address information in the address data 230c, 230g, 231c and 231g, respectively.

The mapping module 152 may use the coordinates 235a and 235b to calculate a first distance 240 between the first waypoint 215a and the second waypoint 215b, generate a first route 245 between the first waypoint 215a and the second waypoint 215b, and generate a first estimated delivery time (EDT 1) 250 for the first route 245. The mapping module 152 may then use the coordinates 235c and 235d to calculate a second distance 241 between the third waypoint 215c and the fourth waypoint 215d, generate a second route 246 between the third waypoint 215c and the fourth waypoint 215d, and generate a second estimated delivery time (EDT 2) 251 for the second route 246.

The first and second distances 240 and 241, the first and second routes 245 and 246, and the first and second EDTs 250 and 251 corresponding to the first and second routes, respectively, generated by the mapping module 152 may then be transmitted to the payment module 156 to generate a total charge 307 corresponding to the order 157b. The total charge 307 comprises an item total 305 and a delivery total 306. In this example, the item total 305 is based on the combined cost of item 205a and item 206a. The delivery total 306 is based on the combined cost of the first and second delivery charges for the delivery of the items 205a and 206a, respectively. For example, a first delivery charge may be a weighted calculation comprising the vehicle type 230b, the distance 240, the route 245, and the EDT 250. The second delivery charge may then be a weighted calculation comprising the vehicle type 231b, the distance 241, the route 246 and the EDT 251. The payment module 156 may then transmit the total charge 307 to the buyer device 105a for buyer authorization 308. Upon receipt of the buyer authorization 308 from the buyer device 105a, the payment module 156 may transmit the total charge 307 to the payment processor 160a for payment processor approval 309. This is a pre-authorization as the financial transaction is not finalized until the courier completes the tasks associated with the various waypoints.

If the buyer device 105a transmits the buyer authorization 308 for the total charge 307 and the payment processor 160a provides the payment processor approval 309, the electronic messaging module 155 generates purchase order requests 310a and 310b, which may also be known as new order notifications, for each merchant, and transmits the purchase order request 310a to the merchant device 125a and the purchase order request 310b to the merchant device 125b. The purchase order requests 310a and 310b may comprise at least one order attribute data 210b, for example, the items selected by the buyer device 105a from the corresponding merchant catalogues 151a and/or 151b for the order 157b.

The merchant corresponding to the merchant device 125a may then transmit a purchase order response 311a to the purchase order request 310a to either accept or decline the purchase order request 310a, and the merchant corresponding to the merchant device 125b transmits a purchase order response 311b to either accept or decline the purchase order request 310b.

Upon receiving the buyer authorization 308 from the buyer device 105a, the purchase order responses 311a and/or 311b in which the corresponding purchase order requests 310a and/or 310b are accepted, and the payment processor approval 309 from the payment processor 160a, the electronic messaging module 155 generates a first identifier 260a corresponding to the first waypoint 215a, a second identifier 265a corresponding to the second waypoint 215b, a third identifier 270a corresponding to the third waypoint 215c, and a fourth identifier 275a corresponding to the fourth waypoint 215d. The first identifier 260a is transmitted to the merchant device 125a, the second identifier 265a is transmitted to the buyer device 105a, the third identifier is transmitted to the merchant device 125b, and the fourth identifier 275a is transmitted to the buyer device 105a.

The identifiers are not typically sent to the courier devices from the system 100 as they must be provided by an electronic device at the waypoint, such as a buyer device or a merchant device, to the courier device. This information may be inputted using various techniques including a short-range communication technique such as Near Field Communication (NFC), Bluetooth signals or Infrared signals. Alternatively QR codes may be used. Therefore, obtaining this information requires the courier device to be at the waypoint. This improves the security of the order; delivery and payment process as it involves verifying that the courier device was physically present at the waypoint when facilitating or fulfilling a particular order. The courier module 153 then locates which of the courier devices 130a-130p are suitable for carrying out the orders 157a and 157b as was discussed previously.

In this example, it should be noted that the second and fourth waypoints are the same, i.e. the location of the buyer device 105a. However, in other use cases, the second and fourth waypoints may be different from one another. For example, the buyer may specify that one item is to be delivered to the buyer (i.e. the second waypoint is the location of the buyer device 105a) and the buyer may specify that the other item is to be delivered somewhere else. In another use case, the second and fourth waypoints may each be different than the location of the buyer device 105a.

A courier response 405b transmitted by the courier device 130a and received by the courier module 153 may indicate that a courier corresponding to the courier device 130a accepts the courier request 405a. Similarly, a courier response 406b transmitted by a courier device 130b and received by the courier module 153 may indicate that a courier corresponding to the courier device 130b accepts the courier request 406a.

The courier corresponding to the courier device 130a arrives at the first waypoint 215a. The first waypoint 215a corresponds to the first address data 230c with the first address task data 230e indicating a pick-up, which in this example is the address of the merchant corresponding to the merchant device 125a. At the first waypoint 215a, the merchant corresponding to the merchant device 125a enters a first identifier response 260b corresponding to the first identifier 260a into the courier device 130a. Likewise, the courier corresponding to the courier device 130b arrives at the third waypoint 215c. The waypoint 215c corresponds to the address data 231c with the address task data 231e indicating a pick-up, which in this example, is the address of the merchant corresponding to the merchant device 125b. At the third waypoint 215c, the merchant corresponding to the merchant device 125b enters a third identifier response 270b corresponding to the third identifier 270a into the courier device 130b.

The electronic messaging module 155 receives the first identifier response 260b provided to the courier device 130a by the merchant corresponding to the merchant device 125a, and matches or otherwise correlates the first identifier 260a with the first identifier response 260b. If the first identifier 260a and first identifier response 260b are matched or otherwise correlated by the electronic messaging module 155, the tasks 230e and instructions 230f associated with the first waypoint 215a are considered to be completed by the courier corresponding to the courier device 130a and verified by the management server 150. At this point a status update message may be sent to the buyer device 105a indicating that this verification has occurred.

Similarly, the electronic messaging module 155 receives the third identifier response 270b provided to the courier device 130b by the merchant corresponding to the merchant device 125b, and matches or otherwise correlates the third identifier 270a with the third identifier response 270b. If the third identifier 270a and third identifier response 270b are matched or otherwise correlated by the electronic messaging module 155, the tasks 231e and the instructions 231f associated with the third waypoint 215c are considered to be completed by the courier corresponding to the courier device 130b and verified by the management server 150.

The courier corresponding to the courier device 130a continues with the delivery process by arriving at the second waypoint 215b. The second waypoint 215b corresponds to the address 230g with the task 230h indicating a drop-off, which in this example is the address of the buyer corresponding to the buyer device 105a. At the second waypoint 215b, the buyer corresponding to the buyer device 105a provides a second identifier response 265b corresponding the second identifier 265a to the courier device 130a. The electronic messaging module 155 receives the second identifier response 265b provided to the courier device 130a by the buyer corresponding to the buyer device 105a, and matches or otherwise correlates the second identifier 265a with the second identifier response 265b. If the second identifier 265a and second identifier response 265b are matched or correlated by the electronic messaging module 155, the tasks 230h and instructions 230i associated with the second waypoint 215b are considered to be completed by the courier corresponding to the courier device 130a and verified by the electronic messaging component 155.

Similarly, the courier corresponding to the courier device 130b continues with the delivery process by arriving at the fourth waypoint 215d. The fourth waypoint 215d corresponds to the address 231g with task 231h as drop-off, which in this example, is the address of the buyer corresponding to the buyer device 105a. At the fourth waypoint 215d, the buyer corresponding to the buyer device 105a provides a fourth identifier response 275b corresponding to the fourth identifier 275a to the courier device 130b. The electronic messaging module 155 receives the fourth identifier response 275b from the courier device 130b, and matches or otherwise correlates the fourth identifier 275a with the fourth identifier response 275b. If the fourth identifier 275a and the fourth identifier response 275b are matched or correlated by the electronic messaging module 155, then the tasks 231h and the instructions 231i associated with the fourth waypoint 215d are considered to be completed by the courier corresponding to the courier device 130b and verified by the electronic messaging module 155.

If the first, second, third and fourth identifiers 260a, 265a, 270a and 275a, are matched or otherwise correlated with corresponding first, second, third and fourth identifier responses 260b, 265b, 270b and 275b, respectively, by the electronic messaging module 155, then the payments module 156 may transmit a payment settlement request 280 to the payment processor 160a to settle payment for the total charge 307. Accordingly, the transaction is settled once all tasks in the orders are completed and the corresponding identifier responses have been verified by the management server 150.

If one of the identifier responses 260b, 265b, 270b or 275b that is provided to the corresponding courier device (e.g. 130a or 130b in this embodiment) cannot be correlated by the electronic messaging module 155, then the management server 150 may initiate a return process. The return process may include, for example, the electronic messaging module 155 determining the waypoint at which the incorrect identifier response was entered and appending a return task to that waypoint.

If the task at the waypoint where a return is determined originally indicated a pick-up, then the orders module 157 may remove the items (item 205a or item 206c in this example) from the order 157b. The payments module 156 may then update the total charge 307. The electronic messaging module 153 may then transmit an electronic message to the buyer device 105a indicating that the task at the corresponding waypoint was not completed.

If the task at the waypoint where a return is determined originally indicated a drop-off, then the orders module 157 may remove the items (item 205a or item 206c in this example) from the order 157b. The payments module 156 may then update the total charge 307. The electronic messaging module 153 may then transmit an electronic message to the buyer device 105a and the corresponding merchant device 125a or 125b, indicating that the task at the corresponding waypoint was not completed.

The electronic messaging module 155 may also transmit status update data 410a corresponding to the activity at the first and second waypoints 215a and 215b to the buyer device 105a and the merchant device 125a. In some embodiments, the electronic messaging module 155 may also transmit status update data 410b corresponding to the activity at the third and fourth waypoints 215c and 215d to the buyer device 105a and the merchant device 125b. In some embodiments, the status update data 410a and 410b may further include at least one of the corresponding first or second distances 240 or 241, the first or second routes 245 or 246, the first or second EDTs 250 or 251, a current first or second courier location indicator 409a and 409b (e.g. GPS coordinates) of the courier devices 130a and 130b, respectively, and whether any identifiers (260a, 265a, 270a, 275a) or identifier responses (260b, 265b, 270b, 275b) have been entered and verified by being matched or otherwise correlated with the corresponding identifiers. In some embodiments, the status update data 410a and 410b may be transmitted constantly to provide real-time traceability of the order 157b to the various parties using the system 100.

In some embodiments, if the merchants corresponding to the merchant devices 125a and 125b are located in a similar geographical zone, i.e. the first waypoint 215a and the third waypoint 215b are located in the same zone, then the courier corresponding to the courier device 130a may fulfill both deliveries. In this scenario, the first identifier response 260b, the second identifier response 265b, the third identifier response 270b, and the fourth identifier response 275b are all provided to the courier device 130a.

In some embodiments, it may be possible for the buyer using the buyer device 105a to share their identifier with another party. For example, it may be possible for a buyer to share their identifier with a family member, friend or co-worker in the event that they wish to allow this person to receive the delivery. In some cases, the buyer may not share the identifier over the system 100 but may choose to share their identifier by another means such as, but not limited to, a personal phone call, an email, an SMS message, or an MMS message, for example. In another example, if the tasks are actually two separate deliveries with one delivery going to the buyer (at work, for example) and the other delivery going to the family member (at home, for example) then two unique identifiers may be generated (one for each delivery) and then sent to the appropriate contact(s) provided.

In an alternative example embodiment, in the case that the merchant is a restaurant, using a variation of the ordering and delivery system 100 described herein, the merchant may receive an order from an end-user or buyer for food items along with requested preparation times and/or delivery times. If the merchant accepts the order and payment is authorized, the order of a food item may be entered into the merchant's internal order system which is given to the kitchen of the merchant for preparation of the ordered food items. When the preparation of the food is completed, the merchant may use their merchant device to indicate that the order is ready for utilization or consumption within the merchant's premises, ready for pick-up or ready for delivery depending on the instructions specified in the order.

It should be noted that the system 100 is not restricted to the delivery of only restaurant prepared food items. The system 100 may be used to deliver various other types of products or services or to perform various tasks. For example, other products and services include, but are not limited to, groceries, pharmacies, medical services, specialty goods, restaurants food, flowers, dry cleaning, clothing, auto parts, office supplies, kitchen supplies, business supplies, restaurant supplies, toiletries, hardware, tools, and documents, retail goods, other messenger or courier services, etc.

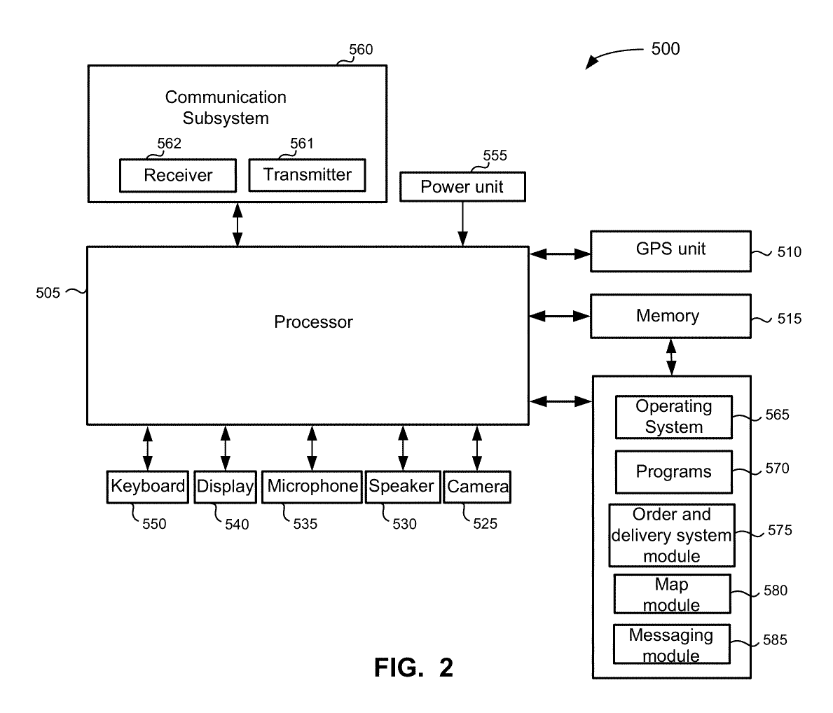

Reference is next made to FIG. 2, which illustrates an example embodiment of an electronic device 500 that may be used with the secure ordering, payment and delivery system 100 or a variant thereof. For example, the device 500 may be used to implement one or more of the buyer devices 105a-105n, the merchant devices 125a-125m, or the courier devices 130a-130p.

The device 500 generally includes a number of components. In this example embodiment, the device 500 comprises one or more processors 505, a GPS unit 510, memory 515, a camera 525, a speaker 530, a microphone 535, a display 540, a keyboard 550, a power unit 555 and a communication subsystem 560. It should be noted that in alternative embodiments, some of these components may not be used, other components (not shown) may be used and/or the components may be coupled to one another in ways that are different from what is shown in FIG. 2. Many components of the electronic device 500 may be implemented using a desktop computer, a laptop, a mobile device, a tablet, and the like depending on the user of the electronic device 500 depending on the particular use case scenario. For example, a courier typically requires that the electronic device 500 is a portable electronic device or an electronic device that is located within their vehicle.

The communication subsystem 560 generally comprises a radio having a transmitter 561, a receiver 562, one or more antennas (not shown) as well as associated components (not shown) to send and receive data, respectively, with the communication network 145. The associated components may include local oscillators, filters and at least one communication processor (not shown), such as a DSP. The receiver 562 may perform such common receiver functions as signal amplification, frequency down conversion, filtering, channel selection, and analog-to-digital (A/D) conversion to allow for digital communication functions such as demodulation and decoding to be performed in the communication processor (not shown). Transmission signals may also undergo modulation and encoding by the communication processor and are then provided to the transmitter 561 for digital-to-analog (D/A) conversion, frequency up conversion, filtering, amplification and transmission over the wireless network 145.

The wireless link between the electronic device 500 and the communication network 145 can contain one or more different communication channels that operate according to associated communication protocols such as, but not limited to, CDMA, UTMS, GSM, GPRS, EDGE or LTE according to standards such as, but not limited to, IEEE 802.11a or 802.11g, for example. New standards may be defined in the future, and it should be understood that the communication subsystem 560 may be configured to use these new standards that are developed in the future.

The memory 515 can include RAM and flash memory elements as well as other suitable storage elements. The memory 515 may store computer executable code for implementing an operating system 565 including a file system (not shown) and various programs or modules 570, including an ordering and delivery system module 575, a map module 580, and a messaging module 585. These modules reside in an area of physical memory and may be used to configure the device 500 to operate in a particular manner according to at least one of the processes described herein. There may also be one or more databases (not shown for ease of illustration). The operating system 565 and the file system provide various basic operational processes for the electronic device 500. The operating system and the various modules 575 to 585 allow the user of the device 500 to interact with the secure ordering, payment and delivery system 100 including sending and receive data regarding an order entry and the status of a live order.

The order, payment and delivery system module 575 is a software application that allows the user of the electronic device 500 to access the secure ordering, payment and delivery system 100. The functionality of the order, payment and delivery system module 575 can be configured depending on whether the user of the electronic device 500 is a buyer, a merchant or a courier since each of these users will be able to interact differently with the secure ordering, payment and delivery system 100.

For example, when the order, payment and delivery system module 575 is configured for use by a buyer, the order, payment and delivery system module 575 may provide various features such as, but not limited to, browsing retailer's web stores and products by vicinity, type, price, distance or ratings: creating orders; customizing delivery options; making payments; creating customized runs for non-web store deliveries (e.g. document courier, item pick-up); tracking the progress of an order; placing reviews and feedback on merchants, products and/or services; viewing ratings and feedback from other users; sharing information (such as through social media) and planning (e.g. scheduling) purchases and/or deliveries.

As another example, when the order, payment and delivery system module 575 is configured for use by a merchant, the order, payment and delivery system module 575 may provide various features such as, but not limited to, at least one of creating a web-store; add items to the web-store; uploading images, price and description for the items; marketing the web-store online (e.g. through social media); creating customized delivery runs; processing purchases for deliveries; receive purchase orders for delivery; and outsource certain delivery needs.

As another example, when the order, payment and delivery system module 575 is configured for use by a courier, the order, payment and delivery system module 575 may provide various features such as, but not limited to, at least one of creating a profile; scheduling shifts; navigation and routing; fulfilling tasks for orders; and earning income based on performance.

It should be noted that in some embodiments, the order, payment and delivery system module 575 may also provide features that are common regardless of whether the user is a buyer, a merchant or a courier. For example, the order, payment and delivery system module 575 may provide common features such as, but not limited to, at least one of creating customized delivery runs for both buyers and merchants as merchants may be viewed as being indirect buyers. For example, a merchant may create custom delivery runs for delivery to their location for their supplies. This particular process may be referred to as a “Sprint”.

The map module 580 may be used to allow the user of the electronic device 500 to display a map of the location of one of more of the buyer device, the merchant device and the courier device that are interacting with one another at various times during the creation or fulfillment of an order. For example, after a courier request has been accepted, the location of the courier device that has accepted the courier request may be tracked, mapped and displayed on the merchant device so that the merchant knows how much longer it will take for the courier to pick up the order. In at least some embodiments, the location of the courier device that has accepted the courier request may also be tracked, mapped and displayed on the buyer device so that buyer knows can track the fulfillment of the order (see FIG. 4I for an example).

The messaging module 585 may be used to allow the electronic device 500 to send various messages to various components of the ordering and delivery system 100. For example, the messaging module 585 may send messages from the electronic device 500 to at least one of the other devices (e.g. one of the buyer devices, merchant devices or courier devices) that are linked with the secure ordering, payment and delivery system 100. The messages may include requests, responses and other information. The messages may be based on certain response templates or requests that are specific to an account type.

The GPS unit 510 may be a receiver for the Global Positioning System (or an equivalent, such as GLONASS or Galileo), and is configured to provide navigation and geographical positioning data for the location of the device 500 to the map module 580. In some embodiments, the GPS unit 510 may also provide traffic information such as road closures and detour information. In some embodiments, the GPS unit 510 may also help determine travel time estimates depending on the method of transport and current traffic information. These time estimates may be determined based on information that is generated by an off the shelf GPS unit. The GPS unit 510 may be optional if the device 500 is used as a buyer device or as a merchant device.

The processor 505 controls the operation of the electronic device 500 and can be one or more suitable processors, controllers or digital signal processors that can provide sufficient processing power processor depending on the configuration, purposes and requirements of the electronic device 500 as is known by those skilled in the art. For example, the processor 505 may be a high performance general processor. In alternative embodiments, the processor 505 may include more than one processor with each processor being configured to perform different dedicated tasks. In alternative embodiments, specialized hardware can be used to provide some of the functions provided by the processor 505.

In use, the processor 505 executes the computer executable code stored in the memory 515 and generally interacts with one or more of the display 540, the keyboard 550, the speaker 530, and the microphone 535 to provide various functions related to the ordering and delivery systems described herein. For example, the functions may include, but are not limited to, entering an electronic message for delivery over the communication network 145, displaying the user's geographical position on the map module 522, providing route and navigation information such as current traffic and road closures, and the like.

The keyboard 550 may comprise, for example, physical buttons or a touchscreen keyboard for allowing a user to enter information on the electronic device 500. In some embodiments, there may also be other user input devices such as, but not limited to, at least one of a mouse, a keyboard, a thumbwheel, a track-pad, a track-ball, a card-reader, voice recognition software and the like again. In some cases, some of these components can be integrated with one another.

There may also be other components such as various interfaces (not shown) that may be used to allow the electronic device 500 to communicate with other devices or computers. In some cases, these interfaces can include, but are not limited to, at least one of a serial port, a parallel port or a USB port that provides USB connectivity, an Internet connection, a Local Area Network (LAN) connection, an Ethernet connection, a Firewire connection, and a modem or digital subscriber line connection, for example.

The display 540 can be any suitable display that provides visual information depending on the physical configuration of the electronic device 500 (e.g. desktop computer versus tablet or smart phone). For instance, the display 540 may be a cathode ray tube, a flat-screen monitor and the like if the electronic device 500 is a desktop computer. In other cases, the display 540 can be a display suitable for a laptop, tablet or handheld device such as a Liquid Crystal Display (LCD), an Organic Light Emitting Diode (OLED), and the like for displaying information. Examples of graphical user interfaces that may be shown to a user on the display 540 is shown in any of FIGS. 4A to 4I.

The camera 525 may be used to take pictures or to record video on the device 500. The speaker 530 may generate audio signals, for example, when the device 500 is used as a telephone handset. The microphone 535 may, for example, be used to capture audio signals when the device 500 is used as a telephone handset.

The power unit 555 can be any suitable power source or power component that provides power to the electronic device 500 such as a power adaptor or a rechargeable battery pack depending on the implementation electronic device 500 as is known by those skilled in the art. For example, in the base of a battery pack, the power unit 555 may comprise at least one lithium ion battery for providing power to the device 500.

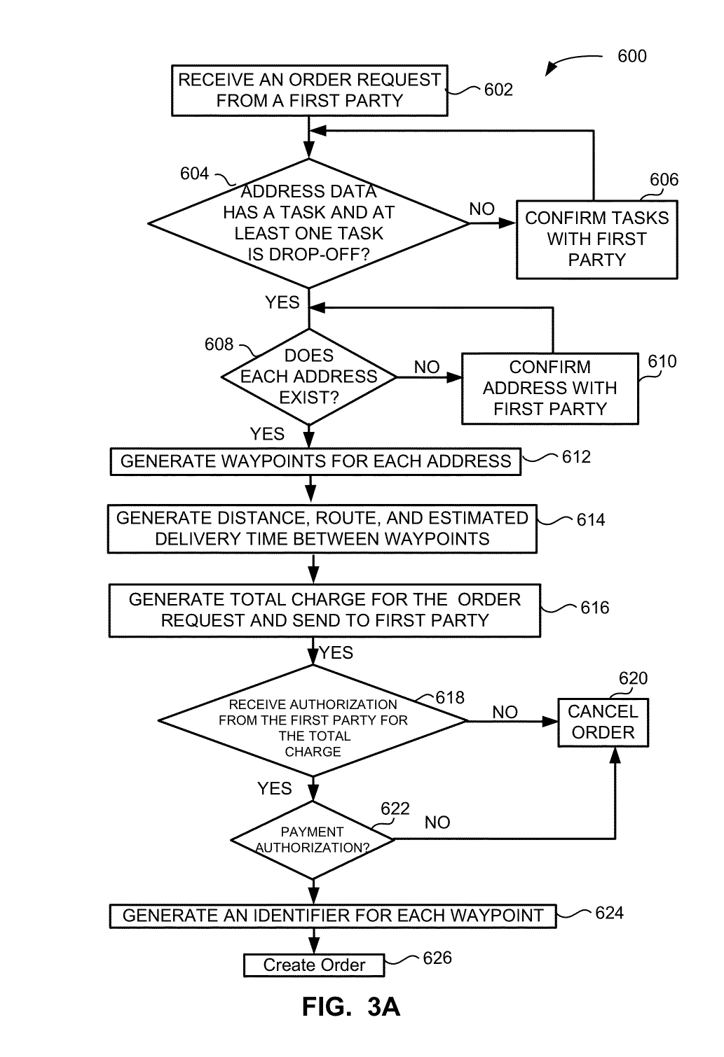

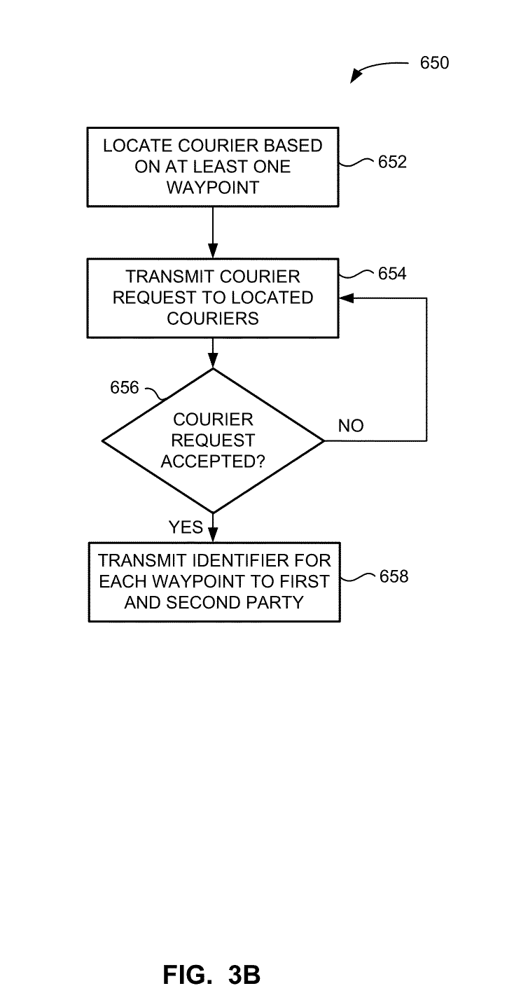

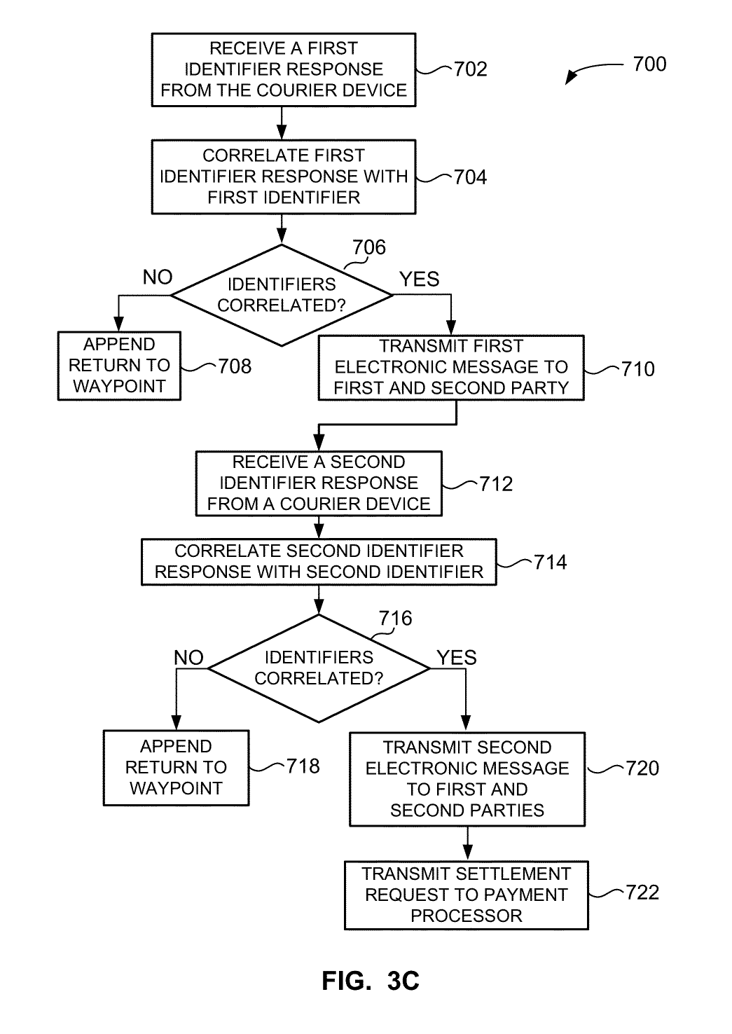

Referring now to FIG. 3A, illustrated therein is an example embodiment of a method 600 for generating an order at the management server 150 based on an order request sent by a first party. At 602, the management server 150 receives an order request from an electronic device associated with the first party. The order request comprises order attribute data including, but not limited to, at least one of item data for one or more items selected for purchase and/or delivery (for example purchase from a merchant catalogue), and/or the selection of a particular service, date and time data for pick-up and drop-off, address data for the pick-up and drop-off, task data (i.e. pick-up, drop-off, return, pay a party, etc.), and instruction data for particular aspects of the task data as previously described for the ordering and delivery system 100. At 604, the management server 150 verifies that each address has a corresponding task, and that at least one task comprises a drop-off or a payment. If each address does not have a task, or a drop-off task is not provided, the method 600 may confirm the task data with the first party at 606 which may include the first party having to enter any missing information and/or correct some incorrect information. If each address has a task and at least one task is a drop-off, then the management server 150 verifies that each address exists at 608. Address verification may comprise cross-referencing each address against a postal office database, for example. If an address cannot be verified by the management server 150, then the first party may be prompted to confirm the unverified address at 610.

At 612, the management server 150 generates a waypoint for each address. At 614, the management server 150 uses the waypoints and associated map information to determine the distance between the waypoints, to generate a route between the waypoints, and to generate an estimated delivery time (EDT) for the route. At 616, the management server 150 generates a total charge for the order request, which generally may comprise a charge for items ordered and a charge for delivery. There may also be other task-related charges for certain types of tasks such as, but not limited to, rush deliveries, for example, which would be referred to as task charges. The total charge is then sent to the electronic device of the first party.

At 618, the management server 150 determines whether an authorization has been received from the first party to continue with the order. If the first party has declined to provide the authorization for the total charge, then the method 600 proceeds to 620 where the order is cancelled. If the first party has sent an authorization for the total charge to the management server 150, then the method 600 proceeds to 622 at which point the management server 150 determines whether the payment processor that corresponds to the first party has provided a payment processor authorization to approve the transaction. If this is not true, then the method 600 proceeds to 620 at which point the order is cancelled. However, if the management server 150 does receive a payment processor authorization, then the method 600 proceeds to 624 at which point the management server 150 generates an identifier for each waypoint associated with the order and these identifiers are used to improve security and show that tasks and/or payment have been performed properly. The method 600 then proceeds to 626 at which point the order is created and is known as a “live” order that requires fulfillment.

Referring now to FIG. 3B, illustrated therein is an example embodiment of a method 650 for locating a courier and sending identifiers for each waypoint for a live order. At 652, the management server 150 locates couriers associated with courier devices in a zone corresponding to at least one of the waypoints. For example, in some embodiments, the courier devices may be located based on the location of a first waypoint, in other embodiments the courier devices may be located based on the location of a second waypoint, while in other embodiments the courier devices may be located based on a combination of the locations of the first and second waypoints. At 654, the management server 150 transmits a courier request to the located courier devices. The courier request may contain details related to the live order including, but not limited to, at least one of the waypoints, items and time to perform certain tasks, for example. At 656, if a courier associated with one of the located courier devices has accepted the courier request, then at 658 the management server 150 transmits the first identifier to a second party (e.g., a merchant to prepare the item(s) for the order) and transmits the second identifier to the first party (e.g. buyer for the order) or another party if a different recipient was specified to receive the items of the order.

Referring now to FIG. 3C, illustrated therein is an example embodiment of a method 700 for correlating a first identifier and a second identifier with a first identifier response and a second identifier response, respectively, to verify fulfillment of a live order in a secure fashion. In other words, method 700 may be used for the secure verification of pick-up and/or drop off for a live order thereby addressing the technical issue of ensuring that tasks and payment are completed in a secure fashion over disparate physical locations that does not allow for any of the parties to falsify the performance of certain tasks or payment due to the generation, transmission and checking of the confirmation data (e.g. identifiers).

At 702, the management server 150 receives a first identifier response, typically at pick-up, from the selected courier device that will fulfill the order, which is entered, or otherwise provided (e.g. via NFC or wirelessly), by the second party (e.g. the merchant) at the first waypoint. At 704, the management server 150 attempts to match or otherwise correlate the first identifier with the first identifier response. At 706, if the first identifier and the first identifier response cannot be matched or correlated, then the first waypoint is appended with a return task at 708 or other error notification.

Alternatively, a creator of the order may specify that the courier try to attempt the task again at a later time in the event of a non-match or a non-correlation. In this case, the electronic message module 155 may be configured to indicate that a delivery attempt was made but failed and to notify all parties to the order. The second attempt may be the final attempt and if that fails as well then the products may be returned to the pick-up location.

If the first identifier and first identifier response are matched or otherwise correlated, then at 710, the management server 150 may transmit a first electronic message to the first and second parties notifying them that the first waypoint task and instructions and possibly payment (if any) have been completed.

At 712, the management server 150 receives a second identifier response from the selected courier device, which may be entered, or otherwise provided (i.e. via NFC or wirelessly), by the first party (e.g. the buyer) when the courier device is at the second waypoint. At 714, the management server 150 matches or otherwise correlates the second identifier with the second identifier response. At 716, if the second identifier and the second identifier response cannot be matched or otherwise correlated, then the second waypoint may be appended with a return task or an error notification at 718. If the second identifier and second identifier response are matched or otherwise correlated, then at 720, the management server 150 may transmit a second electronic message to the first and second parties notifying them that the second waypoint task and instructions (if any) have been completed. For example, the message may be a status update (e.g. a notification) to the merchant to mark the order as being completed. In some cases, the message may alternatively or additionally include a summary or a receipt of the transaction or the custom delivery run.

At 722, if both the first and second identifiers are matched, or otherwise correlated, with the first and second identifier responses, then the management server 150 has securely verified that the delivery has successfully occurred, and transmits a payment settlement request to the payment processor associated with the first party's account. The payment processor then settles the financial transaction and sends a message indicating financial transaction settlement to the management server.

Referring now to FIGS. 4A to 4G, shown therein is a series of graphical user interfaces (GUIs) that a user may use to create an order request. In this example, the user has already selected the items for purchase and is providing further information for the order including task instructions (e.g. pick-up and drop-off location details).

Referring now to FIG. 4A, shown therein is a GUI 800A that allows a user to provide various inputs to specify pick up details for a waypoint. For example, GUI 800A includes header 802 that indicates that pick-up details may be entered by the user as well as parameter 804 that specifies when the pick-up should occur by allowing a user to enter date and time data via a date and time dialog or text box 806. A parameter 808 specifies what particular vehicle the user has selected for fulfilling the order via a vehicle menu 810 that may also show the price for each vehicle. This information is similar to the attributes data 210a comprising the pick-up date time data 230a and the vehicle type data 230b (see FIG. 1B for example). The pickup information may also include data for the weight of the item being picked up, in some embodiments. Accordingly, a parameter 812 specifies the user's weight estimate for the items in the order via a weight menu 814 that may also show the price for each range of weights.

GUI 800A also allows the user to select from different payment options as well as specify the payment value for a given task. In this example, there are three payment options: make a payment option 818a, collect cash payment option 818b and no payment option 818c. If the user selects payment options 818a or 818b, then an amount dialog box (not shown in the figure) may be displayed once the option is selected thereby allowing the user to specify how much the payment should be (if option 818a is selected) or how much money to collect (if option 818b is selected).

GUI 800A may also include various verification options including, but not limited to, at least one of a PIN Verification, a Picture Verification and a Tamper Proof seal Verification, for example. The verification options may be used so that at least one check may be made when a courier interacts with a contact at this particular waypoint to ensure that the tasks are performed correctly.

For example, GUI 800A may include a PIN Verification option 820 that the user may select to indicate that PIN verification (e.g. identifier verification) is not being used at this particular waypoint by selecting the associated button in this example. PIN verification refers to the process of the management server 100 generating identifiers that may be sent to the end user device and the merchant device for a given order. The courier device receives the identifiers and sends them to the management server 150 to securely verify the correct pickup at least one of the merchant and the correct delivery to the end user.

As another example, GUI 800A may include a Take a Picture Verification option 822 that the order creator may select if they wish that the courier takes a picture of the item(s) being picked up at this particular location. This may be used for quality control purposes when dealing with sensitive items such as food and the picture may be used to verify that the item was in a proper condition when it was picked up.

As another example, GUI 800A may include a Tamper-Proof Seal Verification option 824 that may be used to let the user know that the item was not tampered with during delivery if, for example, the seal was not broken from the time of pick up to the drop off to the end user.

In some embodiments, GUI 800A may include all three of the PIN, Picture and Seal verifications 820, 822 and 824, some combination thereof, and/or possibly other types of verifications.

The GUI 800A also includes navigation buttons that the user can use to navigate through the process. For example, there may be a pickup info button 826, an options button 828 and a description button 830. GUI 800A may also include a pickup info button 832, a DONE button 834, a Description button 836 and a cancel button 838. The pickup info button 832 and the description button 836 perform a similar function as the pickup info button 826 and the description button 830, respectively, but one of these sets of buttons may be used for quick entry shortcuts to be applied, and the other sets of these buttons may be used to indicate order creation progress. Buttons 832 and 836 act as navigation buttons between sequenced steps in the order creation process.

The pickup info button 826 may be used to access another GUI where the user may enter information about the contact at the pickup location, an example of which is shown in FIG. 4B. The options button 828 may be used by the user to select tasks that are to be implemented at the waypoint. For example, these tasks may be the tasks specified at 820, 822, and 824 in FIG. 4A or the user may be taken back to FIG. 4A to enter this information. The description button 830 may be used to access another GUI that allows a user to enter particular instructions for one or more tasks to be completed at this pick-up location, an example of which is shown in FIG. 4C. The DONE button 834 may be selected when the user is finished entering all of the pickup information for this pickup location waypoint. The cancel button 838 may be used to cancel this particular pick-up location waypoint.

Referring now to FIG. 4B, shown therein is a GUI 800B that allows a user to specify address information similar to the attributes data 210a for the first waypoint which is a pick-up. The address information includes the first address data 230c and the first address name 230d (see FIG. 1B, for example). In this case, the GUI 800B includes a “populate my details” option 840 that the user may use to select a pre-specified or pre-stored location. When the user selects a pre-specified location, the rest of the text boxes in the GUI 800B may automatically be populated with location information that has been stored for the user. Otherwise, the user can enter data in the text boxes 844 to 862. If the user enters incorrect information, the user may select the clear fields option 842 to remove all of the entries from all of the text boxes 844 to 862.

If the user does not select the populate my details option 840 then during use, for example, text box 844 receives contact name data from the user for a contact at the pick-up location, text box 846 receives email address data from the user for the contact, text box 848 receives a phone number from the user for the contact, while text boxes 852 to 862 receive a street address, an apartment or suite number, an additional code field (if required such as a buzzer code for a condo or apartment type address) and a postal code, respectively. In other embodiments, only some of the text boxes 844 to 862 may be used or different combinations of these text boxes may be used since in both of these alternatives other information may be stored in the system 100. Upon entry of the address information, a map 864 may be displayed showing the address location. The map 864 may be generated by the mapping module 152. A notification option 850 may also be included to allow the creator to select how at least one waypoint contact (e.g. the recipient and/or the creator) would prefer to communicate or receive the order information to the recipient. An example of a similar GUI is shown for Drop-off Details in FIG. 4E. The GUI 800B has another navigation option, options button 866, that the user may select to go back the options menu screen. The user may select to go back to GUI 800A by selecting the DONE button 834 or may cancel this particular waypoint by selecting the cancel button 838.

Referring now to FIG. 4C, shown therein is a GUI 800C that allows the user to specify tasks instructions in instructions dialog box 868. These instructions correspond to the first address instructions data 230f and may specify tasks that are to be done at the first waypoint by the courier.

Referring now to FIG. 4D, shown therein is a GUI 870A that allows a user to provide various inputs to specify drop-off details for a waypoint. For example, GUI 870A includes header 870 that indicates that drop-off details may be entered by the user. GUI 870A also allows the user to select from different payment options as well as specify the payment value for a given task. In this example, there are three payment options: make a payment option 873a, collect cash payment option 873b and no payment option 873c. If the user selects payment options 873a or 873b, then an amount dialog box (not shown in the figure) may be displayed thereby allowing the user to specify how much the payment should be paid (if option 873a is selected) or how much money to collect (if option 873b is selected). In this example, if the user is simply instructing the courier to make a drop-off at this waypoint of what was picked up at the previous waypoint, then the no payment option 873c may be selected.

GUI 870A may also include various verification options including, but not limited to, at least one of a PIN Verification 880, a Picture Verification 882 and a Tamper Proof seal Verification 884, for example. The verification options 880, 882 and/or 884 may be used so that at least one check may be made when a courier interacts with a contact at this particular waypoint to ensure that the tasks are performed correctly.

For example, GUI 870A may include the PIN Verification option 880 to allow the user to indicate that PIN verification is not being used at this particular waypoint by selecting the associated button in this example. PIN verification refers to the process of the management server 100 generating identifiers that may be sent to the end user device and the merchant device for a given order. The courier device accesses the identifiers and sends them to the management server 150 to verify the correct drop-off at this waypoint.

As another example, GUI 870A may include the Take a Picture Verification option 882 that the creator of the order request may select if the creator wishes that the courier takes a picture of the item(s) being dropped off at this particular location. This may be used for quality control purposes when dealing with sensitive items such as food and the picture may be used to verify that the item was in a proper condition when it was dropped off. Another use of the picture verification option may be to take pictures of receipts and or signatures on receipts as a copy to retain for the creator's records; these pictures may be sent to the creator via EMT.

As another example, GUI 870A may include the Tamper-Proof Seal Verification option 884 that may be used to let the user know that the item was not tampered with during delivery if, for example, the seal was not broken from the time of pick up to the drop off to the end user.

In some embodiments, GUI 870A may include all three of the PIN, Picture and Seal verifications, some combination thereof, and/or possibly other types of verifications.

The GUI 870A also includes navigation buttons that the user may use to navigate through the process. For example, there may be a drop-off info button 876, an options button 874 and a description button 878. GUI 870A may also include a drop-off info button 886, a DONE button 834, a Description button 888 and the cancel button 838.

The drop-off info button 876 may be used to access another GUI where the user may enter information about the contact at the drop-off location, an example of which is shown in FIG. 4E. The options button 876 may be used as an indicator of what step the creator is currently on by highlighting it in a certain color, such as green, as is shown in FIG. 4D. The description button 878 may be used to access another GUI that allows a user to enter particular instructions for one or more tasks to be completed at this pick-up location, an example of which is shown in FIG. 4F. The DONE button 834 may be selected when the user is finished entering all of the pickup information for this pickup location waypoint. The cancel button 838 may be used to cancel this particular drop-off location waypoint.

Referring now to FIG. 4E, shown therein is a GUI 870B that allows a user to specify address information similar to the attributes data 210a for the second waypoint which is a drop-off location in this example. The address information includes the second address data 230g and the second address name data 230j (see FIG. 1B, for example). In this case, the GUI 870B is similar to the GUI 800B. The GUI 870B includes a “populate my details” menu item 891 that the user may use to select a pre-specified or pre-stored location. When the user selects a pre-specified location, the rest of the text boxes in the GUI 870B may automatically be populated. Otherwise, the user can enter data in the text boxes 894 to 908. If the user enters incorrect information, the user may select the clear fields option 892 to remove all of the entries from all of the text boxes 894 to 908.

If the user does not select the populate my details option then during use, for example, the text box 894 receives contact name data from the user for a contact at the drop-off location, text box 896 receives email address data from the user for this contact, text box 898 receives a phone number from the user for this contact, while text boxes 902 to 908 receive a street address, an apartment or suite number, an additional code field if required (such as a buzzer code, for example) and a postal code, respectively. In other embodiments, only some of the text boxes 902 to 908 may be used or different combinations of these text boxes may be used since in both of these alternative other information may be stored in the system 100. A notification option 900 may also be included which allows the creator to select how they'd like to communicate the order information to the recipient. Upon entry of the address information, a map 910 is displayed showing the address location. The GUI 870B may have another navigation option, options button 912, that the creator may select to go back to the options page. The user may select to go to back to GUI 800A by selecting the DONE button 834 or may cancel this particular waypoint by selecting the cancel button 838.

Referring now to FIG. 4F, shown therein is a GUI 870C that allows the user to specify tasks instructions in instructions dialog box 910 for the drop-off at this second waypoint. These instructions correspond to the second address instructions data 230i and may specify tasks that are to be done at the first waypoint by the courier.

Referring now to FIG. 4G, shown therein is a GUI 870D that shows a summary of the information that has been specified by the user for the first waypoint at which a pick-up will occur and a second waypoint at which a drop-off will occur. In this example, the contact and data information 922 to 928 for the first waypoint is summarized. The verification information is summarized to show whether PIN code verification will be used 930. Picture verification will be used 932 and/or Seal tampering verification will be used 934. There is also a tool bar with various options to allow the user to still edit some details 942 for the first waypoint, cancel 944 the first waypoint, add another pick-up waypoint 966, or add another drop-off waypoint 968. Also shown are the contact and data information 948 to 952 and drop-off verification information 956 to 960 for that particular waypoint. The contact and data information correspond to the data entered at the GUI 870B. In some embodiments, there may also be proxy cash collection information or proxy cash purchase information that is associated with a waypoint and may also be shown in a GUI. For example, the payment information 918 may correspond to the data that was entered at the GUI 870C.

The GUI 870C may also show a map 936 and a summary of the delivery information 938 that correspond to one of the waypoints. There may also be delivery information that corresponds to the distance associated with this waypoint and any task related charges in the order thus far.

The user can review the order summary information for the whole waypoint displayed by the GUI 870D and take various actions. For instance, the user may decide to edit some of the information for the second waypoint in which case the user selects the edit button 962. The user may decide to enter another waypoint to the order such as a drop-off by selecting the add drop-off button 968. The user may also change their mind and no longer wish to have the second waypoint in the order and thus select the delete button 964. Alternatively, if the user is satisfied that all of the proper information has been entered for the waypoints in this order and wishes the order to be executed, then the user may select button 970 which will take the user to another GUI where the user may specify payment information such as credit card information for example and complete the order request. When the user selects the button 970 and completes the order request, then at least some of the information shown in the GUI 870D may be transmitted to courier devices so that the couriers can review information about the order and decide if they want to perform the tasks at the waypoints for this order. While two checkout buttons 940 and 970 are shown, it should be understood that the button which is actually used depends on the mobile device platform that is being used as different screen sizes will display one button or the other (this may also apply to some other buttons shown in the figures which may appear to be duplications of one another).

Referring now to FIG. 4H, shown therein is an example of how visual confirmation may be used to verify waypoints and a route that are generated for order fulfillment for an example order. In this example, a GUI 870E provides a summary of an order in which there are 4 waypoints including a pick-up waypoint 920, and three drop-off waypoints 946, 972 and 974. The information in the summaries is similar to what was shown in FIG. 4G. Waypoints 920, 946, 972 and 974 also include tool bars that provide options such as editing the information for the corresponding waypoint or deleting the corresponding waypoint. A delivery charge summary 938′ is also shown taking into account all of the waypoints of the order. There is also a map 936′ that provides visual information for each of the waypoints (in this case, only the visual information for drop-offs 946, 972 and 974 are shown). If the user wishes to add another waypoint, then in this example the user can select the add pick-up button 966 or the add drop-off button 968 to add another pick-up waypoint or drop-off waypoint, respectively. If the user is satisfied with the order, then the user may select the “Go To Checkout” button 940 or the Checkout button 970.

It should be noted that the pick-up and drop-off waypoints for an order may be specified by the user to be in a particular order that corresponds to the order in which the user entered the waypoints in the order. However, in some embodiments, the user may be allowed to change the order of certain waypoints that have been entered. Alternatively, or in addition thereto, in some embodiments, the user may be able to insert a waypoint in between two existing waypoints.

It should be noted that in at least some embodiments, the GUI 870D or the GUI 870E may also be used if a merchant is creating a custom run, which is used by a merchant to locate a courier to deliver an order that has been made by a customer when the customer has not initiated the order using the system 100. In these cases, the merchant can add pick-up and drop-off waypoints as needed. In this case, the merchant may be charged for the delivery. In some cases, the merchant may be able to pass the delivery cost onto the customer.

Referring now to FIG. 4I, shown therein is an example of an order status display 980 that may be updated in real time using appropriate time stamps and text descriptions. In this example embodiment, the order status display 980 includes a live order map 980a that shows the current location of the user device 982, the merchant device 984 and the courier device 986. The live order map 980a may be updated from time to time to show the location of the courier device 986. The order status display 980 also comprises a fee log 987 and an order status log 988 which shows the actions that have occurred for this particular order and the time at which these actions occurred such as, but not limited to, at least one of an order being created, a merchant accepting the order, a courier request being sent out and a courier request being accepted, among other actions.

In at least some embodiments, the order status display 980 may be shown to both a merchant and a user who are parties to an order. In alternative embodiments, if the merchant is the creator of the order, the merchant may be able to decide if the user is able to view the order status display 980.

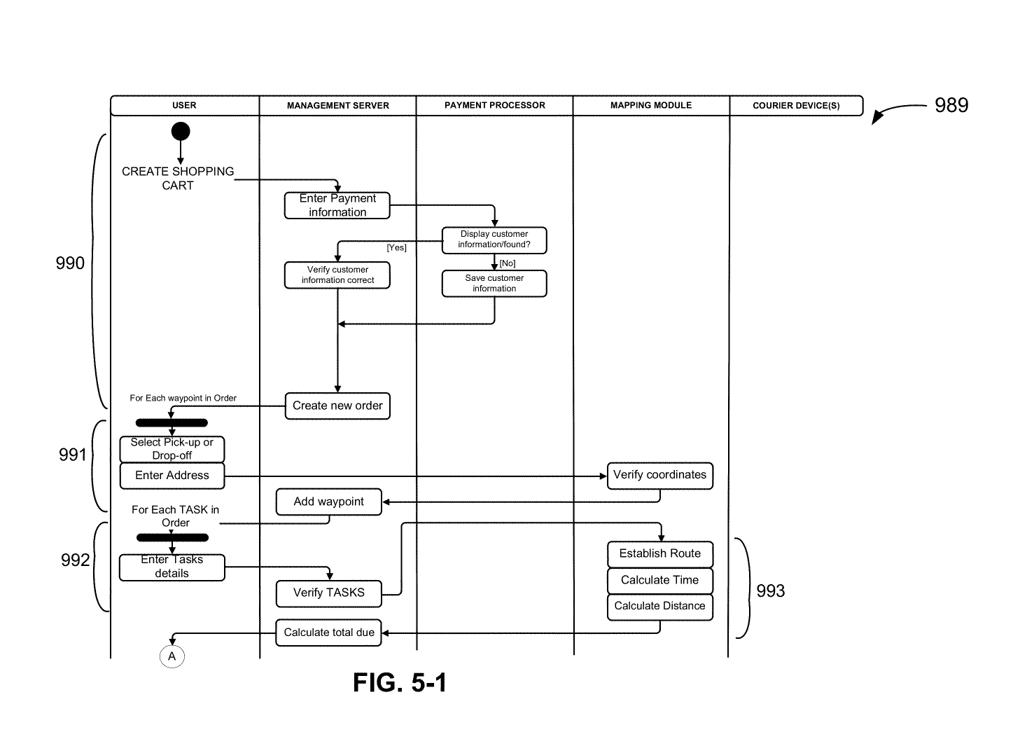

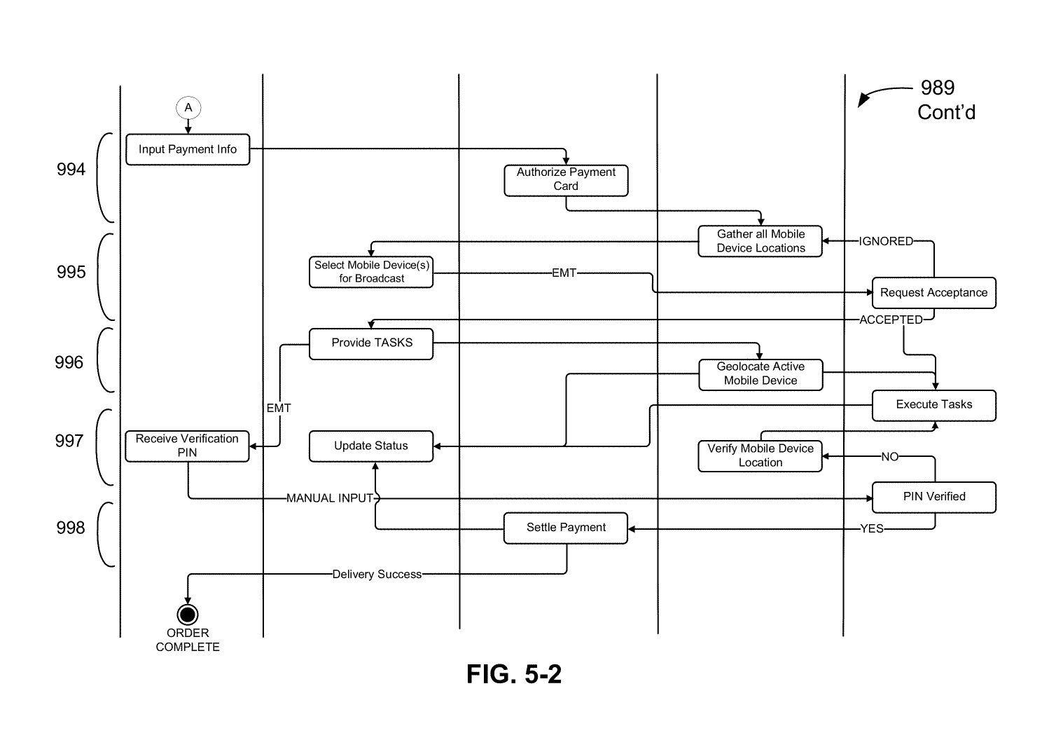

Referring now to FIGS. 5-1 and 5-2, shown therein is a flowchart diagram of an example embodiment of a remote point of sale and delivery settlement method 989 showing an example of the sequence of events that occur and the devices that are involved. In this example, there is a user using a user device, a management server of a secure ordering, payment and delivery system, a payment processor, a mapping module and one or more courier mobile devices, which may be similar to the corresponding elements described in relation to FIGS. 1A-2 herein.

At 990, the user creates a shopping cart at the user device. The shopping cart includes a number of goods and/or services that the user wishes to purchase from at least one merchant (there can be purchases from several different merchants in other orders). Alternatively, or in addition thereto, the shopping cart may include one or more tasks that the user wishes for a courier to perform, such as pick up dry-cleaning, etc. The management server receives the shopping cart and determines charges and method of payment before any edits are made to the cart. The management server then sends a request for payment information data from the user which the user provides. The management server then sends the payment information data to the payment processor. The payment processor then determines whether it has payment information data on a data store for this user and if so whether the stored payment information data matches the payment information data received from the management server. If this is true, then the payment processor indicates this condition to the management server and the management server verifies that the user information is correct, such as their address and contact information, for example. The payment processor may also run a pre-authorization check on the credit card at this time. If there is no payment information on record for this user, then the payment processor may create a new record for this user and store the payment information. When the customer information for the user has been verified, then the method 989 begins to create a new order.

During order creation, the method 989 proceeds to 991 at which point the user enters information for a waypoint for the order. For a given waypoint, the user selects whether the waypoint will correspond to a pick-up location or a drop-off location. The user may then enter address data for that particular waypoint. The address data is sent by the user device to the management system which may use the mapping module to verify that the address information is correct. If this address information is correct, then the management server may add this waypoint to the order. If the address information is not correct, then the user may be prompted to revise the address information.

The method 989 then moves to 991 at which point the user enters task information data for the newly added waypoint. The task data information is then verified by the management server. For example, the tasks are verified to make sure they are eligible for the type of order being created. This verification may be done by using certain parameters whose values are set by the system administrator. These parameters may include, but are not limited to, limitations on tasks such as no payment can be made unless a payment amount is inputted by the creator of the order. Other parameters may also be used.

It should be noted that the actions at 991 and 992 are performed for each waypoint that is part of the order. Accordingly, if there are multiple waypoints, then the actions at 991 and 992 are repeated a corresponding number of multiple times.

When the tasks have been verified for each waypoint, the method 989 proceeds to 993 at which point the mapping module establishes a route for the courier device based on the locations of the waypoints. A distance is calculated for the route and a delivery or completion time is estimated for the route; this may be done in real-time taking various factors into account such as, but not limited to, the traffic information, for example.

The process 989 then moves to 994 at which point payment for the order is pre-authorized. If additional waypoints were created and the cart was revised then the amount is verified by the user before checkout, the payment information can be edited at this stage. This may involve the management server determining the total cost of the order which is then sent to the user device, if the user of the user device wishes to proceed with the order, then the user enters payment information into the user device which is sent to the management server which then sends this total cost information and user authorization to the payment processor. The payment processor then pre-authorizes the payment of the order assuming that the user can accommodate the financial transaction on their account, which may be a debit account or a credit card account, for example.

It should be noted that this act takes into account the situation that an addition was made to the order such as a new waypoint and the option of switching the method of payment is made available which allows the user to run through the payment process acts once more.

However, for embodiments that do not consist of multiple pick-ups or multiple drop offs, then multiple iterations of acts 991 and 992 may be avoided. For example, a user placing an order with a merchant for delivery may not require any further tasks or waypoints since the template provided will calculate all the costs associated with the tasks in 990.

Once the payment has been pre-authorized, the method 989 moves to 995 at which point a courier is located to carry out the order. This may involve using the mapping module to gather all courier device locations which the management server then uses to determine which courier devices will receive the order broadcast.

Once a courier has accepted the order via their courier device, the method 989 moves to 996 at which point task information data is sent to the courier device along with each waypoint for the order. For example, all waypoints may be shown but the current waypoint may be highlighted and the immediate task to be performed may be shown. Tracking of the location of the courier device may begin at this point so that the management server can monitor the completion of the tasks for the order. The tracking or traceability information may be provided to the buyer device but in some embodiments it may be possible for the merchant device to have access to the tracking information.

One a courier has accepted the order via their courier device, unique identifiers are sent to the contacts at the waypoints an example of which is shown by the verification PIN being sent to the user device at 997. At this point, the courier also begins to go to the waypoint and, as mentioned before, the location of the courier device may be tracked as tasks are completed so that status updates may be provided to the user and any other parties that are part of the order (such as the merchant who provides an ordered good or service and a recipient who may be different from the user).

Still at 997, when the courier has performed the tasks for a waypoint. An identifier response based on the unique identifier for that particular waypoint is provided to the courier device. The identifier response may be the actual unique identifier that was sent by the management server or the output of a cryptographic algorithm that operates on the unique identifier, for example. The identifier response may be provided manually or wirelessly, for example. At this point the location of the courier device is verified to ensure that it is at the proper waypoint. At this point other actions may be performed such as, but not limited to, the recipient taking a photo for confirmation of the task being completed, for example.

When the task is completed, verification of the task being completed may be sent to the payment processor which then finalizes the financial transaction at 998. If there are multiple waypoints then act 997 and potentially act 998 may be performed for each waypoint.

Once all of the payments are settled, the tasks are deemed to be successful. At this point the order is complete. In some embodiments, the management server may collect information throughout acts 995 to 997 so that various performance statistics can be maintained for the couriers that perform the tasks of the order, such as how many tasks are successfully completed by the courier, how many of the tasks are completed on time, etc. The management server may also use these order delivery statistics to settle any disputes that the user may have such as when the user complains that certain items or services were never performed or performed late or performed in a manner that does or does not comply with the task information.

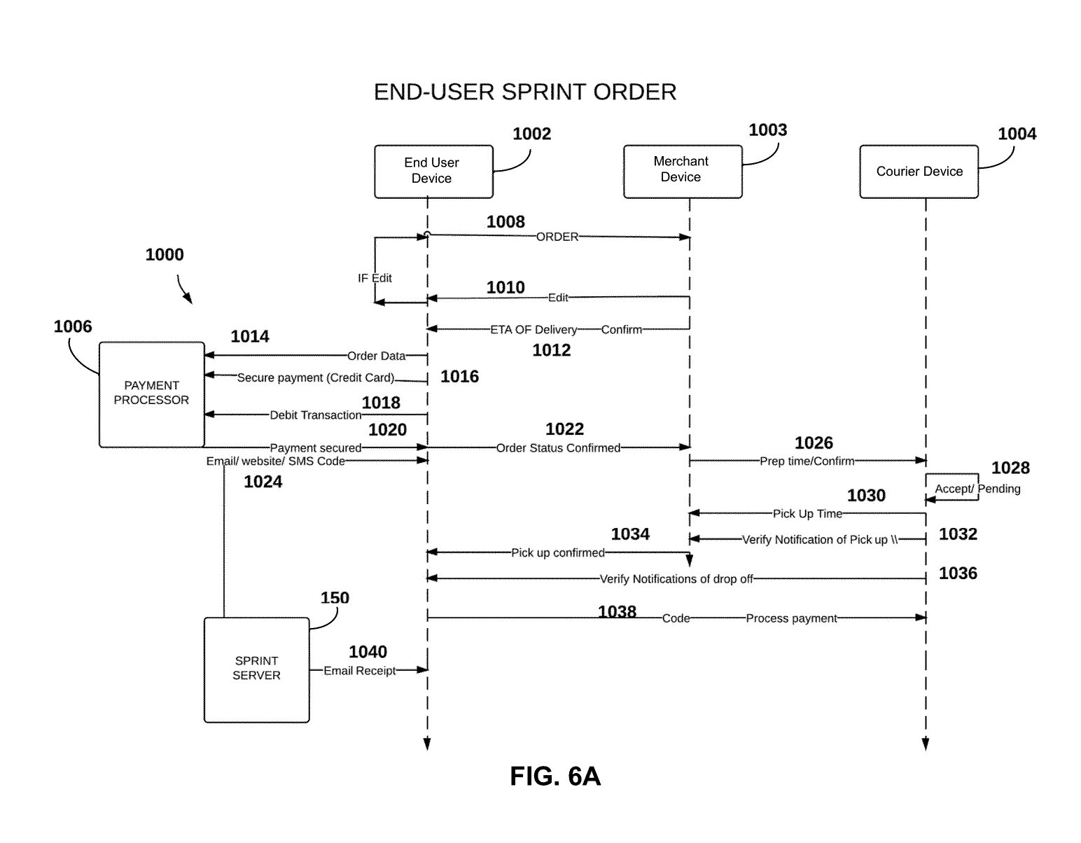

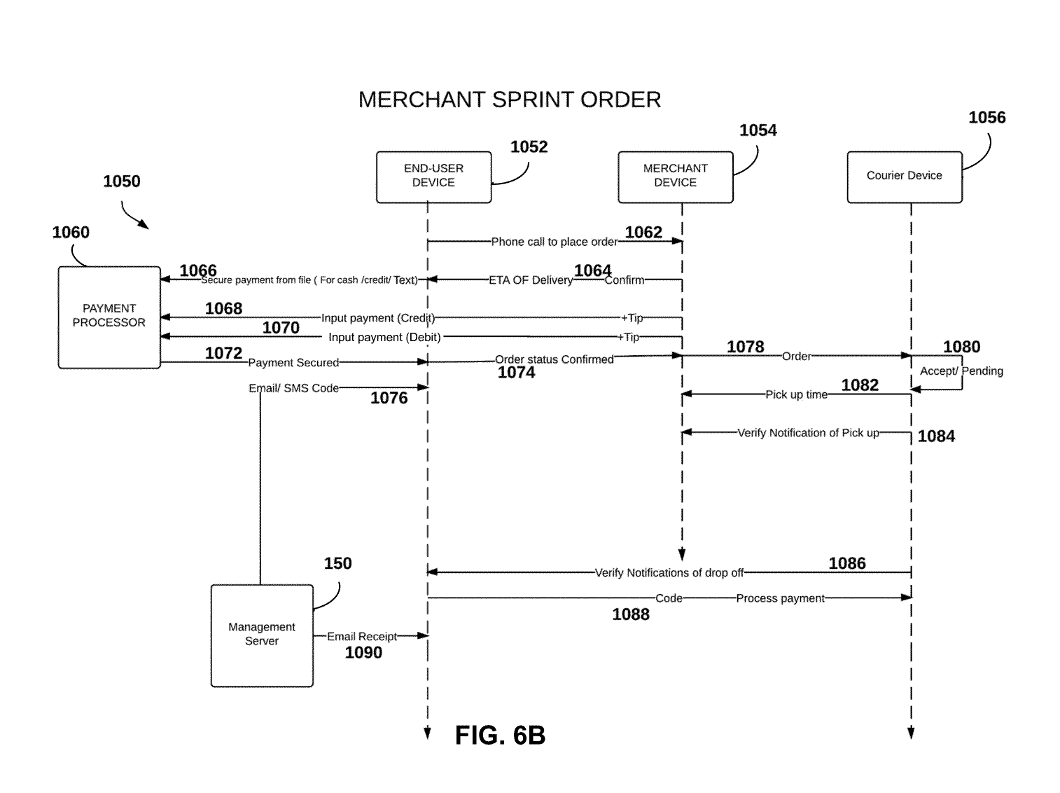

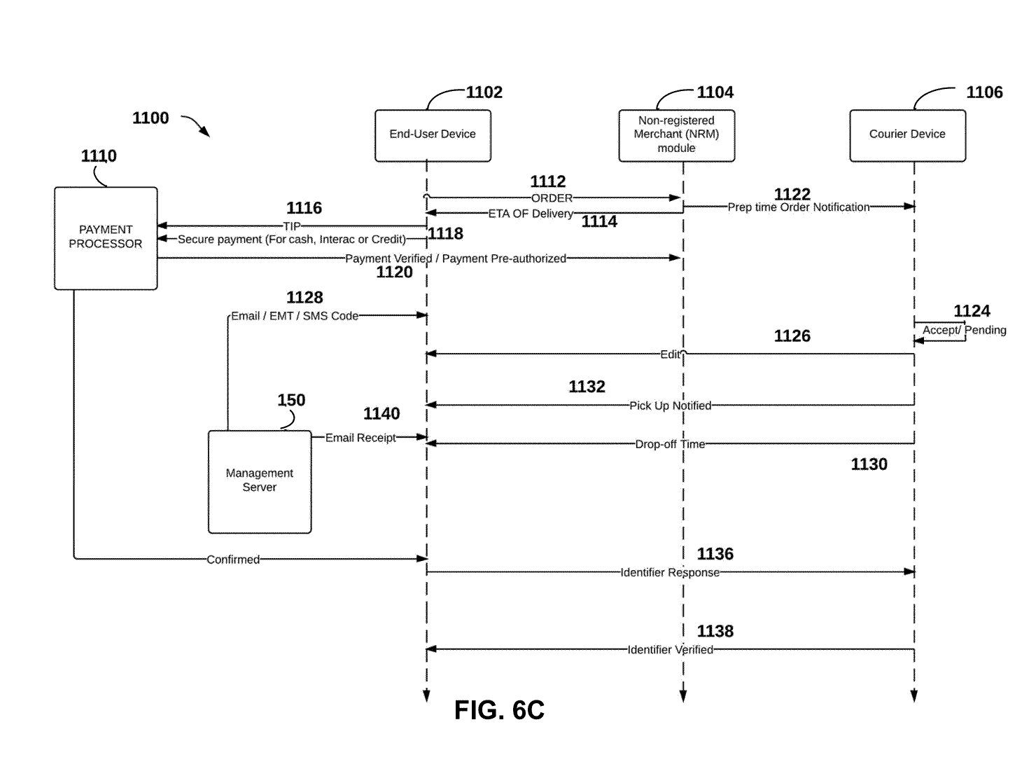

Referring now to FIGS. 6A-6C, shown therein are examples of several different use cases for the ordering and delivery system 100. In FIG. 6A, there is an example of a use case 1000 that involves an end user or customer creating an order. In FIG. 6B, there is an example of a use case 1050 that involves a merchant creating an order. In FIG. 6C, there is an example of a use case 1100 that involves an order made for a non-registered merchant (e.g. a merchant that has not been previously registered with the system 100). The information for a non-registered merchant may be sent to the management server for verification and then to the courier devices.

Referring now to FIG. 6A, the example use case 1000 shows an example interaction between a user device 1002, a merchant device 1003, a courier device 1004, the management server 150 and a payment processor 1006. This is an example of a user using the secure ordering, payment and delivery system 100 to order goods and/or services from a merchant and having the order delivered to a recipient. The recipient may or may not be the user but in both cases the delivery is made to a user-defined delivery location. Alternatively, the recipient can be someone else and the delivery location corresponds to this other person.

At 1008, a user sends an order request to a merchant which involves the user device 1002 sending various order attribute data to the merchant device 1003. The merchant may have to edit one or more aspects of the order at 1010 and the edited order data is sent from the merchant device 1003 to the user device 1002. At this point, the user can further edit the order and the edited order data is sent back to the merchant device 1003. Once the merchant agrees to facilitate the order, then an order accept confirmation is sent at 1012 from the merchant device 1003 to the user device 1002 which generally includes the order cost and an Expected Time of Arrival (ETA) for the delivery. At this point, the management server 150 may determine (not shown) distance, route, delivery cost information and total cost information which is part of the total cost that is sent to the user device 1002.

It should be noted that when the user creates a merchant order they may also create multiple pick-ups including different merchants. However each merchant device will only receive their order at 1008 and interact with the user at acts 1010 to 1012.

At 1014, the order is approved by the user. Cost information about the order and also user information for the user who is using the user device 1002 is then sent to the payment processor 1006. The order data may specify that the user wishes to pay for the order using a credit card 1016 or using a debit card 1018 or maybe even using cash (not shown). The payment processor 1006 then pre-authorizes the payment by issuing a payment processor approval at 1020 if the user has sufficient funds.

At 1022, the payment processor approval is sent to the user device 1002 and the merchant device 1003 to confirm the order. At this point, the order becomes a live order and the merchant determines a preparation time to prepare goods and/or services associated with the order. Also, unique identifiers are generated and sent at 1024 to each waypoint which in this case is the recipient device (in this case the user device 1002) that will be at the drop-off waypoint, the merchant device 1003 which will be at the pick-up waypoint, and the courier device 1004 that will facilitate the order.

At 1026, the preparation time along with other information about the order including distance, time of order completion and one or more waypoint locations are sent to courier devices until one of the couriers accepts the order at 1028. At 1030, a pick-up time is determined based on the distance between the courier device 1004 that agreed to deliver the order and the merchant's location. At 1032, the courier device 1004 arrives at the merchant location, receives the merchant's identifier response and then sends the identifier response to the management server 150 for verification. Upon successful verification, a confirmation of pickup is sent at 1034 to the user device.

At 1036, the courier device 1004 arrives at the recipient location, which in this example is the user's location, receives the recipient's identifier response and then sends the identifier response to the management server 150 for verification. Upon successful verification, a confirmation of drop-off is sent to all parties. The management server 150 sends an electronic message to the payment processor 1006 which then completes the financial transaction at 1038. An email receipt of the transaction may then be generated by the management server 150 at 1040 and sent to one or all of the parties that were involved in the creation and fulfillment of the order.

Referring now to FIG. 6B, the example use case 1050 shows an example interaction between a user device 1052, a merchant device 1054, a courier device 1056, the management server 150 and a payment processor 1060. This is an example of a merchant using the secure ordering, payment and delivery system 100 to create an order for delivery and to secure payment of goods and/or services prior to delivery of the goods and/or services. The merchant may create multiple waypoints for pick-up or drop-off each comprising of merchant defined tasks specific to each waypoint. The merchant may add items from the merchant catalogue as tasks, e.g. goods to be picked up from the merchant site or another site such as, but not limited to, a warehouse and then delivered. The user is notified of the details once the order has been created by the merchant.

At 1062, a user places an order request with a merchant which involves the user device 1052 sending various order data to the merchant device 1062. The user may use the user device 1052 to send order request data to the merchant device 1062. Alternatively, the user may place the order with the merchant through a phone call or in person. Once the merchant agrees to facilitate the order, then an order accept confirmation is sent at 1064 from the merchant device 1054 to the user device 1052 which generally includes the order cost and an Expected Time of Arrival (ETA) for the delivery. At this point, the management server 150 may determine (not shown) distance, route, delivery cost information and total cost information which is part of the order cost sent to the user device 1002.

At 1066, once the order is approved by the user, a pre-authorization request for the order is sent to the payment processor 1060 from the merchant device 1054. In this example embodiment, the payment gateway may involve the use of an email (or EMT) with a link to a payment page specific to that order which is sent to the user to facilitate payment as though the user had placed the order using the secure ordering, payment and delivery system 100 although in this case the merchant is carrying out these steps on behalf of the user. In some embodiments, the merchant, through the merchant device 1054, may enter take their payment information (e.g. credit card) or may send them the payment link as explained above.

In this example embodiment, customer payment information may be saved at the payment processor 1060 to facilitate quick processing. Cost information about the order and also payment information for the user is then sent to the payment processor 1060 from the merchant device 1054. The order data may specify that the user wishes to pay for the order using cash, a credit card or a debit card. If the user wishes to pay for the order using a credit card, then at 1068 the merchant device 1054 provides the credit card payment information for the user to the payment processor 1060. If the user wishes to pay for the order using a debit card, then at 1070, the merchant device 1054 sends the debit card information to the payment processor 1060. If the user wishes to make a cash purchase then a credit card pre-authorization may still be required. The payment processor 1060 then pre-authorizes the payment by issuing a payment processor approval at 1072 if sufficient funds are available for the user. For a first time user, a credit card pre-authorization will secure a payment and reduce the risk of no payment. This is advantageous since it may help reduce prank orders or other forms of theft by securing a payment pre-authorization a credit-card before the order is prepared by the merchant.

At 1074, the payment processor approval is sent to the user device 1052 and the merchant device 1054 to confirm the order. At 1076, the order becomes a live order and the management server 150 generates and sends unique identifiers to each waypoint which in this case is the recipient device (in this case is the user device 1052) that will be at the drop-off waypoint, and the merchant device 1054 which will be at the pick-up waypoint (in this example).

At 1078, information about the order including distance, time of order preparation completion and one or more waypoint locations are sent to courier devices until one of the couriers accepts the order at 1080. At 1082, a pick-up time is determined based on the distance between the courier device 1056 that agreed to deliver the order and the merchant's location. At 1084, the courier device 1056 arrives at the merchant location, receives the merchant's identifier response and then sends the identifier response to the management server 150 for verification.

Upon successful verification of the response identifier for the pick-up, the courier travels to the users location. At 1086, the courier device 1056 arrives at the users location, receives the user's identifier response and then sends the identifier response to the management server 150 for verification. Upon successful verification, a confirmation of drop-off is sent to all parties. At 1088, the management server 150 sends an electronic message to the payment processor 1060 which then completes the financial transaction. An email receipt of the transaction may then be generated by the management server 150 at 1090 and sent to all parties.

Referring now to FIG. 6C, the example use case 1100 shows an example interaction between a user device 1102, a non-registered merchant (NRM) module 1104, a courier device 1106, the management server 150 and a payment processor 1110. This is another example of using the secure ordering, payment and delivery system to create an order for goods and/or services directly from the ordering and delivery system which may provide goods and/or services for purchase or may request the goods and/or services from a merchant that is not registered with the ordering, delivery and payment system 100. As before, it is possible for multiple waypoints for pick-up or delivery to be created with tasks that are specific to each waypoint.

To facilitate the implementation of this particular use case, the ordering and delivery system includes an NRM module 1104. The NRM module 1104 may be used to order at least one good and/or service that can be provided by the secure ordering, payment and delivery system 100 or to order at least one good and/or service from a third party merchant that is not registered with the secure order, payment and delivery service system 100 for access by users or consumers. This type of order request may also be referred to as a non-registered merchant order.

It should be noted that in an alternative embodiment, the system 100 may include a No-Link Waypoints (NLM) module that may be used instead of the non-registered merchant module 104. An NLM module may be for merchants or users that are not registered with the secure ordering, payment and delivery system 100. The term “No-Link” indicates that there is no transmission between the creator of the order to a buyer or a merchant or a seller or another other way point contact. Accordingly, the waypoint is handled by the secure ordering, payment and delivery system 100 as if there were no link to the system. This means that there is a 2 way communication (i.e. communication between two entities) rather than a 3 way communication (i.e. communication between three entities).

At 1112, the creator sends an order request to the NRM module 1104. In this example, the creator may have selected at least one good and/or service that was shown on a web page or an electronic document that is being managed by the management server 150 rather than another merchant. In some embodiments, a web store may be created for a merchant that does not currently exist in the merchants database but with which requests may be placed and orders delivered by using the NRM module 1104. This technique may be described as being a crowd sourced web store and crowd sourced item creation in that a user or creator can help build this web store (this is described in more detail below).

At 1114, if the secure ordering, payment and delivery system 100 is able to facilitate the order then it will determine the preparation time and the ETA of the delivery and send this information to the user device 1102. At this point, the management server 150 may determine distance, route, delivery cost information and total cost information which is part of the information (not shown) that is sent to the user device 1102. If the secure ordering, payment and delivery system 100 must interact with a third party non-registered merchant to prepare the order then this merchant will provide the preparation time which is then used by the NRM module 1104 to determine the ETA of the delivery, which is then communicated to the user device 1102. Along with the ETA, the NRM module 1104 sends the total cost to the user device 1102.

At 1116, the user may add a tip to the total cost and this information is communicated to the payment processor 1110. At 1118, the user, via the user device 1102, provides payment information to the payment processor 1110 which is then verified and processed by the payment processor 1110 in the case of using a credit or a debit card. Alternatively, the user may choose to provide payment through cash.

At 1120, payment or pre-authorization verification is notified to the management server 150 and the NRM module 1104 when the payment processor 1110 determines that the user has sufficient funds to pay for the transaction. For example, in the case of a non-registered merchant providing the goods and/or services, the expected purchase amount for the goods or services may be pre-authorized on the user's credit card to facilitate a purchase for this order.

It should be noted that in some embodiments, an order may be a “proxy purchase” or a “proxy payment”, which is a purchase or payment that is requested by a merchant or a customer (both referred to here as a creator) when placing an order for pickup and drop-off. In this case, the creator of the order request includes a task which specifies if a purchase needs to be made on their behalf. The creator inputs the maximum amount to be transacted at the location and to be pre-authorized on their credit card/account. Once the courier has completed the transaction as per the task requested by the creator, the actual and exact transaction amount as charged to the courier's payment card will be transacted from the creator's credit card/account. Accordingly, the courier payment card may be used as the proxy purchasing card and the pre-authorization amount, as defined by the creator, may also serve as a limit to the amount that the courier payment card may be charged.

Likewise, the proxy payment may be created for a courier to perform some task, such as picking up items that are needed and requested by a merchant, for example. When creating a proxy payment request, the creator inputs an amount to be collected for or from the creator (e.g. from the pick-up or from the drop-off). The payment may be collected in cash or any other suitable form such as debit or credit.

In both of these situations, the payment processor 1110 may settle the total charge on the user's credit card which matches the exact charge transacted on the courier's payment card at the point of sale. The courier's payment card may be linked to a credit card account or a debit account, for example. It should be noted that a custom order or custom run may comprise a proxy purchase or a proxy payment collection in certain cases.

It should be noted that for proxy orders, there may be a fixed charge for each task that must be performed or there may be different task specific charges. Also, for proxy orders, the courier may make a purchase on behalf of the creator of the proxy order. For proxy orders, in some embodiments, it may not be the response identifier (e.g. PIN code) that is used to verify the transaction conducted by the courier but rather the amount of the transaction made by the courier that may be used for verification. This is not the case for the example in FIG. 6C since identifiers and identifier responses are used. In some cases, the courier may be instructed in the task data to take a picture of the item that has been purchased or the courier may perform other tasks that were specified by the creator such as retaining a copy of the receipt, etc. At the end of the proxy order, when the order has been facilitated by the courier, the creator of the proxy order may finalize payment for the order; for example, the creator may pay in cash or their credit card account may be billed to settle charges for the order.

The order becomes a live order when the creator has “checked out” which means that all of the steps regarding payment verification have been performed and confirmed to the creator.

At 1122, the NRM module 1104 determines a preparation time for the ordered goods and/or services to be ready for pick-up by a courier. The preparation time along with other information about the order including distance, time of order completion and one or more waypoint locations are sent to the courier devices using an EMT until one of the couriers accepts the order at 1124.

At 1126, the management server 150 also becomes aware that the courier has accepted the order and at 1128 the management server 150 generates unique identifiers that are sent to the user device 1102. The identifiers may be sent in an email, an SMS code or some other form of electronic message transmission (EMT).

Thereafter, still at 1126, the courier who accepted the order may edit a portion of the order using the courier device 1106. For example, since the catalogue of the non-registered merchant can only be verified once a courier is at the location, there may be some items that are not available and therefore a courier may make a suggestion for an alternate item or may simply inform the creator of the order of an item's unavailability. Any edits made to the order may be sent back to the creator for verification.

At 1130, a drop-off time is determined based on the distance between the courier who is using courier device 1106 and agreed to deliver the order, the non-registered merchant's location and the waypoint that was indicated as being a drop-off point for the order. The drop-off time may be communicated to the user device 1102. In some embodiments, this information may also be sent to the NRM module 1104 which may relay this information to the user device 1102.

At 1132, the courier having courier device 1106 arrives at the pickup location and picks up the items that are specified in the order. The location of the courier (and hence the courier device 1106) may be used to determine whether the courier has reached the NRM location or not. Also, the tasks associated with a particular waypoint may be marked complete or incomplete by the courier on the courier device 1106 and a notification may be generated. For example, when pickup is complete, a pickup notification may be sent to the user device 1102 and may also be sent to the management server 150 to indicate that the task(s) at the pickup waypoint were completed. If the pick-up failed after the editing process, then the waypoint may be cancelled along with the associated drop-off waypoint if this is the only pickup waypoint associated (i.e. specified in the same order) with the drop-off waypoint. The action of cancelling the order may be executed by the creator when reviewing the status of the order or the edited order when at least one item is indicated as being “item unavailable”.

At this point a request may be sent to the payment processor 1110 to finalize the payment. Alternatively, in some embodiments, it is possible for the user/customer to make a payment in advance using debit since debit cards cannot be pre-authorized, therefore the customer may choose to settle the transaction in advance which may include gratuity (tip).

At 1140, the payment processor 1110 sends a notification of payment settlement to the user device 1102.

At 1136, the courier with the courier device 1106 arrives at the user's location to drop off the order. The courier device 1106 receives the user's identifier response and then sends the identifier response to the management server 150 for verification. Upon successful verification, a confirmation is sent to the user device 1102 at 1138 and payment is then transferred to the courier's payment card. An email receipt of the transaction may then be generated by the management server 150 at 1134 and sent to all parties.

As mentioned before, the creator use an electronic device, referred to as the creator device, to create a web store for a merchant that does not currently exist in the merchant catalogues database in order to place orders for at least one item (it should be noted that in the description that follows an item may be a good or a service) using the creator device. Once the order is created, the NRM module 1104 may be used to place the order with an electronic device associated with the non-registered merchant. This may all be facilitated by the creator using their electronic device to interact with the ordering and delivery system which communicates with the non-registered merchant and to one or more courier devices that are associated with one or more couriers respectively. This is advantageous as the non-registered merchant and couriers may be located in different locations and their identities may not be known prior to placing the order but the ordering and delivery system may determine this information through instantaneous determination and electronic communication with these various parties.

In order to create a web store, the creator may create a new business waypoint for the web store by sending information from the creator's device to the server of the secure ordering, payment delivery system 100. Information provided by the creator which may be used to create the business waypoint include various business attribute data including, but not limited to, at least one of business name, business address and/or business contact, for example. The business information may be verified before the web store is created.

The creator may also create new items for the business waypoint by sending information from the creator device to the server of the secure ordering, payment and delivery system 100. The creation of new items may include specifying various item attribute data including, but not limited to, at least one of an item name, an item description, an item price and/or an item image, for example. In some cases, an item weight and/or an item volume may also be specified for an item by the creator. In some cases, the description and/or the image may be optional. The item information may be verified before it is associated with the web store.

In one aspect, the price may be provided as being approximate (e.g. a budget), and the price may be determined at non-registered merchant's point of sale by the payment module. Instructions for payment may be provided to the courier device as an instruction to use a specific payment method (e.g. a type of courier credit card) to pay for the products and the credit card will have a limit correlating to the budget. The price that is settled at the management server will be the price charged to the creator of the order.

The newly created business waypoint and corresponding items may be stored in one or more databases of the secure order, payment and delivery system 100 for future use by the same creator or a different creator. Also, in the future, the same creator or another creator may add another item to the web store.

Once the business waypoint and items have been configured by the creator, the web store for the non-registered merchant may be made accessible online. The creator may then access this web store at which point the items available at the non-registered merchant may be displayed. The order may then be prepared by the creator by adding the desired item(s) to an online cart and sending this information from the creator device to the server of the ordering and delivery system.

The creator may then proceed to create a drop-off waypoint for drop-off of the ordered item(s) by sending information from the creator's device to the management server 100 of the secure ordering, payment and delivery system 100. The drop-off waypoint may be created by specifying drop-off waypoint attribute data including, but not limited to, at least one of a drop-off waypoint name, a drop-off waypoint address, a drop-off waypoint image (which may be used by the courier to identify the waypoint), and drop-off waypoint contact information, for example. Once the waypoint is created, a route for a courier may be determined by using the mapping module, for example.

After the drop-off waypoint is specified, the creator may proceed to a checkout web page for the online cart. At this stage, a payment amount or charge is determined based on a sum of the ordered item(s) as well as other charges, such as delivery charges, task charges and tax, for example. The payment amount is sent to the creator device from the management server of the secure ordering, payment and delivery system 100. The creator may confirm the amount that is to be pre-authorized on the creator's credit card, debit account or another account that the creator may have setup with the secure ordering, payment and delivery system 100 by sending a confirmation from the creator's device to the management server of the secure ordering, payment and delivery system 100. At this point, the creator may perform one final check of the order before placing it. This check may include at least one of a review of the sprint summary for the order, a review of a cart summary for the order, a review of the waypoints (e.g. business and/or drop-off waypoints) for the order and a review of the route that the courier device will be given. The creator may then choose to place the order by transmitting this request from the creator device to the management server. At this point, the order is then broadcasted from the management server of the secure ordering, payment and delivery system to the electronic device associated with the non-registered merchant and the courier devices associated with couriers who may be available to deliver the ordered item or perform some other task related to the ordered item, such as providing payment, for example. At this point, the method may follow method 1100 of FIG. OC. At this point, there may also be user tracking. Once the order has been processed by the system, the creator may use the creator device to track the progress of the order through an online portal such as that shown in FIG. 4I, for example, based on tracking information that is sent to the creator device by the management server of the secure ordering, and payment and delivery system 100.

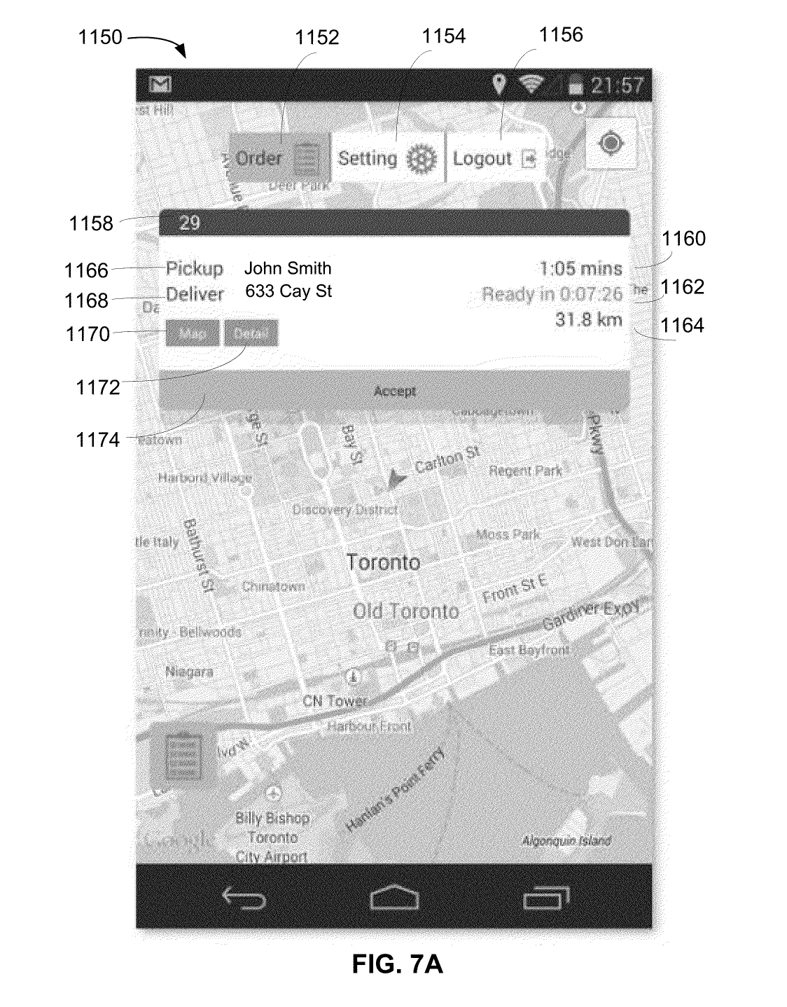

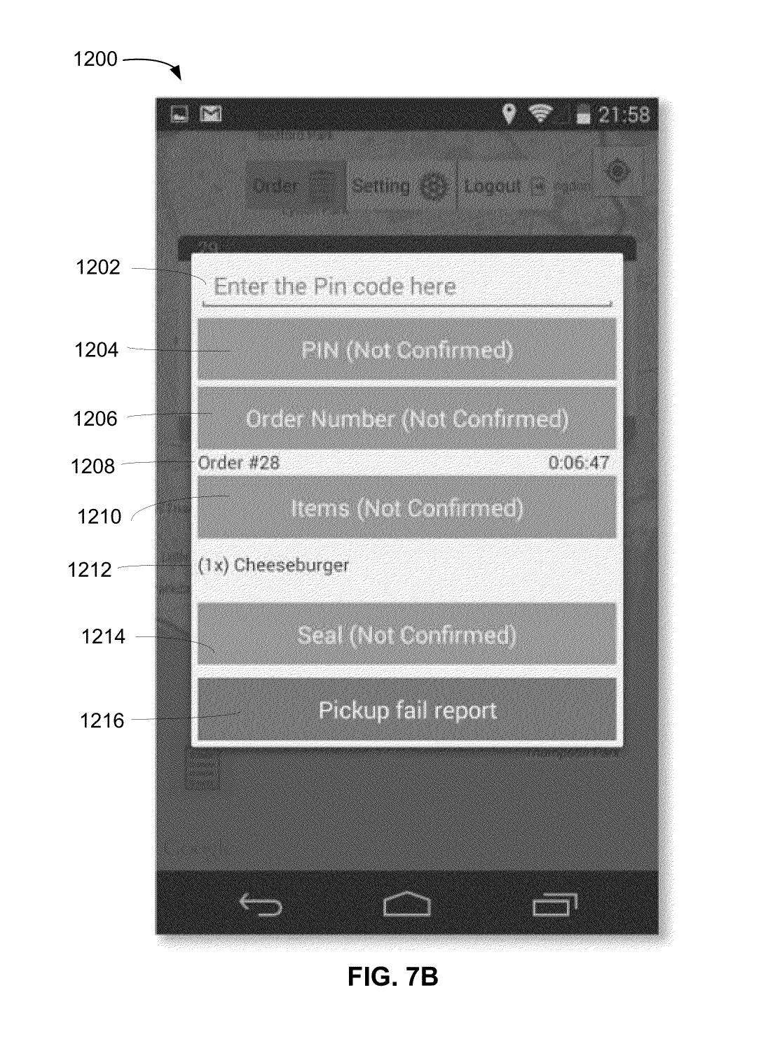

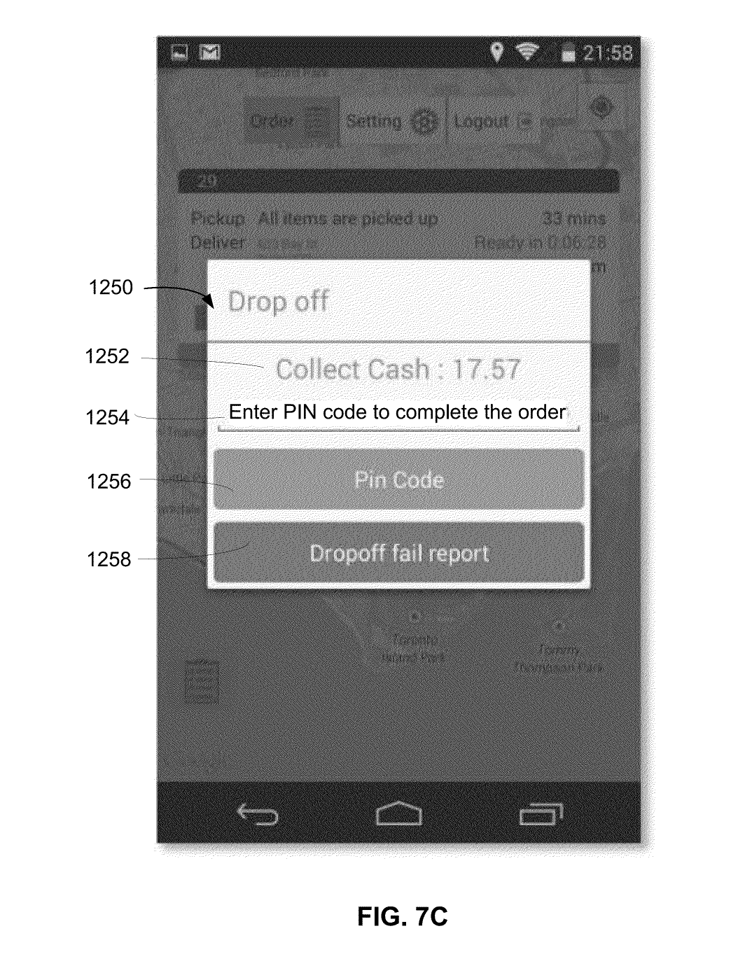

Referring now to FIGS. 7A-7C, shown therein is an example embodiment of several courier graphical user interfaces that may be displayed at a courier device and used by the courier when accepting a courier request, making a pick-up and/or making a delivery. For example, FIG. 7A shows a courier request GUI 1150 that may be displayed to a courier so that the courier may decide whether or not to accept the courier request. In another example, FIG. 7B shows a waypoint pick-up GUI 1200 that may be displayed to a courier when the courier is performing tasks at a waypoint that is a pick-up location. As another example, FIG. 7C shows a waypoint drop-off GUI 1250 that may be displayed to a courier when the courier is performing tasks at a waypoint that is a drop-off.

Referring now to FIG. 7A, the courier request GUI 1150 comprises several options that may be accessed by a courier when interacting with the system 100. The options comprise an order option 1152, a setting option 1154, a logout option 1156 and an accept option 1174. There is also an order notification 1158 which shows identification for the order, such as a number. When the order option 1152 is selected, the GUI 1150 will provide information about an order corresponding to an incoming courier request. When the setting option 1154 is selected, the courier may be able to change certain settings related to the courier requests such as, but not limited to, receiving courier requests that are within a certain specified distance, receiving courier requests that have a minimum charge or receiving courier requests that require a certain vehicle type and each of these may be used as a filter for incoming courier requests. For example, if the courier request specifies a van and the courier device setting is set to car then the courier device would not show the courier request. Other settings that may be changed include, but are not limited to, profile information, profile picture, profile description and account security settings such as password changes and address changes. When the logout option 1156 is selected, the GUI 1150 is disabled and the courier receives no further courier requests. In other embodiments, other options may be used. If the courier decides to accept the courier request, the courier may select the accept option 1174.

In this example, the order option 1152 is selected and an example of information that may generally be shown for an order is shown for an order notification 1158 that is order #29 and corresponds to the current courier request. In this example, the order information may also include the total delivery time data 1160 for doing the entire delivery. The order information may include preparation time data 1162 that indicates how much time is needed for the goods at the pick-up waypoint to be ready for pick-up. The order information may also include a total distance data 1164 that is expected to be traveled if the courier accepts the courier request. The total distance data 1164 may be recalculated and redisplayed every so often (such as every 15 seconds) if the courier is moving. The total delivery time data 1160 and/or the expected time of delivery may also be updated in this case.

The order information may also include contact information data 1166 including a contact name or a business name that the courier must interact with at the pick-up waypoint to perform the associated tasks. The order information may also include delivery address information data 1168 that includes the address of the drop-off waypoint. In some cases, there may be multiple pick-ups and multiple drop-offs. In addition, the address information for the pick-up and/or the contact name for the drop-off may be specified.

Other options may be included to show further information about the order 1158 such as, but not limited to, at least one of a map option 1170 and a detail option 1172. If the courier selects the map option 1170, then a map showing the waypoints and a route for traveling between the waypoints may be shown. If the user selects the detail option 1172, then additional order information about the order 1158 may be displayed such as, but not limited to, at least one of turn by turn directions, total time to completion and other account information. Any additional information which could help the courier determine the amount of time and effort and liabilities involved with the order.

Referring now to FIG. 7B, the waypoint pick-up GUI 1200 may comprise various input boxes 1202, 1208, and 1212 as well as several display outputs 1204, 1206, 1210, 1214 and 1216. The waypoint pick-up GUI 1200 is shown when an order is active, the courier request has been accepted and the courier is at a pick-up waypoint. Each waypoint has its own set of tasks, known as the waypoint checklist, with each box representing a task on the checklist. Accordingly, any tasks that are created by the creator of the order may also be shown in the waypoint pick-up GUI 1200 as another line item to check when it has been accomplished. Each task carries out a specific function which may include, but is not limited to, at least one of verifying identifiers, items, weight, and/or volume, as well as taking pictures of receipts and/or goods, collecting payments, making purchases, and editing order attributes, for example.

For example, if the creator of the order selects the “take a picture” option as a task for the courier to perform then an additional input such as a box may appear in the GUI 1200. By clicking on the “take a picture” box, the courier device will launch its own camera application and instruct the courier to take a picture of the user described item such as, but not limited to, at least one of the parcel, a receipt, and the like, for example. The picture may be stored at the management server 150 with access available to the creator of the order and the management server administrator, or customer if so defined by the creator of the order.

The input box 1202 receives an identifier response from the contact at the pick-up waypoint. The identifier response may be the initial identifier that was sent by the system 100 to the merchant device that corresponds to the pick-up waypoint, which is what is shown in this case as the “Pin code”. In other embodiments, the identifier response may be the output of a cryptographic algorithm or some other method that operates on the identifier as an input at the merchant device.

Once the identifier response has been entered at the GUI 1200, the identifier response is sent to the management server 150 which then performs verification on the identifier response to determine whether it is authentic. The authentication result is then sent to the courier device and displayed at display output 1204. In this example, the response identifier was not authentic so an authentication result message is displayed that the PIN is not confirmed. If the response identifier was authentic then the result message is displayed that the PIN is confirmed. If the PIN is not confirmed then this means that the contact at the pick-up waypoint may be fraudulent or that the courier went to the wrong waypoint.

At input box 1208, an order number is entered. The order number may be on a ticket that is put on the parcel or package that is picked up at the pick-up waypoint. The order number can then be compared to the order number received by the courier device and shown on the courier request GUI 1150. The management server 150 performs this comparison as part of another level of checking or verification to add to the secure operation of the system 100. The order number is created by the system 100 when the identifiers are created for each waypoint. If the order is a custom-run then there may be a custom run number that is used. The result of the order verification check is shown in display output 1206. If the order number input at the courier device does not match the order number created by the management server 150 then this result may be displayed as result message “Order Number (Not Confirmed)”, for example. If the order number input at the courier device does match the order number created by the management server 150 then this result may be displayed as result message “Order Number (Confirmed)”, for example.

At input box 1212, the items that are part of the order 1158 may be input by the courier and another verification check may be performed to determine whether all of the items specified in the order 1158 to be at the pick-up waypoint have been picked up by the courier. The items that are listed at the input box 1212 may be sent to the management server which checks to see if all of the correct items have been picked-up. If this is true, then the result message “Items (Confirmed)” may be displayed at the output display 1210. If this is not true, then the result message “Items (Not Confirmed)” may be displayed at the output box 1210.

At 1214, the courier can check to make sure that a package that contains the items to be picked up at the pick-up waypoint is sealed. If this is true, then the courier may provide an input indicating that the package is sealed and this may displayed on the display output 1214. A seal is a tamper-proof label that may be applied to some of the packages being transported by the courier. If a creator of an order selects a Seal/Tamper-proof task when creating the order then the Seal/Tamper-proof task is performed and the result may be shown at 1214.

At 1216, the final result of the tasks performed at the pick-up waypoint is displayed. If each of the verification checks are confirmed then a result message “Pickup successful report” may be displayed at the display output 1218. If any of the verification checks are not confirmed, then the result message “Pickup fail report” may be displayed at the display output 1216.

Referring now to FIG. 7C, the waypoint drop-off GUI 1250 comprises a task list display output 1252 for the courier, a response identifier text input box 1254, a response identifier verification display output 1256 and a waypoint result output 1258. In other embodiments, other input boxes or display fields may be used.

The task list display output 1252 displays the next list of tasks to be performed at the drop-off waypoint by the courier. In this example, the courier is to collect payment in the amount of $17.57 in cash. In other examples, the courier may be instructed to receive payment by credit card or by debit card. In some embodiments, if the payment is made by credit card, then the transaction may not be settled until the response identifier is verified by the management server 150 and the credit card transaction has been pre-authorized by a payment processor.

Once the payment is received, a response identifier is entered at the response identifier input box 1254. The identifier response may then be sent to the management server 150 which performs verification on the identifier response to determine whether it is authentic. The authentication result is then sent to the courier device and displayed at display output 1256. If the response identifier is not authentic, the authentication result message “PIN (Not Confirmed)” may be displayed. If the response identifier was authentic then the result message “PIN (Confirmed)” may be displayed. If the PIN is not confirmed then this may mean that the contact at the pick-up waypoint may be fraudulent or that the courier went to the wrong waypoint.

If the drop-off is successful, then the waypoint result output 1258 may display “Drop-off success report”. If the drop-off is not successful, then the waypoint result output 1258 may display “Drop-off fail report”. In this case, a text box may pop up for allowing the courier to enter a reason as to why the drop-off had failed and this information may then be relayed back to the management server 150 as a ticket that requires resolution. A creator may also specify alternative actions that the courier may take in case the drop-off were to fail by entering the instructions in the description/instructions (see 910 in FIG. 4F).

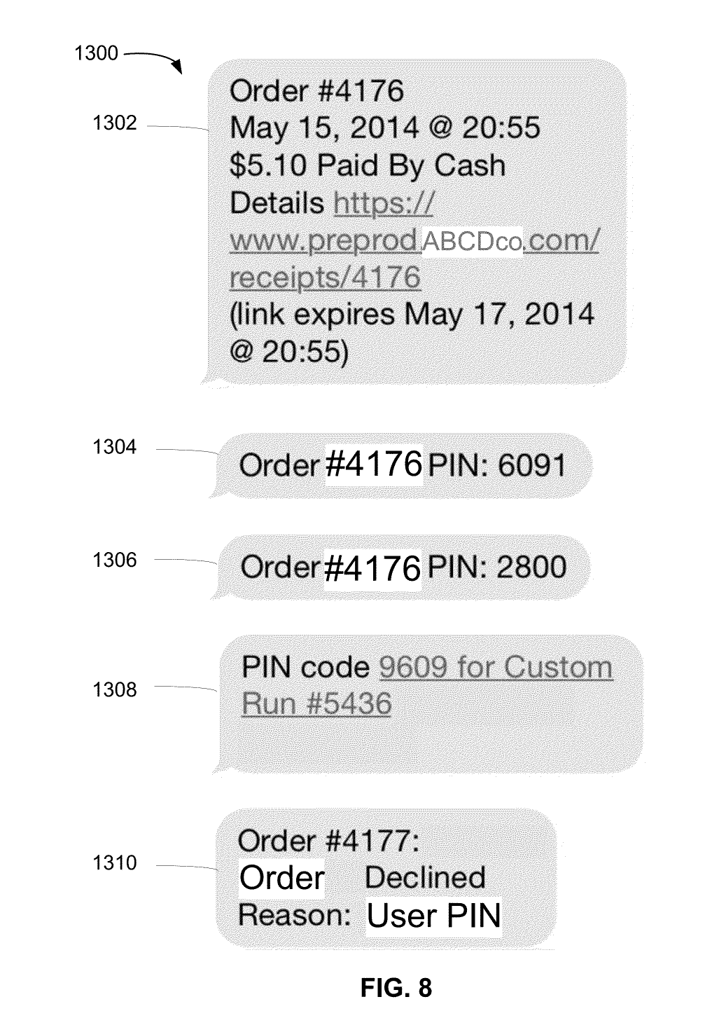

Referring now to FIG. 8, shown therein are examples 1300 of some electronic messages that may be sent during the operation of at least one of the embodiments of the secure ordering, and payment and delivery systems that are described herein. While SMS messages are shown in FIG. 8, it should be understood that other types of electronic messages may be used.

An SMS message 1302 is shown that is a receipt that may be given to a user for an order that was delivered. In this example, the order was order #4176 that was delivered at 8:55 pm on May 15, 2014. The order was paid for using cash in the amount of $5.10. A link that provides more information on the transaction is provided as well as a date at which the link expires.

Two SMS messages 1304 and 1306 are shown that are PIN code (i.e. identifiers) notifications that were generated for the order #4176. The SMS message 1304 was sent to a merchant device to provide the PIN code 6091 to the merchant for the order #4176 and the SMS message 1306 was sent to the device of the recipient of the order (e.g. the person who will receive the delivery) to provide the PIN code 2800 for the order #4176.

SMS message 1308 is an example of a PIN code notification for an order that was a custom run #5436. In general, a custom run is a customizable pick-up and drop-off service that can be created by a creator by defining certain tasks and instructions. The various secure ordering, payment and delivery systems described herein may implement a template to cover most of the tasks and instructions that are typically encountered within its operating environment. However, custom runs enable a creator to further customize tasks and instructions and streamline the secure order, payment and delivery process. For example, a custom run may be created by a merchant who needs a courier to drop-off some items to a buyer or to pick-up some items for delivery to the merchant. As another example, a user may also create a custom run to perform certain tasks which do not require ordering an item but rather picking up an item or completing some other task, such as picking up dry cleaning, for example. In another example, a creator may choose to have their documents picked up from their office and delivered to another office. In another example, a creator may schedule multiple pick-ups and one drop off for a future date in the case of a laundry service provider.

Alternatively or in addition thereto, for a custom run, the courier may perform some verification tasks such as taking a picture of the receipt or product that is picked-up (this can be specified when creating the tasks for a waypoint). The picture may then be sent to the creator of the custom run and/or to the management server 150. This may be used for verification and/or quality control.

Alternatively, or in addition thereto, for a custom run, the creator of the custom run may choose whether the courier may see the identifier or PIN code for tasks at a specific waypoint and/or whether the courier device may send the PIN code to the respective party at the specific waypoint by electronic messaging which may, for example, involve any combination of the following: email, SMS, push notification, and text messages. The merchant may choose not to see the PIN if the respective party so wishes, and they will be notified when the PIN has been hidden from the creator. The Merchant or creator of a custom run may choose to disable the PIN verification and the order may be marked to indicate “NO PIN VERIFICATION REQUIRED BY CREATOR”.

SMS message 1310 is an example of a status notification that shows the result of an order. The SMS message 1310 indicates that order #4177 has been declined or rejected because the PIN code of the user was not found to be valid. In other cases, there may be other reasons as to why an order is declined or rejected such as the merchant not preparing the order properly which may be determined when the courier arrives to pick-up the ordered items, for example.

Referring now to FIG. 9, shown therein is an example embodiment of a control panel 1400 that may be used by a system administrator or system controller to monitor and to control the activity of an ordering and delivery system according to the teachings described herein. The control panel 1400 includes a plurality of tabs for displaying different types of information. The plurality of tabs include a dashboard tab 1402, a merchant tab 1404, a courier tab 1406, a user tab 1408, a finance tab 1410, a dispatch tab 1412, a call center tab 1414 and an admin settings tab 1416. Each of the tabs may be used to access a corresponding window which provides information on a particular aspect of the secure ordering, payment and delivery system 100. In other embodiments, some of these tabs may be omitted and/or some other tabs may be included.

For example, the dashboard tab 1402 may be used to control whatever an end user or buyer is able to see when they are interacting with the ordering and delivery system on their buyer device. For example, the dashboard tab 1402 may allow a user to specify customizable reports that amalgamate information for certain existing pages or tabs.

The merchant tab 1404 may be used to view information about all of the merchants that are registered for use with the secure ordering, payment and delivery system 100. For example, the merchant tab 1404 may provide an interface to the merchant catalogues database 151d which is a directory of all merchants and allows the system administrator to access information about the merchants such as, but not limited to, contact information, address information, item information, payment information, billing information and reports. The system administrator may also use the merchant tab 1404 to access information on the current merchant's operations status, such as active, inactive, suspended, and pending.

The courier tab 1406 may be used to view information about all of the couriers that are registered to interact with the secure ordering, payment and delivery system 100. For example, the courier tab 1406 may provide an interface to a courier database which allows the system administrator to access information about the couriers such as, but not limited to, at least one of contact information, vehicle information, performance statistics, payment information, account statements, bills and invoices. The courier tab 1406 may also allow the system administrator to access a directory listing of all couriers, along with status such as, active, inactive, suspended, pending, scheduled and unscheduled.

The user tab 1408 may be used to view information about all of the users that are registered to place order requests with the secure ordering, payment and delivery system 100. For example, the user tab 1408 may provide an interface to the user accounts records database 154d which allows the system administrator to access information about the users such as, but not limited to, at least one of contact information, address information, order history, payment information, sales information and history of use.

The finance tab 1410 may be used to setup financial information that may be viewed by the merchants who use the secure ordering, payment and delivery system 100. For example, the finance tab 1410 may allow an administrator to allow merchants to view information about a summary of all of the payment transactions made by the merchants, invoices and statements as well as other information that is related so sales performance analytics including, but not limited to, any additional reporting on their account, for example.

The dispatch tab 1412 may be used to view information regarding orders that have been delivered, are currently being delivered or are in the process of being delivered. In this example embodiment, a dispatch window associated with the dispatch tab 1412 is shown. The dispatch window may include at least one of the current time, the number of current active orders 1430, the number of scheduled orders 1432 in a certain time period that have been placed in advance, the number of orders that were delivered late 1434 and the total completed orders 1436 for a certain time period.

The dispatch window may also provide information on each order including, but not limited to, at least one of an order number 1438, an order time 1440 for the time the order was placed, a merchant name 1442 for the merchant that is preparing the items in the order, a courier name 1444 for the name of the courier that will carry out the tasks at each of the waypoints for the order, a zone 1446 where the order is to be delivered, an order status 1448, a contact name 1450 for the customer/buyer and a performance indicator 1452. In other embodiments, some of this information may not be presented on the dispatch window and/or other types of information may be presented on the dispatch window. Other details about a particular order such as the item details may be accessed by clicking on the row for that particular order.

The order status 1448 may use various status identifiers (identified herein as quotations in brackets) that indicate whether the order was delivered (e.g. “delivered”), whether the order has been picked up by the courier and the courier is enroute to the recipient (e.g. “delivering”), whether the items in the order is still being prepared by the merchant and the courier is enroute to pick up the items (e.g. “processing”) or whether a courier request has been transmitted and the system 100 is waiting for a courier to accept the courier request (e.g. “waiting”).

The performance indicator 1452 may be used to describe the timing and/or quality of each order that has been fulfilled. For example, an order may have been fulfilled early, late, on-time or may still be pending. For late or early delivered orders, the amount of time by which the order was delivered late or early, respectively, may be shown. In this example embodiment, various codes may be used to encode different delivery delays such as, but not limited, at least one of being late due to PUD (Pick up delay), PRP (Preparation/Processing Delay), COD (Commuting Delay) and CAR (Car Trouble), for example. In at least some embodiments, codes may be used to indicate that an order was inaccurate such as, but not limited to, at least one of WRO (Wrong Order #), WRI (Wrong items), IQT (Incorrect Quantity) and ITO (Incorrect Total), for example. In addition or as an alternative thereto, in at least some embodiments, codes may be used to indicate No Delivery such as, but not limited to, at least one of WDL (Wrong Delivery Location), WAC (Wrong Address—Customer Order), WAM (Wrong Address—Merchant Order), WDC (Wrong Delivery Time—Customer Input) and WDT (Wrong Delivery Time), for example. In some cases, these codes may be used to help the system administrator to connect the appropriate parties to resolve an issue based on the type of error code that is returned from the courier device for that particular issue.

The call center tab 1414 may be used to perform various actions such as dealing with pending tickets and/or acting as a customer support line funnel. For example, there may be line items indicating whether there is a client (e.g. creator) waiting on call/email. The line items may also include columns indicating the nature of the issue, the urgency of the issue, the amount of time lapsed since the creation of the issue and so on. This window may populate customer service data as mentioned above for all end-users, merchants and couriers that are related to the order for which the ticket was created.

The admin settings tab 1416 may be used to set parameter values for the entire service based on the user type i.e. Buyer, Merchant or Courier. For example, the admin setting tab 1416 may be used to manage all user charges, service options, security settings, profile settings and overall access to service(s).

The zones/schedules tab 1420 may be used to provide information about the couriers that are registered with the secure ordering, payment and delivery system 100. For example, a map showing the location of current active couriers may be shown for a given zone. The status of the courier may also be shown along with their location and this status may be similar to the order status given for the status filed 1448.

It should be noted that a zone is a sub-area of the total area that is serviced by the secure ordering, payment and delivery system 100. The given zone generally includes merchants that will prepare items for orders and the couriers that may fulfill the order. The given zone may also include the end user. The total area that is serviced by the secure ordering, payment and delivery system 100 is divided into zones as this make it more efficient to locate couriers that are best able to fulfill an order in a reasonable amount of time.

The use of zones may be used to enable scheduling of couriers. The courier schedule may also be displayed by selecting the zones/schedule tab 1420. The courier schedule may include a list of couriers, the times that they will be available to fulfill orders and the zones in which they will be operating.

The settings tab 1422 may be used to set parameters that are used for determining the charges for delivering an order. For example, the settings tab 1422 may be used to set a delivery charge based on various factors such as, but not limited to, at least one of the delivery distance, the type of items ordered (for example, larger items may have a higher delivery fee), and the priority of the order (for example, an express delivery charge for express orders).

The activity map tab 1424 allows the system administrator to plot information regarding the couriers, merchants and buyers for all current live orders in a given zone. Alternatively, this information may be shown for a selected order. Icons can be used to indicate the locations of each of the couriers, merchants and buyers for a selected live order similar to what is shown in FIG. 4I. A small status window showing the status of the selected live order may also be displayed. Alternatively, the courier, merchant and buyer information for the selected live order may be shown in a table format that is similar to what is shown in FIG. 9. Alternatively, the courier, merchant and buyer information for all live orders may be shown in a table format.

The resolutions tab 1426 may also be used to deal with or resolve any problems for a given order however the tickets being dealt with at this tab may be email or EMT tickets that are created by administrators, merchants, users or couriers. For example, there may be a dispute as to whether an order was delivered, or if an order was delivered late or incorrect. The resolutions tab 1426 may include tickets for each such dispute as well as dispute resolution information that was logged about the order that may be used to resolve the dispute. Examples of dispute resolution information include, but are not limited to, at least one of the total delivery time, the list of items that were picked up and/or delivered, and proof of financial transactions, for example.

Another example of dispute resolution may be when the recipient of a delivery is unavailable and the courier uses the courier device to report a problem by describing it. This will create a ticket including all of the waypoints and their details that were involved so that the system administrator can resolve the issue. The system administrator can address the issue remotely by contacting the contact people at the waypoints and notifying and following up with the order creator. The ticket's progress may be tracked on this page as well. Accordingly, this page may contain a directory listing of all of the tickets consisting of information for possible solutions, contacts, or any monetary adjustments that need to be made such as additional charges, or credits to a merchant's account, a courier's account, or a customer's account against the order, payment and delivery system account.

The data/log tab 1428 may be used to show log data for every transaction that has occurred using the secure ordering, payment and delivery system 100. The log data includes a plurality of transaction data that may include at least one of order request data (for example, see FIGS. 1B-1F and the related description), order performance statistics (such as the total delivery time, the preparation time, etc.), and financial transaction data. The log data may be used to resolve any disputes about an order. For example, in some embodiments, the log data may be used to provide data that may be used to resolve a ticket in the resolutions/issues page.

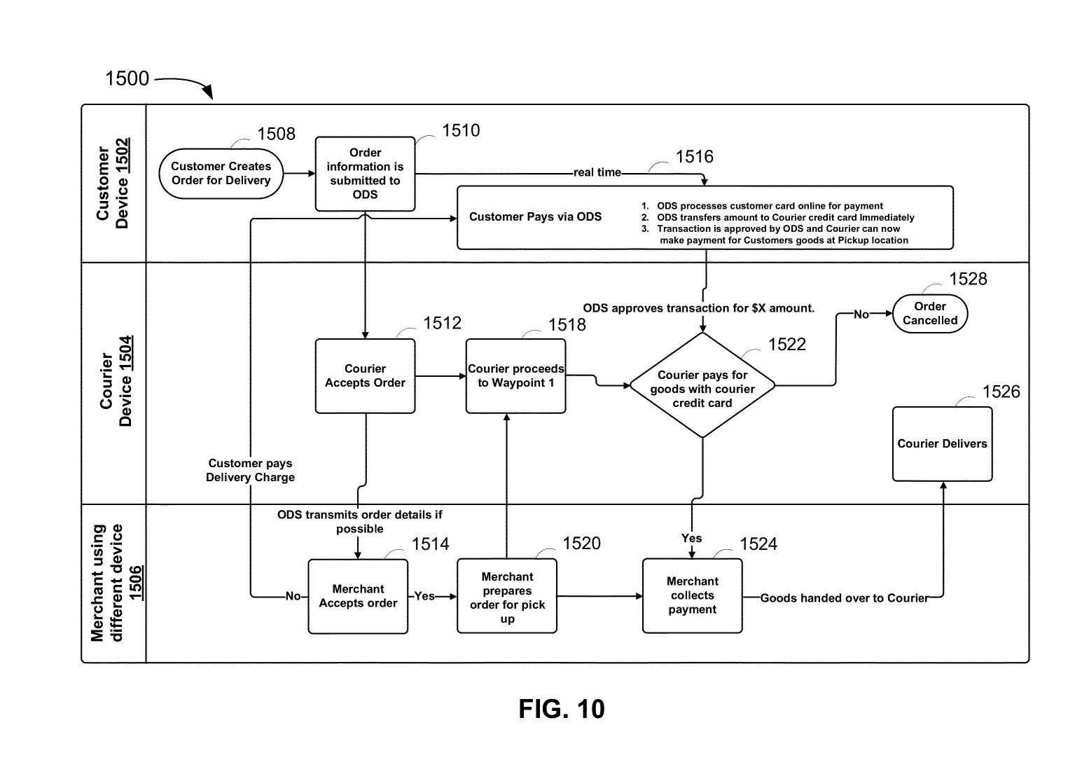

Referring now to FIG. 10, shown therein is an example embodiment of a secure order, payment and delivery process 1500 for an alternative embodiment of the ordering and delivery system (ODS) that uses a management server (not shown) having payment processing functionality and also allows a courier to pay for an order on behalf of a customer. In particular, FIG. 10 provides an example of when a proxy purchase may be made. In this instance, a courier, through their courier device, may confirm whether the items specified in an order for pick-up are actually available once the courier reaches the pick-up location or merchant location. A proxy purchase may most likely be carried out for a non-registered merchant order, such as the example given in FIG. 6C. The example in FIG. 10 involves a customer using a customer or buyer device 1502, a courier that facilitates the order and is using a courier device 1504 and a non-registered merchant that is preparing items for the order and is using a different device 1506. In the case that the merchant is non-registered, the management server 150 and the courier device 1504 may simulate the data that is received/sent to a merchant.

At 1508, the customer creates an order request to order certain goods, items and/or services from the merchant for delivery to a particular recipient which may be the customer or another recipient. At 1510, the order request is sent to the management server 150 for further processing. For example, the management server 150 may broadcast a courier request to couriers to accept the request at 1512 using the courier device 1504. The management server 150 may start processing the customer's payment information at 1516.

At 1514, the details of the items that the customer has requested from the merchant are sent to the device 1506. If the merchant accepts the order than the process 1500 moves to 1516 at which point the customer pays or pre-authorizes payment for the order via the ODS. At 1516, the ODS processes a payment or payment pre-authorization from the customer using payment information that may be sent by the customer device 1502 or may already be on record for the customer. For example, the ODS may process the customer's credit card for pre-authorization. If the customer has enough credit to cover the transaction then the ODS may transfer the amount of the transaction to the courier's credit card. The transaction is now approved by the ODS and the courier can make a payment for the customer's order when the courier picks up the ordered goods and/or services at the pickup location since the merchant is not registered with the secure ordering, payment and delivery system. In the event that a courier arrives at a waypoint that is a pickup and is unable to process the order due to an error on the seller or merchant's part than the user may be charged just the courier's delivery charge.

Generally, in the case of an error, the secure ordering, payment and delivery system may determine which party is liable for the error. For instance, if the merchant takes too long to prepare an order and the customer decides to cancel the order but the order has already been picked-up by the courier than the secure ordering, payment and delivery system may inform the administrator that the merchant was delayed preparing the order and that the merchant is responsible for settling the payment. As another example, if the dispute was due to the secure ordering, payment and delivery system itself then the system may be liable to settle the charges.

It should be noted that in some embodiments, the customer does not always have to pay and there may be other methods of payment that may be used. For example, payment may be settled by the merchant, the secure ordering, payment and delivery system or the courier.

At 1518, the courier proceeds to waypoint 1 which is the location of the merchant that has accepted the order. At 1520, the merchant is preparing the ordered goods for pickup. At 1522, the courier arrives at the merchant location and pays for the goods with the courier's credit card. If the courier's payment is verified and authorized then the merchant may collect payment at 1524 and the goods are given to the courier. The courier may then proceed to deliver the goods to the recipient at 1526. If the courier payment is not verified then the courier does not pick up the goods and the order is cancelled at 1528. The customer may then be notified of the cancelled order.

It one aspect of the various embodiments of the secure ordering, payment and delivery systems described herein, these systems enable the secure and remote transfer of information, communication of instructions, defined tasks, waypoint status updates and payment processing authorization and settlement and at least some or all of these elements may be stored at a central location accessible by a management server and may also provide real-time access functionality.

In another aspect of at least some embodiments of the ordering and delivery system, the system may specify the most appropriate courier for the order, the task information may specify the amount of time allotted to complete a particular task and/or that the task is for the courier to return an item for a refund or exchange.

In another aspect of at least some embodiments of the secure ordering, payment and delivery systems described in accordance with the teachings herein, secure remote payments are possible which allows users to be able to pay for a transaction as if they were physically present at the location where the transaction takes place. In these embodiments, a courier may be used to facilitate the payment at the location and the user can remotely authorize such a transaction. For example, customers may be able to pay through a courier that uses a physical payment card that is pre-authorized by the user for the transaction. This is beneficial in cases where couriers make a pickup at a merchant who is not registered for use with the ordering and delivery system and require payment at their local point of sale in order to proceed with the transaction and complete the order.

In another aspect, when an order is made for items provided by different merchants, then at least one of the secure ordering, payment and delivery systems described in accordance with the teachings herein may generate different receipts for each merchant. The total charge for the total order or the charge for the order from each merchant may be presented to the buyer.

In another aspect of at least one embodiment of the secure ordering, payment and delivery systems described herein, the courier may also complete tasks using their courier device for various tasks at various waypoints. This may be done in addition to using a PIN code or an identifier to verity completion of tasks at a waypoint.

In another aspect, the various embodiments of the secure order, payment and delivery systems and associated methodologies described in accordance with the teachings herein solve various technical problems related to secure and remote ordering, delivery and payment of goods and services which result in various technical advantages such as at least one of providing secure verification that a task has been done, providing secure payment for the task and also enabling error checking, allowing for remote ordering of good and services and delivery of those goods or services to various locations, and resolution for orders that are not completed successfully.

For example, when there is a loss of information during data communication that may cause a miscommunication between at least two of a seller, a buyer and a courier, then at least one embodiment of the secure order, payment and delivery systems described in accordance with the teachings herein may have the capability to track and time stamp each process and task within each order. This makes the process more transparent to identify errors and liabilities and resolve any issues for non-completed or improperly completed tasks. For example, with reference to FIGS. 6A, 6B and 6C, the system may perform at least one of time stamping each task that is created (for logistical support and to determine accountability), determining accountability for each task (which may be the courier), recording order details (from the creator), recording preparation time (due to the merchant), recording travel time (due to the courier) and securing payments in accordance with the instructions provided by the creator of the order. The system also manages and may record any other dialogue and correspondence between the 3 parties via the user device, the merchant device and the courier device that can later be used in error resolution.

For example, in at least one embodiment, a customer's purchase via a credit card may only be used for pre-authorization to secure the purchase and delivery of the goods. Once the delivery has been verified by the system a transaction for the amount will only then be settled. Accordingly, if the courier or the merchant were to fail in delivering the product then there is no need for a charge back or refund to the customer's credit card as a resolution. The charge back process would cost the merchant, however with this system this is one way of avoiding such charge backs.

As another example, at least one embodiment of the secure order, payment and delivery system according to the teachings herein may generally provide continuous contact for all interested parties including providing status updates as well as verification that certain tasks have been completed at certain waypoints in real-time. Since this information may be communicated automatically during the normal course of action of a buyer, a merchant and/or a courier, there will not be a slowdown in the completion of any tasks at any of the waypoints or the actual delivery when the courier is commuting to a waypoint. Furthermore, since all the data is logged and time stamped and available to all parties. It is difficult for either party to create a dispute based on different or inaccurate information which will help to prevent any fraudulent or prank activity. Accordingly, this should lead to a reduction in the errors associated with traditional deliveries that are not secure.

In yet another aspect, at least one embodiment of the secure order, payment and delivery systems described in accordance with the teachings herein may be used to secure payments and settlement for one or more of the parties that are involved in a transaction. Furthermore, the automated verification that occurs through the use of sending identifiers (e.g. PINS) to the merchant and to the buyer and using the courier's device as part of the process of verifying these identifiers results in reduction of any tampering or foul play in the fulfillment of an order.

In yet another aspect, at least one embodiment of the secure order, payment and delivery systems described in accordance with the teachings herein may keep detailed records of various aspects of fulfilled orders for at least one of a given user, a given merchant and a given courier. These detailed records may be used for advanced reporting, dispute resolution, tracking and scheduling of sales, tracking consumer buying habits and trends and the tracking of purchases.

In yet another aspect, at least one of the secure order, payment and delivery systems described in accordance with the teachings herein are flexible for use in multiple different industries while using a general web application and native applications along with couriers having different types of vehicles and may charge different amounts for fulfillment of an order depending on the type of order that requires fulfilling even if the orders vary in at least one of the size and/or number of items to be picked up and/or dropped off at a waypoint, the various handling instructions and if there is a requirement for a different payment method.

In another aspect, the various embodiments of the systems and methods described herein may be used to facilitate the secure order, payment and delivery of a wide variety of good and services. Accordingly, it should be understood that the term “goods and services” referred to herein may comprise ordering and transporting goods, or providing transportation services.

In another aspect, payments may be handled at any time before, during or after the entire order process depending on the type of order and the circumstances of the order. This feature enables the secure ordering, payment and delivery systems described herein to be more versatile which is advantageous.

In another aspect, at least one embodiment of the secure ordering, payment and delivery systems described in accordance with the teachings herein may generate new data that is used for better business operations and sales analytics.

In another aspect, at least one embodiment of the secure ordering, payment and delivery systems described herein may have the ability to create reports for better business operations by generating in depth data for businesses offering a delivery service or delivery service operators themselves as well as reducing the possibility of penalties incurred for returns due to delivery errors for businesses.

In another aspect, at least one embodiment of the secure ordering, payment and delivery systems described herein may provide logistical tracking and logging of transaction and delivery data individually for each sprint that is created and the data may include at least one of payment status, transactions log data, delivery route data and delivery durations, task attributes, returns or errors yielding enough information to produce valuable customizable reports.

In another aspect, at least one embodiment of the secure ordering, payment and delivery systems described herein may provide an alternative method for remote or mobile purchases from local sellers to be made using a more secure and monitored process.

In another aspect, at least one embodiment of the secure ordering, payment and delivery systems described in accordance with the teachings herein may generate new proxy payments data for businesses and individuals.

In another aspect, at least one embodiment of the secure ordering, payment and delivery systems described in accordance with the teachings herein may provide functions that allow businesses to market their products online and process delivery orders using the same secure and monitored payment settlement method remotely.

In another aspect, at least one embodiment of the secure ordering, payment and delivery systems described in accordance with the teachings herein may expedite the existing process for businesses to engage their customers and couriers for the sale, payment, delivery and tracking of items. This engagement may include at least one of sale, reviews, feedback or any other dialogue specific to that business.

The three way communication between the seller, the courier and the buyer also allows for transactional data to be exchanged more efficiently and effectively using template forms of data requests and responses between the seller, buyer and courier regulated by the system.

Various embodiments of systems, processes and devices have been described herein by way of example only. Various modifications and variations may be made to these example embodiments without departing from the spirit and scope of the embodiments, which is limited only by the appended claims. The appended claims should be given the broadest interpretation consistent with the description as a whole.

We claim:

1. A method to facilitate the secure order, payment and delivery of at least one of goods and services using a communication network, the method comprising:
providing for the connection of a plurality of buyer devices, merchant devices and courier devices using the communication network;
receiving an order request for the at least one of goods and services at a management server, the order request being sent from a first electronic device of a first party, the at least one of goods and services being prepared by a second party having a second electronic device and the order being fulfilled by a courier having a courier device;
obtaining order authorization for the order request from the first electronic device of the first party;
generating first and second corresponding identifiers for the order request and sending the first identifier to the second electronic device of the second party and the second identifier to the first electronic device of the first party;
locating the courier who will fulfill the order;
receiving a first identifier response from the courier device when the located courier picks up the order from the second party;
verifying pick up of the order at the second party by matching the first identifier with the first identifier response;
receiving a second identifier response from the courier device when the located courier delivers the order to the first party;
verifying delivery of the order to the first party by matching the second identifier with the second identifier response; and
completing payment transaction for the order upon delivery verification.

2. The method of any one of claim 1, further comprising sending the order request to the second electronic device and upon receiving acceptance of the order request from the second electronic device, the first and second corresponding identifiers for the order request are generated and sent to the second and first electronic devices respectively.

3. The method of claim 1, wherein the order comprises order attribute data and at least two waypoints, and wherein each of the at least two waypoints corresponds to a pick-up location or a drop-off location and comprises one or more waypoint attribute data.

4. The method of claim 3, wherein the order request comprises waypoints for multiple drop-offs and/or multiple pick-ups.

5. The method of claim 3, further comprising determining a total distance and a delivery time for the at least two waypoints using a mapping module.

6. The method of claim 5, wherein the payment transaction comprises determining a total charge that is based on the order attribute data and a delivery charge.

7. The method of claim 5, wherein locating the courier to fulfill the order further comprises broadcasting a courier request to a plurality of courier devices corresponding to couriers, the courier request comprising the total distance, the delivery time and address information for waypoints associated with the order for review by the couriers.

8. The method of claim 3, wherein an Expected Delivery Time (EDT) is determined by the management server and transmitted from the management server to the first electronic device of the first party.

9. The method of claim 1, wherein the payment transaction is transmitted to a payment processor associated with the first party.

10. The method of claim 9, further comprising receiving a payment pre-authorization response from the payment processor corresponding to the order authorization before generating the first and second identifiers.

11. The method of claim 9, wherein a payment processor approval is transmitted after the first and second identifier responses are matched with the first and second identifiers, respectively.

12. The method of claim 2, wherein the order attribute data comprise item data for at least one item ordered from the second party, vehicle type data for a type of vehicle needed to deliver the order, and address data, contact name data and task information data for instructions to be followed by the courier at each of the waypoints of the order.

13. The method of claim 12, wherein the order attribute data comprises weight and volume data that is used to determine the vehicle type data.

14. The method of claim 12, wherein the order is a custom run and the task information data comprises instructing the courier to take a picture of any goods being picked up and/or dropped off.

15. The method of claim 12, wherein the task information data comprises at least one of pick-up data including a pick-up time, and drop-off data including a drop-off time.

16. A method to facilitate the creation of an order request for secure ordering, payment and delivery of at least one of goods and services using a communication network, the method comprising:
receiving item data from a first electronic device of a first party for at least one of goods and services to be ordered from a second party;
receiving first waypoint data for a first waypoint of the order request, the first waypoint data comprising first address data, first contact data and first task instruction data;
receiving second waypoint data for a second waypoint of the order request, the second waypoint data comprising second address data, second contact data and second task instruction data;
packaging the item data, first waypoint data and second waypoint data into an order request;
sending the order request to a second electronic device of the second party;
upon acceptance of the order request by the second party, sending a courier request to a plurality of courier devices to locate one courier that will deliver the order; and
upon acceptance of the courier request, sending an identifier for each waypoint to a contact at each waypoint, wherein the identifiers are used to verify the completion of tasks by the courier at each of the waypoints.

17. A method of creating an online store at a server to facilitate the secure order, payment and delivery of at least one item by a secure ordering, payment and delivery system, the online store being for a non-registered merchant that is not previously associated with the secure ordering, payment and delivery system, wherein the method comprises;
receiving business attribute data sent from a creator device at the server for creating a business waypoint for the online store;
receiving item attribute data sent by the creator device at the server for at least one item associated with the online store;
associating the at least one item with the business waypoint at the server;
receiving drop-off waypoint data sent by the creator device at the server for the waypoint where the ordered item is to be delivered;
receiving an order request sent by the creator device at the server for at least one item at the online store;
determining a charge for the order request at the server based on the at least one ordered item, a route between the business and drop-off waypoints and a delivery charge;
sending information on the order request and the charge to the creator device for approval;
receiving approval of the order request at the server and broadcasting the order request to an electronic device associated with the non-registered merchant to prepare at least one item and/or at least one service specified in the order request; and
broadcasting the order request to courier devices for delivering the at least one ordered item.

18. The method of claim 17, further comprising creating the business waypoint at the server using the business attribute data sent from the creator device, the business attribute data comprising at least one of a business name, a business address and a business contact.

19. The method of claim 17, further comprising creating the at least one item for the online store at the server using the item attribute data sent from the creator device, the item attribute data comprising at least one of an item name, an item description, an item price, an item image, an item weight and an item volume.

20. The method of claim 17, further comprising creating the drop-off waypoint at the server using the drop-off waypoint attribute data sent by the creator device, the drop-off waypoint attribute data comprising at least one of a drop-off waypoint name, a drop-off waypoint address, a drop-off waypoint image, and drop-off waypoint contact information.
